(19) United States
(12) Patent Application Publication
(10) Pub. No.: US 2005/0083858 A1
(43) Pub. Date: Apr. 21, 2005

(54) System and method of utilizing virtual ants in small world infrastructure communication networks

(76) Inventors: Kanchei Loa, Phoenix, AZ (US); Michael Sugino, Mesa, AZ (US)

Correspondence Address: FLIESLER MEYER, LLP, FOUR EMBARCADERO CENTER, SUITE 400, SAN FRANCISCO, CA, 94111, US

(21) Appl. No.: 10/960,882

(22) Filed: Oct. 7, 2004

Related U.S. Application Data
(60) Provisional application No. 60/509,934, filed on Oct. 9, 2003.

(51) Int. Cl. H04L 12/28

(52) U.S. Cl. 370/254; 370/397; 370/399; 706/14

(57) ABSTRACT

A small world infrastructure network of communication units, a plurality of which are stigmergic-capable nodes that are capable of generating and supporting virtual ants. A virtual ant can carry information relating to a node, such as its identification and sequence information, and can be sent by the node to one or more neighboring nodes to establish, recursively, hierarchical forwarding paths. A virtual ant interacts with a node through alteration of the table entries of the destination node receiving the virtual ant.

### CLAIM OF PRIORITY

This application claims priority under 35 U.S.C. 119(e) to U.S. Provisional Patent Application No. 60/509,934 entitled SYSTEM AND METHOD OF UTILIZING VIRTUAL ANTS IN SMALL WORLD INFRASTRUCTURE COMMUNICATION NETWORKS, by Kanchei Loa and Mike Sugino, filed Oct. 9, 2003 (Attorney Docket No. SUGN-01001USO), which is incorporated herein by reference.

### FIELD OF USE

This invention relates to communication systems, specifically methods and systems for determining and establishing a communication path in information transport networks.

### BACKGROUND OF THE INVENTION

Current communication systems are extremely large networks of interconnected Communication Units (CUs) approaching complexities and scale of unmanageable magnitude. These systems are comprised of a hybrid mix composed of wire line and wireless transport networks which are fixed (stationary), movable (reconfigurable fixed), portable (slow mobility) and mobile (fast mobility). The architecture of various types of CUs forming the system network is constantly changing and evolving adding to the complexity.

Packet based architectures for the efficient routing, forwarding, and switching of data flows are non-existent which also exhibit flexibility and scalability over a multiplicity of network protocols, granularity, applications and hardware. With the current evolution of the Internet as a global communication infrastructure, the inherit design imposes challenging constraints in supporting emerging services in the wire line and wireless networks.

The primary network infrastructure including the Internet was constructed around a very simple point to point communication model. Network intelligence was assigned to the network routing nodes, while the end point devices were assumed independent from the transport decision tasks. The network nodes would perform all transport forwarding tasks and decisions. This simple two-tier model has allowed these infrastructures to evolve without efficiency or scalability issues to current magnitudes with little issues.

Research from social networking has resulted in the concepts of “small worlds” theory where contact relationships and acquaintance metrics reduce the degrees of separation between entities. This can drastically reduce the path length of large complex networks to a very manageable practical size.

A subset of a relationship graph is shown in FIG. 1. Nodes represent entities with their associated relational contacts. The number of degrees of separation is the number of hops between two entities. Node 50 has relational associations or contacts with nodes 54, 58, 62, 66 and 70 shown by links 52, 56, 60, 64 and 68, respectively. There are other links associated via links 72 and 74. If the node of interest is node 94, a relationship path discovered through contact links would be node 66 via link 64, node 78 via link 76, node 82 via link 80, node 86 via link 84, node 90 via 88 and the node of interest 94 via link 94. This illustrates six degrees of separation between node 50 and node 94.

Emerging communication networks have been exploiting results from small world concepts to attempt to reduce large complex networks to a reasonable small world network. Several new architectures have been introduced in the research community that attempt to create a small world in large-scale networks. These architectures are based on defining relational contacts for network nodes. The contacts form short cuts in the communications path, which represent logical connections that translate into multiple physical hops.

A particular node will have its own set of contact information, which may encompass many different sets of other nodes, depending on the particular relational attribute being exploited. But for a given set of contacts there will be a set of first contacts or single hop links or nodes of one degree of separation. This represents the initial known contacts and forms a one degree contact domain. In FIG. 2 a portion of a contact or relationship graph is shown. For a node of interest, 100, the first contacts, 104, 108, 112, 116, 120, 124, 128, 132 and 136 are shown with their associated relational links or contacts, 102, 106, 110, 114, 118, 122, 126, 130 and 134, respectively. This resulting one degree contact domain is shown as 156.

This virtual contact domain concept may be extended to encompass nodes of multiple degrees of freedom. In FIG. 2 a first contact node, 136 is chosen for illustration purposes. Node 136 has a one degree contact domain, 158, comprised of nodes 132, 140, 144, 148, 104, 108 and 100 with associated links, 154, 138, 142, 146, 150, 152 and 134, respectively. If this is extended for all nodes in the one degree contact domain for node 100, the resulting two degree contact domain, 160 is formed. This will result in increased efficiency in finding a node within a domain.

As the number of degrees of freedom or as virtual reach of the contact domain increases, the probability of finding the destination node increases, because the contact domains will overlap. In FIG. 3 several nodes, 170, 174, 180 and 186 and their associated two degree contact domains, 172, 176, 182 and 188, respectively are shown. Domain 172 overlaps domain 176 resulting in an overlap 178, domain 176 overlaps domain 182 resulting in an overlap 184 and domain 188 is outside domains 172, 176 and 182. Source node 170 would be capable of finding any destination in contact domain 176 via contacts in 178 and for destinations in contact domain 182, contacts via 178, 176 and 184 would be utilized. For destinations in contact domain 188, no destinations could be found utilizing contact information.

Extending the number of degrees of separation is accomplished at a penalty of increased resources for maintaining contact information within a domain. If the extent is insufficient, the probability of reaching the destination is very low utilizing contact information only unless some means is incorporated for maintaining contact outside of the domain.

With the introduction of wireless nodes into the network, spatial dependencies due to radio transceiver efficiencies become a necessary consideration. Mobility will add time dependencies as an additional mandatory parametric factor. Both location and time are relational attributes, but maintain required parametric presence if wireless mobility is incorporated into the communication infrastructure. This adds significant complexity to conventional discovery methodologies, but becomes a natural extension of the small world concept as only an added relational attribute.

A portion of a relational graph is shown in FIG. 4. For illustrative simplicity, only node 194 will be mobile. The source node 190 with its associated two degree contact domain 192 and the mobile node 194 with its associated two degree contact domain 196 are shown in their initial state. The domains overlap 198 and destination discovery is guaranteed. The node 194 is moving away from node 190. In FIG. 5, at a later time, node 194 has moved along the path 200 and is shown as node 202 in its new position within the relational graph. Node 202 has a new two degree contact domain 204 associated with its new position. The new domain still overlaps 192 and is shown as 206. This will still insure destination discovery of node 202 (old node 194). With further movement of node 202 along path 208, its new position is shown as node 210 in FIG. 6. The new two degree contact domain 212 no longer overlaps 192. If only the nodes within the domain 192 are queried for contact information, discovery of node 210 would be lost. Research has indicated that maintaining a small number of carefully chosen nodes outside the contact domain will significantly increase the coverage. In FIG. 7, a node 214 is chosen as an extension contact node outside of domain 192. This effectively adds the contact domain 216 from node 214 to domain 192. This new coverage now overlaps domain 212 resulting in a discovery of node 210.

These contacts are chosen by various algorithms and/or by taking advantage of mobility or underline routing protocols. The goal of such contacts is to be used during network routing and resource discovery without global flooding. These “smart” contacts, computed by current or future algorithms, out-perform traditional packet routing protocols in simulation studies but have little commercial value without a practical, efficient and robust mechanism to implement these relationship in “real-live” wire line and wireless packet communication networks.

Multi-protocol label switching (MPLS) and generalized multi-protocol label switching (GMPLS) are current technology solutions for addressing performance, management and scalability issues in today's networks. MPLS/GMPLS separate routing from packet forwarding/switching with the use of a simpler paradigm based on label swapping. The separation from routing allows for interfacing to existing layer 2 and layer 3 protocols. The communication path is determined from labels embedded in the packet header. The label determines the Label-Switched Path (LSP) for a packet with local significance only (i.e. next hop).

An illustrative diagram of a MPLS domain is shown in FIG. 8. The network is comprised of an ingress host 220 with multiple data flows to two egress hosts, 222 and 224, interconnected via multiple Label Switching Routers (LSR). Two LSP's, 270 and 272 are shown, one for each data flow. LSR 228 is the ingress point for the host 220. The LSR's located at the edge of a MPLS domain are also classified as a Label Edge Router (LER) due to possible added support for dissimilar networks. Data flows are assigned to a particular Forwarding Equivalency Class (FEC) determined by a set of transport requirements such as service properties and destination address.

As a packet 226 enters the edge LER 228, a FEC is assigned as well as determining the LSP 270 to use. The LSP will determine which label should be added to the packet. LER 228 will forward the packet on the appropriate interface to the determined LSR 232. The labeled packet 230 is received by LSR 232. The incoming interface and label will be used to determine the outgoing interface and new label. The current label is swapped for the new label and forwarded on the appropriate interface to the next LSR 236 for the particular LSP 270. The new labeled packet is received by LSR 236 and processed in a similar manner and forwards a new labeled packet 238 to LSR 240. LSR 240 processes the packet 238 and forwards a new labeled packet 242 to the egress LER 244.

LER 244 perform similar tasks with the exception of stripping the label from labeled packet 242 before forwarding to the appropriate interface for external conventional processing to destination host 222.

Data flows assigned to LSP 272 are processed in a equivalent manner. Packets from host 220 destined for host 224 are processed be LER 228 with a label added for appropriate processing by LSR 232. The labeled packet 250 is processed by 232 and forwarded to LSR 254 as labeled packet 252. LSR 254 processes the packet 252 and forwards the labeled packet 256 to LSR 258. LSR 258 processes packet 256 and forwards the labeled packet 260 to LSR 262. LSR 262 will process packet 260 and forward the labeled packet 264 to LER 266, where the label is stripped and forwarded to the appropriate interface for external processing to destination host 224.

MPLS cannot work without the distribution of the mappings of the incoming interface and label to the outgoing interface and label. Without populating the LSR's throughout the domain, LSP's could not be used. MPLS does not specify a single protocol for distribution of labels or mappings, but allows for multiple solutions. The hop-by-hop LDP (Label Distribution Protocol) for creating LSP's allows high-level relationship attributes being mapped to “real” network services by negotiating and setup on a hop-by-hop basis.

In MPLS label distribution is from the downstream direction. The mappings are towards the source and opposite the direction of data flow. With GMPLS upstream label suggestion is permitted.

With downstream distribution, two possible methodologies are supported, downstream label distribution and downstream-on-demand label distribution. With downstream label distribution, a downstream LSR will assign a label and send its mapping unsolicited to its upstream neighbor for a particular FEC. In FIG. 9 during the creation of a LSP 308 from ingress host 220 to egress host 306, with downstream label distribution LSR 276 would send a mapping 278 to LER 274 upon assignment of the label mapping the interface to the next hop LSR 282 in the LSP 308. Subsequently, LSR 282 would send a mapping 284 for the next hop LSR 288 to LSR 276. This will continue with LSR 288 sending mapping 290 to LSR 282, LSR 294 sending mapping 296 to LSR 288. Finally LER 300 would finish the LSP 308 sending the mapping 302 to LSR 294.

With downstream-on-demand label distribution, the LSR would request a label mapping from the downstream LSR. Following the same LSP 306 in FIG. 9. LER 274 recognizes LSR 276 as the next hop for the FEC and send a request for mapping 280 from LSR 276, which would send back a mapping 278. LSR 276 would send a request 286 to 282 which would send a mapping 284 back. LSR 282 would send a request 292 to 288 which would send a mapping 290 back. LSR 288 would send a request 298 to 294 which would send a mapping 296 back. LSR 294 would send a request 304 to 300 which would send a mapping 302 back terminating the LSP.

However, MPLS is designed for IP flows aggregation from ingress points to egress points. MPLS also assumes that “network reach-ability issues” have been resolved by incorporated routing protocols.

The two-tier model from which current network architectures have been based was envisioned with unicast service provisioning in mind, where the destination was known and fixed. With the evolution of communication systems to include wireless and wire line infrastructures, fixed and mobile nodes, services are becoming more complex. In addition to the basic unicast services, more complex services are emerging such as multicast where there can be multiple source and destination participants, anycast where there is only a single receiver for a particular packet, multihoming where there is more than a single service destination (i.e. multiple service providers), dynamic where the topology will not be constant and mobility where the destination location is not fixed. These new services have failed deployment in the existing infrastructure.

In order to alleviate these shortcomings, several attempts have been made to decouple the source from the destination by introducing an indirection point between the source (sender) and destination (receiver). Most proposed solutions have failed due to scalability issues. An overlay network based solution was proposed, Internet Indirection Infrastructure (I3), using rendezvous based communications.

A rendezvous based network assumes an indirection point, a logical abstraction where a identifier is associated with a rendezvous point between sender and receiver. There are two primitives, send(p) in which a sender would send a packet (id, data) into the network and insert(t) in which a receiver would insert a trigger (id, address) into the network. This id represents the logical abstraction of the rendezvous point. In the I3 network, the overlay network is comprised of I3 servers which act as the rendezvous points. The servers store triggers as well as forward packets.

A rendezvous based I3 network is shown in FIG. 10 comprised of a receiver 310 attached to the network at 312, a sender 318 attached to the network at 320 and an I3 server 316 attached to the network at 314. The receiver 310 would send a trigger 322 to the I3 server 316 with an ID identifying a service packet and the destination address associated with 310 to forward the packet. The sender 318 would send a data packet 324 to the I3 server 316 containing an ID identifying the abstract destination, ID to whom the data packet should be forwarded. The I3 server 316 matches the ID from the data packet 324 with the ID from the trigger 322 and forwards the data packet 326 to the destination address associated with 310 identified in the trigger 322. This is equivalent functionally to a unicast service, but with the sender and receiver decoupled.

For a multicast service, a rendezvous based 13 network is shown in FIG. 11 comprised of multiple receivers, 310 attached to the network at 312, 328 attached to the network at 330 and 332 attached to the network at 334, which are participating as a multicast group. There is also a sender 318 attached to the network at 320 and an I3 server 316 attached to the network at 314. Each receiver in the multicast group 310, 328 and 332 would send a trigger to the I3 server 316. Receiver 310 would send a trigger 322 with an ID identifying a multicast session service packet and the destination address associated with 310 to forward the packet. Receiver 328 would send a trigger 336 with the same ID identifying the same multicast session service packet but the destination address associated with 328 to forward the packet. Receiver 332 would send a trigger 338 with the same ID identifying the same multicast session service packet but the destination address associated with 332 to forward the packet. The sender 318 would send a data packet 324 to the I3 server 316 containing an ID identifying the abstract destination, ID to whom the data packet should be forwarded, in this case the multicast group, but the mechanism is identical to the unicast example. The I3 server 316 matches the ID from the data packet 324 with the ID from the multicast group. The I3 server will forward the packet 326, 340 and 342 to the destination addresses associated with triggers, address for 310 identified in the trigger 322, address for 328 identified in the trigger 336 and address for 332 identified in the trigger 338.

For an anycast service, a rendezvous based 13 network is shown in FIG. 12 comprised of multiple receivers, 310 attached to the network at 312, 328 attached to the network at 330 and 332 attached to the network at 334, which are participating as an anycast group. There is also a sender 318 attached to the network at 320 and an I3 server 316 attached to the network at 314. Each receiver in the anycast group 310, 328 and 332 would send a trigger to the I3 server 316. Receiver 310 would send a trigger 322 with an ID identifying an anycast group session service packet with some of the least significant ID bits unique identifying 310 and the destination address associated with 310 to forward the packet. Receiver 328 would send a trigger 336 with an ID identifying an anycast group session service packet with some of the least significant ID bits unique identifying 328 and the destination address associated with 328 to forward the packet. Receiver 332 would send a trigger 338 with an ID identifying an anycast group session service packet with some of the least significant ID bits unique identifying 332 and the destination address associated with 332 to forward the packet. The ID for each member of the anycast group would have k significant bits identical and associated with the anycast group ID. The sender 318 would send a data packet 324 to the I3 server 316 containing an ID identifying the abstract destination, ID to whom the data packet should be forwarded, in this case the anycast group. The I3 server 316 matches the ID from the data packet 324 with the k significant bits ID from the anycast group. The I3 server will determine by some preset means the best suited receiver to forward the packet. In this case packet 326 would be forwarded to the destination address associated with 310 identified in the trigger 322. This selection could be determined by best prefix matching, QoS or CoS parametrics.

In a mobile application the receiver can change location within the network changing the destination address. A rendezvous based 13 network is shown in FIG. 13 comprised of a receiver 310a at initial location attached to the network at 312, a sender 318 attached to the network at 320 and an I3 server 316 attached to the network at 314. The receiver 310a would send a trigger 322 to the I3 server 316 with an ID identifying a service packet and the destination address associated with 310a to forward the packet. The sender 318 would send a data packet 324 to the I3 server 316 containing an ID identifying the abstract destination, ID to whom the data packet should be forwarded. The I3 server 316 matches the ID from the data packet 324 with the ID from the trigger 322 and forwards the data packet 326 to the destination address associated with 310a identified in the trigger 322. Receiver 310a will move to new location in the I3 network along a path 344. The receiver designated as 310b in its new location will be attached to the network at 346. The receiver 310b would send a trigger 348 to the I3 server 316 with the same ID identifying a service packet and the destination address associated with 310b to forward the packet. The I3 server 316 matches the ID from the data packet 324 with the ID from the trigger 348 and forwards the data packet 350 to the destination address associated with 310b identified in the trigger 348.

The rendezvous based communications solution, Internet Indirection Infrastructure is solid in theory and simulations have been very positive. When implemented as an overlay network on top of IP, the solution is not applicable to the “real” Internet. The scheme consists of a set of servers that stores the ID and forwards packets between the sender and receiver. This exhibits very inefficient packet routing in the overlay network because the forwarding path is mixed with ID storage and lookup resulting in serious scalability issues.

Within MPLS networks, various LSP's could converge over portions of the network, sharing forwarding paths. These flows would share labels within this common area. This is known as label merging or flow aggregation. A MPLS domain is shown in FIG. 14 with multiple ingress hosts 360 and 364 with data flows to separate egress hosts 362 and 366 respectively. LSP 408 for the data flow from ingress host 360 to egress host 362 is defined by label mappings 384, 386, 388, 390 and 392. LSP 410 for the data flow from ingress host 364 to egress host 366 is defined by label mappings 398, 400, 402 and 404. LSP 408 and LSP 410 share a common path or merge from LSR 370 to LSR 372 and diverge at LSR 374. In order to maintain flow identity at the divergence point, a mechanism called label stacking was implemented. The level within a stack corresponds to the level within the flow hierarchy. In this example, the labels associated with the mappings 384, 386 and 392 are part of a level 0 stack for LSP 408. The labels associated with mappings 398 and 404 are part of the level 0 stack for LSP 410. In the merged region the labels associated with mappings 400 and 388 would be identical and the labels associated with mappings associated with mappings 402 and 390 would be identical. These two labels would represent level one in the stack for LSP 408 and LSP 410. This illustrates a simple case of a hierarchical LSP concept.

In GMPLS, flow aggregation is a key concept and defined as GMPLS Hierarchical LSP by the IETF. GMPLS extends MPLS beyond packet based switching to also support switching based in the time, wavelength and space domains present in current infrastructures. Within these networks a natural hierarchy exists between Packet Switch Capable (PSC), Time Domain Multiplexing Capable (TDM), Lambda Switch Capable and Fiber Switch Capable (FSC) devices with increasing bandwidth capabilities, respectively. A simplifying constraint exists within this hierarchy which requires that an LSP must begin and end at the same level due to natural equipment support. This massive aggregation of bandwidth requires extremely large amounts of LSP's to support it. The higher levels in the hierarchy require increasing amounts due to this aggregation. The concept of Hierarchical LSP allows the GMPLS network to dramatically reduce the number of LSP's that the higher levels would have to support.

This hierarchical structure is shown in FIG. 15 illustrating GMPLS flow aggregation. This natural hierarchy occurs between the PSC network 420 at level 0, the TDM network 422 at level 1, the LSC network 424 at level 2 and the FSC network 426 at level 3. Because of the termination equipment requirements, there is a natural symmetry to the network hierarchy.

Assuming a particular ingress 428 and egress 430, the hierarchy can be described. The ingress flow enters the PSC network 420 through an interface on one of the ingress PSC nodes 432. PSC 432 would traverse the PSC network until entering a boundary PSC node 434 through link 434. The boundary node 434 would interface to the TDM network 422 via a link 438. The link 438 interfaces with the ingress TDM node 444 where it will be aggregated with other PSC links 440 and 442. This aggregation would be repeated through other ingress TDM nodes from throughout the PSC network 420. This aggregated flow would traverse the TDM network 422 until entering a boundary TDM node 448 through link 446. The boundary node 448 would interface to the LSC network 424 via a link 442. The link 452 interfaces with the ingress LSC node 454 where it will be aggregated with ingress TDM link 452. This aggregation would be repeated through other ingress LSC nodes from throughout the TDM network 422. This aggregated flow would traverse the LSC network 424 until entering a boundary LSC node 458 through link 456. The boundary node 458 would enter the FSC network 426 via a link 460. The link 460 interfaces with the ingress FSC node 466 where it will be aggregated with other ingress TDM links 462 and 464. The aggregated flow is at the highest level, level 3, in the hierarchy. The flow would traverse the FSC network 426 until entering an egress FSC node 470 through link 468.

The flow would begin traversing down the hierarchy when the aggregated flows are split to the appropriate interfaces and exit the FSC network 426 through links 472 and 474. The flow of interest interfaces with the boundary LSC node 476. The flow would traverse the LSC network 424 until entering an egress LSC node 480 through link 478. The flow would be split to the appropriate interfaces and exit the LSC network 424 through links 482 and 484. The flow of interest interfaces with the boundary TDM node 486. The flow would traverse the TDM network 422 until entering an egress TDM node 490 through link 488. The flow would be split to the appropriate interfaces and exit the TDM network 422 through links 492, 494 and 496. The flow of interest interfaces with the boundary PSC node 498. The flow would traverse the PSC network 420 until entering an egress PSC node 502 through link 500. The flow would exit the network out an interface of egress PSC node 502.

The process of creating the Hierarchal LSP will be shown in FIG. 16 using the same example in FIG. 15 for a flow from ingress 428 to egress 430. When the flow enters the PSC network 420 at ingress node 434, a request 504 for a level 0 LSP 544 from ingress PSC node 434 to egress PSC node 502 would be generated. The request would arrive at the boundary PSC node 438 where a request to ingress TDM node 444 would be generated. With the arrival at the level 1 TDM network 422, a request 506 for a level 1 LSP 542 from ingress TDM node 444 to egress TDM node 490 would be generated. The request would arrive at the boundary TDM node 448 where a request to ingress LSC node 454 would be generated. With the arrival at the level 2 LSC network 424, a request 508 for a level 2 LSP 540 from ingress LSC node 454 to egress LSC node 480 would be generated. The request would arrive at the boundary LSC node 460 where a request to ingress FSC node 466 would be generated. With the arrival at the level 3 FSC network 426, a request 510 for a level 3 LSP 538 from ingress FSC node 466 to egress FSC node 470 would be generated.

Egress FSC node 470 would complete the creation of the level 3 LSP 538 and sends a response 522 back to the requesting ingress FSC node 466. With the completion of the level 3 LSP 538, the request 508 for the level 2 LSP 540 from ingress node 454 is tunneled 524 through the level 3 LSP 538 to boundary LSC node 476 and forwarded to egress LSC node 480. This completes the level 2 LSP 540 and egress LSC node 480 sends a response 526 back to the requesting ingress LSC node 454. With the completion of the level 2 LSP 540, the request 506 for the level 1 LSP 542 from ingress node 444 is tunneled 528 through the level 2 LSP 540 to boundary TDM node 486 and forwarded to egress TDM node 490. This completes the level 1 LSP 542 and egress TDM node 490 sends a response 530 back to the requesting ingress TDM node 444. With the completion of the level 1 LSP 542, the request 504 for the level 0 LSP 544 from ingress node 432 is tunneled 532 through the level 1 LSP 542 to boundary PSC node 498 and forwarded to egress PSC node 502. This completes the level 0 LSP 544 and egress PSC node 502 sends a response 534 back to the requesting ingress PSC node 432. This completes the Hierarchal LSP.

The conventional MPLS LSP is just a sequence of labels or a concatenation of labels. With a Hierarchal LSP (H-LSP), for levels greater than 0, the level n LSP is a sequence or concatenation of lower level LSP's. The level 0 LSP is equivalent to the conventional MPLS labels. A homogeneous H-LSP, LSP(4,1) is shown in FIG. 17 with a constant level depth of 4. The figure depicts a LSP as LSP(n,m) where n is the level number and m is a LSP sequence number within the LSP level n. Labels are indicated as L(n,l) where n is the level number and l is a label sequence number within the LSP level n. An X indicates a null to act as a label placeholder at the end of a label sequence of a particular LSP.

For instance, LSP(1,1) is a level 1 LSP and the first level 1 LSP comprised of labels L(0,1), L(0,2) and a null (X) indicating the end of LSP(1,1). For level n>1, the sequence is a concatenation of LSP's of level n−1. LSP(2,1) is a concatenation of LSP(1,1) and LSP(1,2) with label L(1,1) used for LSP(1,1) and a null(X) as a placeholder for LSP(1,2). Similarly for LSP(3,1) is a concatenation of LSP(2,1) and LSP(2,2) with L(2,1) used for LSP(2,1) and null(X) as a placeholder for LSP(2,2). Finally for the level 4 LSP, LSP(4,1) is a concatenation of LSP(3,1) and LSP(3,2) with label L(3,1) used for LSP(3,1) and a null(X) as a placeholder for LSP(3,2). The other LSP's are defined equivalently.

The table in FIG. 17 illustrates the associated label stack corresponding to the sequence from top (ingress) to bottom (egress). At the ingress, sequence 1, for LSP(4,1) which is a hierarchy of level 3, 2, 1 and 0 LSP's, labels L(3,1), L(2,1), L(1,1) and L(0,1) are pushed on the stack. At sequence 2, L(0,1) is swapped for L(0,2). At sequence 3, L(0,2) is swapped for a null(X) to indicate a placeholder for the end of LSP(1,1). At sequence 4, LSP(1,1) will be completed and the level 0 label, X will be popped from the stack. Sequence 4 also corresponds with the creation of LSP(1,2) and the final label for LSP(2,1). To accommodate these events a null(X) to indicate a placeholder for the end of LSP(2,1) and L(0,3) for the creation of LSP(1,2) will be pushed on the stack. At sequence 5, L(0,3) is swapped for L(0,4). At sequence 6, L(0,4) is swapped for a null(X) to indicate a placeholder for the end of LSP(1,2). At sequence 7, LSP(1,2) and LSP(2,1) will be completed and the level 0 label, X as well as the level 1 label, X will be popped from the stack. Sequence 7 also corresponds with the creation of LSP(1,3) and LSP(2,2) as well as the final label for LSP(3,1). To accommodate these events a null(X) to indicate a placeholder for the end of LSP(3,1), L(1,2) for the creation of LSP(2,2) and L(0,5) for the creation of LSP(1,3) will be pushed on the stack. The labels will be swapped, popped and pushed on the stack in a similar manner through the remaining sequence. At sequence 13, LSP(1,4), LSP 2,2) and LSP(3,1) will be completed and the level 0, 1 and 2 labels, X as will be popped from the stack. Sequence 13 also corresponds with the creation of LSP(1,5), LSP(2,3) and LSP(3,2) as well as the final label for LSP(4,1). To accommodate these events a null(X) to indicate a placeholder for the end of LSP(4,1), L(2,2) for the creation of LSP(3,2), L(1,3) for the creation of LSP(2,3) and L(0,9) for the creation of LSP(1,5) will be pushed on the stack. Finally at the egress, sequence 24, for LSP(4,1) all LSP's will be completed and all labels in the stack will be popped at the completion of the sequence.

A H-LSP is not limited to the homogeneous case, but can have variable depths with a the only constraint being for a level n H-LSP, the sequence of concatenated LSP's of depths less than n and greater than 1 must contain at least one LSP with depth n−1. An inhomogeneous level 4 H-LSP, LSP(4,1) is shown in FIG. 18 with a variable level depth from 1 to 4. The figure depicts a LSP as LSP(n,m) where n is the level number and m is a LSP sequence number within the LSP level n. Labels are indicated as L(n,l) where n is the level number and l is a label sequence number within the LSP level n. An X indicates a null to act as a label placeholder at the end of a label sequence of a particular LSP. The H-LSP initially has a depth of 4 at sequence 1, a depth of 3 at sequence 7, a depth of 1 at sequence 13, a depth of 3 at sequence 16 and the completes at sequence 21. The sequence is a concatenation of a level 3 LSP, LSP(3,1), a level 1 LSP, LSP(1,5) and a level 2 LSP, LSP(2,2). LSP(3,1) is a concatenation of a level 2 LSP, LSP(2,1) and two level 1 LSP's, LSP(1,3) and LSP(1,4). LSP(2,1) is a concatenation of two level 1 LSP's, LSP(1,1) and LSP(1,2). Finally, LSP(2,2) is a concatenation of two LSP's, LSP(1,6) and LSP(1,7).

The table in FIG. 18 illustrates the associated label stack corresponding to the sequence from top (ingress) to bottom (egress). The stack behavior is similar to the homogeneous example in FIG. 17 with the exception of a variable stack depth corresponding to the variable depth of LSP's. For example, at sequence 7, LSP(1,2) and LSP(2,1) will be completed and the level 0 label, X as well as the level 1 label, X will be popped from the stack. Sequence 7 also corresponds with the creation of LSP(1,3). To accommodate these events L(1,2) will be swapped for L(2,1) to indicate the continutation of LSP(2,1) for LSP(3,1) and L(0,5) for the creation of LSP(1,3) will be pushed on the stack. At this point the stack has a depth of 3 instead of 4 corresponding with the reduction in level in the hierarchy. Similarly at sequence 13, LSP(1,4) and LSP(3,1) will be completed and the level 0 label, X as well as the level 1 label, X will be popped from the stack. Sequence 13 also corresponds with the creation of LSP(1,5) and L(0,5) will be pushed on the stack resulting in a stack depth of 1 as well as a level 1 hierarchy. At sequence 16 LSP(1,5) will be completed and the level 0 label, X will be popped from the stack. Sequence 16 also corresponds with the creation of LSP(1,6) and LSP(2,2). To accommodate these events L(1,4) for the creation of LSP(2,2) and L(0,11) for the creation of LSP(1,6) will be pushed on the stack. At this point the stack has a depth of 2 corresponding with the level in the hierarchy. Finally after sequenc 231, for LSP(4,1) all LSP's will be completed and all labels in the stack will be popped at the completion of the sequence.

The use of label stacking in a Hierarchical LSP enables concatenation of lower level LSP's, but still requires the means for determining these sequences.

The Small World Infrastructure (SWI) is a method to determine, establish and maintain a communication path between interconnected communication units (CU). The Small World Infrastructure (SWI) is implemented as an underlay network. SWI utilizes the relational attributes inherit in the CU's which are incorporated in a general packet communications network. These relationships or small world contacts determine the paths between source and destination CU's in the network. These contact paths are implemented as the defining method for composing the Hierarchical Label Switched Path (H-LSP) in a MPLS or GMPLS domain.

An illustrative portion of a MPLS domain is shown in FIG. 19. The MPLS capable network 626 consists of interconnected Label Switching Routers (LSR). The CU of interest 550 is a source or destination node for the communication path to be determined. With a particular set of relational attributes, there exists a set of associate CU's exhibiting direct or first level contacts. In the subset of CU's illustrated, these are shown as nodes 558, 564, 574, 588, 602, 612 and 622. Each of these CU's are composed of a sequence of segments making up a first level H-LSP. Segments 552 and 556 create H-LSP 560 between 550, 554 and 558. Segments 552 and 662 create H-LSP 566 between 550, 554 and 564. Segments 568 and 572 create H-LSP 576 between 550, 570 and 574. Segments 578, 582 and 586 create H-LSP 590 between 550, 580, 584 and 588. Segments 592, 596 and 600 create H-LSP 604 between 550, 594, 598 and 602. Segments 706 and 610 create H-LSP 614 between 550, 608 and 612. Segments 606, 616 and 620 create H-LSP 624 between 550, 608, 618 and 622. This set of H-LSP's make up a first level contact domain for CU 550. This subset of a MPLS domain 626 is shown in a larger set of the MPLS in FIG. 20.

The first level contact domain of FIG. 19 can be extended. Each of the first level contacts can each have its own set of first level contacts, extending the contact domain for CU 550 as illustrated in FIG. 20. As shown in FIG. 21, the first level contact domain 627 is shown with the first level extensions of each of the first level contact CU's 558, 564, 574, 588, 602, 612 and 622. CU 558 is extended to its first level contacts 674 (with H-LSP 676), 630 (with H-LSP 632) and 634 (with H-LSP 636). CU 558 is extended to its first level contacts 674 (with H-LSP 676), 630 (with H-LSP 632) and 634 (with H-LSP 636). CU 558 is extended to its first level contacts 674 (with H-LSP 676), 630 (with H-LSP 632) and 634 (with H-LSP 636). CU 558 is extended to its first level contacts 674 (with H-LSP 676), 630 (with H-LSP 632) and 634 (with H-LSP 636). CU 564 is extended to its first level contacts 638 (with H-LSP 640) and 642 (with H-LSP 644). CU 574 is extended to its first level contact 646 (with H-LSP 648). CU 588 is extended to its first level contacts 651 (with H-LSP 652) and 654 (with H-LSP 656). CU 602 is extended to its first level contacts 658 (with H-LSP 660) and 662 (with H-LSP 664). CU 612 is extended to its first level contacts 666 (with H-LSP 669) and 668 (with H-LSP 670). CU 622 is extended to its first level contact 672 (with H-LSP 673). This extends the contact domain to 628.

Contact domain 628 is shown in FIG. 22 with the irrelevant MPLS components not shown for clarity. All first level contact H-LSP's are shown for domains 627 as well as the extended domain 628. The first level H-LSP's can be concatenated to create a second level contact domain which is identical in scope with the combined first level domains 627 and 628. First level H-LSP's 560 and 632 are concatenated to form H-LSP 678. First level H-LSP's 560 and 636 are concatenated to form H-LSP 680. First level H-LSP's 566 and 640 are concatenated to form H-LSP 682. First level H-LSP's 566 and 644 are concatenated to form H-LSP 684. First level H-LSP's 576 and 648 are concatenated to form H-LSP 686. First level H-LSP's 590 and 652 are concatenated to form H-LSP 688. First level H-LSP's 590 and 656 are concatenated to form H-LSP 690. First level H-LSP's 604 and 660 are concatenated to form H-LSP 692. First level H-LSP's 604 and 664 are concatenated to form H-LSP 694. First level H-LSP's 614 and 668 are concatenated to form H-LSP 696. First level H-LSP's 614 and 670 are concatenated to form H-LSP 698. First level H-LSP's 624 and 674 are concatenated to form H-LSP 700. First level H-LSP's 560 and 676 are concatenated to form H-LSP 702. The resulting second level contact domain 629 for CU 550 is shown in FIG. 23.

The SWI service model is simple. For indirection services, the sender maps an identifier to a packet forwarding path from the sender to the rendezvous point, where the receiver expresses interest in packets sent to the same identifier. In FIG. 24 is shown a larger MPLS domain which includes a source or sender CU, 710 and a destination or receiver CU, 711. For an indirection service, the sender 711 would need to locate rendezvous point(s) suited to the service relational attributes. The initial contact domain 732 for the receiver 711 consists of contacts 712, 713, 714, 715, 716, 717, 718, 719, 720 and 722 which are connected with H-LSP's 722, 723, 724, 725, 726, 727, 728, 729, 730 and 731, respectively. From within these contacts, 717, 718 and 719 are found to have attributes and contact extensions with the best relational attributes for the requested service. Contact 718 has a contact domain that extends to contacts 716, 733, 734 and 718 connected with H-LSP's 740, 741, 742 and 743, respectively. Contact 719 has a contact domain that extends to contacts 717, 734, 735, 736 and 719 connected with H-LSP's 743, 744, 745, 746 and 747, respectively. Contact 719 has a contact domain that extends to contacts 718, 736, 738, 739 and 720 connected with H-LSP's 747, 751, 752, 753 and 752, respectively. Contact 736 has a contact domain that extends to contacts 718, 735, 737, 738 and 719 connected with H-LSP's 746, 748, 749, 750 and 751, respectively. The contact domain for CU 711 has been extended by the domain 754.

The contact domain 732 and the extended domain 754 are illustrated in FIG. 25 with MPLS components not shown for clarity. For this specific example, contacts 733, 735 and 738 are determined to have the best relational attributes for use as rendezvous points for the service. The rendezvous point 733 would have a trigger sent from the receiver 711 containing the identifier ID and forwarding path from the rendezvous point 733 to the receiver 711. This forwarding path would be H-LSP 755 composed from the lower level H-LSP's 741 and 727. The rendezvous point 734 would have a trigger sent from the receiver 711 containing the identifier ID and forwarding path from the rendezvous point 734 to the receiver 711. This forwarding path would be H-LSP 756 composed from the lower level H-LSP's 745 and 728. The rendezvous point 738 would have a trigger sent from the receiver 711 containing the identifier ID and forwarding path from the rendezvous point 738 to the receiver 711. This forwarding path would be H-LSP 757 composed from the lower level H-LSP's 752 and 729.

At this point the receiver has inserted triggers at rendezvous points in the SWI awaiting services mapped to the identifier ID in the trigger. In FIG. 26 the MPLS domain is shown with the receiver 711 and the rendezvous points 733, 735 and 738 determined for trigger placement for the desired service. The sender 710 would attempt to map an identifier for the desired service identifier ID associated with the trigger placed by the receiver to a packet forwarding path from the sender to the rendezvous point. The sender only needs to locate a rendezvous point that is aware of the identifier ID associated with the trigger from the receiver. In the SWI service model, the process of finding a rendezvous point is very similar to the process of the receiver determining a rendezvous point for trigger placement. The sender 710 provides a service that is associated with the identifier ID requested by a receiver without any required prior knowledge of the receiver; only what service is required by the requested ID. The sender would have a contact domain 776 associated with the relational attributes of the service. The initial contacts 758, 759, 760 761, 762, 763, 764, 765 and 766 would be connected with H-LSP's 767, 768, 769, 770, 771, 772, 773, 774 and 775, respectively. In a similar way that the contact domain is extended for the receiver, the sender's contact domain would determine that contacts 759, 760 and 761 would be best associated for extension. These contacts would extend the contact region to include contacts 777, 738, 737, 780, 781, 782, 783, 784 and 785.

The resulting extended contact domain 805 is shown in FIG. 27 with the MPLS components not shown for clarity. The extended domain includes the rendezvous point 738 which is aware of the service identifier ID from the receiver 711. The sender 710 would map an identifier for the desired service identifier ID associated with the trigger placed by the receiver to a packet forwarding path from the sender to the rendezvous point. This forwarding path would be H-LSP 807 composed from the lower level H-LSP's 806 and 793. The forwarding path from the sender to the receiver would be complete and the rendezvous point would concatenate the sender H-LSP and the receiver H-LSP resulting in the H-LSP 808 shown in FIG. 28. The sender can now use the forwarding path to send the appropriate service packets to the receiver. This is the simple case of a unicast indirection service.

For a direction service, the receiver 711 would be the rendezvous point. This is shown in FIG. 29 with the sender 710 providing the direction service. The trigger would be located at the rendezvous point which is the receiver 711 and contain the identifier ID of the service and the address of the receiver. Identically as in the indirection service scenario the sender only needs to locate a rendezvous point that is aware of the identifier ID associated with the trigger from the receiver. The sender 710 provides a service that is associated with the identifier ID requested by a receiver without any required prior knowledge of the receiver; only what service is required by the requested identifier ID. The sender would have a contact domain 776 associated with the relational attributes of the service. The contact domain is extended for the sender in a series of extensions contact by contact through 759, 738 and 719. The extended contact region 809 includes the rendezvous point or receiver 711 which is aware of the service identifier ID. The sender 710 would map an identifier for the desired service identifier ID associated with the trigger placed by the receiver to a packet forwarding path from the sender to the rendezvous point. This forwarding path would be H-LSP 810 composed from the lower level H-LSP's 768, 793, 752 and 729. The forwarding path 810 from the sender to the receiver would be used by the sender for forwarding the appropriate service packets to the receiver. This is the simple case of a unicast direction service.

The SWI service model supports many different indirection and direction scenarios. All of them utilize the concept of relational contacts for location services. The remainder of the illustrations utilizing the SWI service model will use these relational contacts for locating rendezvous points in a similar method as the previous illustrations. These show the versatility of the SWI service model.

Mobility is illustrated in FIG. 30 with mobile sender and receiver with an indirection service. The SWI service model accommodates mobility independent of sender or receiver mobility. The receiver only needs to have knowledge of a rendezvous point and keep the trigger up to date with its location. Since the sender would map an identifier ID to a forwarding path based on the H-LSP to the rendezvous point, no additional operation needs to be invoked when the sender moves. The FIG. 30 will be used to discuss several situations. A simple case with stationary sender and mobile receiver will be discussed. Initially the receiver 820a would send a trigger to a rendezvous point I13 with the service identifier ID and forwarding path H-LSP I14 from I13 to 820a. The sender 822a would map an identifier ID to a forwarding path H-LSP I15 from the sender 822a to the rendezvous point I13 containing the trigger placed from the receiver 820a. The rendezvous point would concatenate the H-LSP's I15 and I14 completing the forwarding path from the sender to the receiver. The resulting H-LSP I16 would be used by the sender to forward the requested service packets to the receiver 820a. Assuming the sender remains stationary at 822a and the receiver moves along path 833. The receiver 820b would only need to send a new trigger with the same identifier ID and new forwarding path I17 to the rendezvous point I13. The sender 822a would map an identifier ID to a forwarding path H-LSP I15 from the sender 822a to the rendezvous point I13 containing the trigger placed from the receiver 820b. The rendezvous point would concatenate the H-LSP's I15 and I17 completing the forwarding path from the sender to the receiver. The resulting H-LSP 832 would be used by the sender to forward the requested service packets to the receiver 820b. This was illustrated with a constant rendezvous point, but the rendezvous point could change as the receiver moved.

The next case will illustrate mobile receiver and sender with a changing rendezvous point. In FIG. 30 the initial location for the receiver is 820a and the sender 822a. Initially the receiver 820a would send a trigger to a rendezvous point I13 with the service identifier ID and forwarding path H-LSP I14 from I13 to 820a. The sender 822a would map an identifier ID to a forwarding path H-LSP I15 from the sender 822a to the rendezvous point I13 containing the trigger placed from the receiver 820a. The rendezvous point would concatenate the H-LSP's I15 and I14 completing the forwarding path from the sender to the receiver. The resulting H-LSP I16 would be used by the sender to forward the requested service packets to the receiver 820a. The receiver would follow the path 833 to location 820b and the sender would follow the path 834 to location 822b. Due to relational attributes, a new rendezvous point I19 is determined. The receiver 820b would only need to send a new trigger with the same identifier ID and new forwarding path H-LSP 830 to the rendezvous point I19. The sender 822b would map an identifier ID to a forwarding path H-LSP 831 from the sender 822b to the rendezvous point I19 containing the trigger placed from the receiver 820b. The rendezvous point would concatenate the H-LSP's 831 and 830 completing the forwarding path from the sender to the receiver. The resulting H-LSP 835 would be used by the sender to forward the requested service packets to the receiver 820b.

Multicast service is illustrated in FIG. 31 for a sender 844 and three receiver's 838, 840 and 842. For simplicity, we will assume a single rendezvous point 846, but multiple rendezvous points are just as practical without further complexity. Each of the receivers 838, 840 and 842 would place a trigger at the rendezvous point 846 with the same identifier ID. Receiver 838 would place a trigger at the rendezvous point 846 with the service identifier ID and forwarding path H-LSP 848 from 846 to 840. Receiver 840 would place a trigger at the rendezvous point 846 with the service identifier ID and forwarding path H-LSP 850 from 846 to 840. Receiver 842 would place a trigger at the rendezvous point 846 with the service identifier ID and forwarding path H-LSP 852 from 846 to 842. The sender 844 would map an identifier ID to a forwarding path H-LSP 854 from the sender 844 to the rendezvous point 846 containing the triggers placed from the receivers 838, 840 and 842. The rendezvous point would concatenate the H-LSP 854 to a point-to-multipoint H-LSP containing the receiver forwarding paths H-LSP 848, H-LSP 850 and H-LSP 852 completing the forwarding paths from the sender to the receivers. The resulting point-to-multipoint H-LSP would effectively be equivalent to H-LSP 856, H-LSP 858 and H-LSP 860, but with the multicasting occurring at the rendezvous point 846.

Anycast service is illustrated in FIG. 32 for a sender 868 and the three receiver's 862, 864 and 866 in an anycast group. For simplicity, we will assume a single rendezvous point 870, but multiple rendezvous points are just as practical without further complexity. Each of the receivers 862, 864 and 866 would place a trigger at the rendezvous point 870 with the same anycast group identifier ID. The SWI model offers a great deal of flexibility allowing the identifier ID to be m-bits string, which ranges from fixed length static key for database query to variables length string with embedded active program. Additionally, the ID matching rules can be just as flexible extending the flexibility to the services provided by the receiver and sender. The ID matching functions plays a key role in anycast H-LSP construction. For example, but not limited to, a very simple case of a matching rule for anycast in SWI with fixed length ID is all hosts in an anycast group maintain triggers which are identical in the k most significant bits. These k bits play the role of the anycast group identifier. To send a packet to an anycast group, a sender uses an identifier whose k-bit prefix matches the anycast group identifier. The packet is then delivered to the member of the group whose trigger identifier best matches the packet identifier according to the longest prefix matching rule. Each matching trigger creates a H-LSP from the sender to one of the receivers in the group. Receiver 862 would place a trigger at the rendezvous point 870 with the anycast ID and forwarding path H-LSP 872 from 870 to 862. Receiver 864 would place a trigger at the rendezvous point 870 with the anycast ID and forwarding path H-LSP 876 from 870 to 864. Receiver 866 would place a trigger at the rendezvous point 870 with the anycast ID and forwarding path H-LSP 876 from 870 to 866. The sender 868 would map an identifier ID to a forwarding path H-LSP 878 from the sender 868 to the rendezvous point 870 containing the triggers placed from the receivers 862, 864 and 866. In this case assume the best match is to the trigger ID from receiver 866. The rendezvous point 870 would concatenate the H-LSP 878 and H-LSP 876 completing the forwarding path from the sender to the receiver. The resulting H-LSP 880 would be used by the sender to forward the requested service packets to the receiver 866.

The SWI service model allows extensions to the basic identifier ID within the sender mappings and receiver triggers. The identifier ID would be replaced by a stack of identifiers IDstack(receiver) for the receiver and IDstack(sender) for the sender adding versatility and flexibility to the service model. A general stack of ID's can provide service composition from both the sender and receiver. The IDstack(receiver) allows the forwarding of a packet to a series of identifiers such as shown in FIG. 33. A receiver 882 will place a trigger at the rendezvous point 886. The trigger would be composed of a stack of identifiers, two in this case. The identifiers would provide the service and forwarding path H-LSP 894 to redirect the packet to 890 for intermediate service prior to forwarding to the receiver 882 using H-LSP 896. This trigger would be identified by it's association with a service requested by 882 and the forwarding path from the rendezvous point 886 to the receiver 882. This intermediate service is independent of the sender and can remain transparent.

The sender 884 would map a stack of identifiers IDstack(sender) to a forwarding path H-LSP 898 from the sender 884 to the rendezvous point 886 containing the trigger placed from the receiver 882. The service packet would be forwarded to 904 using H-LSP 900 for service intermediate to being forwarded to the rendezvous point 886 using H-LSP 902. This intermediate service is independent of the receiver and can remain transparent. The rendezvous point would concatenate the H-LSP's 898 and 888 completing the forwarding path from the sender to the receiver. The resulting H-LSP 906 would be used by the sender to forward the requested service packets to the receiver 882. The packets however would be redirected to service nodes 904 and 890 prior to receiver 882.

The trigger can also be generalized to offer redirection of the packet. In FIG. 34, a receiver 908 would place a trigger at the rendezvous point 914, containing an identifier ID but the forwarding path would be an H-LSP 918 instead of H-LSP 916 to the receiver. The sender 912 would map an identifier ID to a forwarding path H-LSP 920 from the sender 912 to the rendezvous point 914 containing the trigger placed from the receiver 908. The rendezvous point would concatenate the H-LSP 922 and H-LSP 918 completing the forwarding path from the sender to the destination receiver 910. The resulting H-LSP 922 would be used by the sender to forward the requested service packets to the destination receiver 910.

Social insects such as ants, bees and termites have introduced many concepts to the world of network management and routing. This collective interaction of simple agents results in a very intelligent system. This community utilizes indirect communication through environmental influences or stigmergy implemented with very simple primitives. Ants utilize pheromones as a medium for indirect communication among the colony. The pheromones are deposited to provide a signaling system indicating a shortest route to sources of food. The amount of pheromone deposited will increase with increasing usage by the ants. As the pheromones increase, the ants will select the path with the highest concentration. This will reinforce the path. The pheromone will evaporate over time allowing for unused paths to diminish and new paths discovered. This swarm intelligence results in a complex behavioral system capable of solving complex problems using cooperation. The behavior of ants has been studied extensively for their use in solving network routing problems efficiently. Ant based algorithms have evolved from very simple reinforcement learning algorithms and can be very resilient to typical network corruption and failures as well as exhibiting very low resource overhead requirements.

A desirable attribute of any solution for current packet-switched communication networks is a fully distributed routing algorithm absent of any need for centralized management. These distributed algorithms need to adapt efficiently to changing topologies and reliably find the desired least cost route. Ant based distributed routing algorithms have been explored with promising potential exhibiting these desirable properties. We will assume there are two types of nodes, end point nodes (hosts) and switching/routing nodes (routers). The end point nodes are communication source or destination nodes which initiate or terminate data messages. The switching/routing nodes forward data messages and process switching/routing messages. Ants are represented by messages generated by end points in the network (communication destination nodes). Two new ant algorithms that have been applied to data networks meet these requirements.

The first algorithm, the regular ant algorithm, has its initial roots from call routing in telephony networks. The regular ant algorithm is a shortest path solution constrained to links with equal costs for both directions. The regular ant is also a single path solution. A second algorithm, the uniform ant algorithm, is a multi-path solution. The uniform ant algorithm is also suitable to links with non-symmetrical costs. Both algorithms follow three key concepts, 1) ants explore the network, 2) forwarding tables are probabilistic and 3) ants probabilistically update the forwarding tables. The ants explore the routes backwards from the destination nodes towards the source nodes. The ants begin with a zero cost at the destination node and while exploring the network, the cost for the path followed is incremented. As the ants encounter nodes in its path the accumulated cost is used to update the probabilities reflecting the cost from the node to the destination node which generated the ant. The probability for the link the ant arrives on will be increased similar to traditional reinforcement algorithms to the inverse of the normalized cost of the path to the destination node. The remaining links would be decreased accordingly.

To discuss both ant algorithms, a simple network topology will be used with non-uniform link costs. This network is shown in FIG. 35 showing only router nodes where it is assumed that the end-point nodes would enter or exit the network through one of the router nodes. The router nodes indicated as a, b, c, d, e, f, g and h are shown as 1000, 1002, 1004, 1006, 1008, 1010, 1012 and 1014, respectively. They are interconnected with links 1016, 1020, 1024, 1028, 1032, 1036, 1040, 1044, 1048, 1052, 1056, 1060, 1062, 1064, 1068 and 1072 each with an indicated link cost (7) 1018, (4) 1022, (5) 1026, (3) 1030, (3) 1034, (2) 1038, (4) 1042, (7) 1046, (3) 1050, (4) 1054, (4) 1058, (3) 1062, (3) 1066, (2) 1070 and (4) 1074, respectively. For example the cost for transporting the packet from node 1000 to node 1002 on link 1016 would have a cost of (7) shown as 1018. It is also assumed that all costs are symmetric to maintain consistency across all discussions, resulting in a cost of (7) for transporting a packet on link 1016 from node 1002 to node 1000. We will also assume that the cost of forwarding by each node is equal and will not be significant enough to affect the probabilities. It is also assumed that the destination node is introduced to the network with all initial probabilities from the destination node equal. If a node has three ports, each would have a probability of 1/3, for four ports, each would have a probability of 1/4 and for five ports, each would have a probability of 1/5.

FIG. 36 shows the total shortest path costs from all nodes back to the destination node 1000. From node 1002, links 1016, 1028 and 1036 have a path cost back to node 1000 of (7) 1074, (7) 1076 and (10) 1078, respectively. From node 1004, links 1020, 1028, 1032, 1040 and 1044 have a path cost back to node 1000 of (4) 1080, (10) 1082, (8) 1084, (13) 1086 and (15) 1088, respectively. From node 1006, links 1024, 1032, 1048 and 1052 have a path cost back to node 1000 of (5) 1078, (7) 1090, (11) 1092 and (15) 1094, respectively. From node 1008, links 1036, 1040, 1056 and 1064 have a path cost back to node 1000 of (9) 1096, (8) 1098, (12) 1100 and (13) 1102, respectively. From node 1010, links 1044, 1048, 1056, 1060 and 1068 have a path cost back to node 1000 of (11) 1104, (8) 1106, (12) 1108, (12) 1110 and (13) 1112, respectively. From node 1012, links 1052, 1060 and 1072 have a path cost back to node 1000 of (9) 1114, (11) 1116 and (14) 1118, respectively. From node 1014, links 1064, 1088 and 1072 have a path cost back to node 1000 of (11) 1120, (10) 1122 and (13) 1124, respectively. Additionally, at each node other than the destination node, the least cost link is shown with a heavier line. As an example, at node 1010, the link 1048 is the link with the least cost path to the destination node 1000. The network is also shown with least cost routes for destination node 1014 in FIG. 37 and for destination node 1012 in FIG. 38. In all situations, the least cost routes would also reflect the highest probabilities.

The network will be used to illustrate the ant process. With the regular ant, the destination node will generate ants with randomly chosen designated source nodes. The regular ant is forwarded at the encountered nodes according to the probabilistic forwarding tables. In FIG. 39, the destination node 1000 would generate a message or ant containing [the destination node, the total cost back to the destination node, the source node]. For this example initial message, the source is chosen as node 1014 and the cost is set to zero illustrating the introduction of a new node 1000 to the network. The links from FIG. 37 reflecting the probabilities and least cost routes to node 1014 are shown. At this point in time all the link probabilities from node 1000 are equal. The message 1126 [a, 0, h] containing destination node 1000, cost (0) and source node 1014 is sent on one of the links 1016 towards node 1002 with a link cost of (7) 1018. The message 1128 [a, 7, h] would arrive at node 1002 with a total cost at this point of (7) reflecting the cost (7) 1018 of link 1016. At this point the forwarding tables on node 1002 would be updated reflecting the cost back to the destination node 1000. Node 1002 will forward the message 1130 [a, 7, h] on one of the links to the designated source node. At this point, link 1036 was determined from the probabilities for the forwarding path to node 1014 from node 1002. The message 1132 [a, 9, h] would arrive at node 1008 with a total cost at this point of (9) reflecting the cost (2) 1038 of link 1036. At this point the forwarding tables on node 1008 would be updated reflecting the cost back to the destination node 1000. Node 1008 will forward the message 1134 [a, 9, h] on one of the links to the designated source node. At this point, link 1064 was determined from the probabilities for the forwarding path to node 1014 from node 1008. The message 1136 [a, 12, h] would arrive at node 1014 with a total cost at this point of (12) reflecting the cost (3) 1066 of link 1064. At this point the forwarding tables on node 1014 would be updated reflecting the cost back to the destination node 1000. At the designated source node 1014 for the ant under discussion, the message would be terminated.

In FIG. 40, the effect on the probabilistic forwarding tables will be illustrated for the initial sequence shown in FIG. 39. After the message arrives from node 1000, the forwarding probabilities to node 1000 for node 1002 are updated. The post designation shows the split of a particular link to indicate from which node the link is associated, node 1002 in the case for link 1016b. The width of the associated link will be proportional to the probability. For node 1002 the probability of link 1016b is increased and the probabilities for links 1028a and 1036a are decreased. After the message arrives from node 1002, the forwarding probabilities to node 1000 for node 1008 are updated. For node 1008 the probability of link 1036b is increased and the probabilities for links 1040b, 1056a and 1064a are decreased. After the message arrives from node 1008, the forwarding probabilities to node 1000 for node 1014 are updated. For node 1014 the probability of link 1064b is increased and the probabilities for links 1068b and 1072b are decreased.

FIG. 41 illustrates the generation of a subsequent ant from the destination node 1000. In this instance the designated source node was randomly chosen as node 1012. The links from FIG. 38 reflecting the probabilities and least cost routes to node 1012 are shown. The message 1138 [a, 0, g] containing destination node 1000, cost (0) and source node 1012 is sent on one of the links 1020 towards node 1004 with a link cost of (4) 1022. The message 1140 [a, 4, g] would arrive at node 1004 with a total cost at this point of (4) reflecting the cost (4) 1022 of link 1020. At this point the forwarding tables on node 1004 would be updated reflecting the cost back to the destination node 1000. Node 1004 will forward the message 1142 [a, 4, g] on one of the links to the designated source node. At this point, link 1032 was determined from the probabilities for the forwarding path to node 1012 from node 1004. The message 1144 [a, 7, g] would arrive at node 1006 with a total cost at this point of (7) reflecting the cost (3) 1034 of link 1032. At this point the forwarding tables on node 1006 would be updated reflecting the cost back to the destination node 1000. Node 1008 will forward the message 1146 [a, 7, g] on one of the links to the designated source node. At this point, link 1052 was determined from the probabilities for the forwarding path to node 1012 from node 1006. The message 1148 [a, 11, g] would arrive at node 1012 with a total cost at this point of (11) reflecting the cost (4) 1054 of link 1052. At this point the forwarding tables on node 1012 would be updated reflecting the cost back to the destination node 1000. At the designated source node 1012 for the ant under discussion, the message would be terminated.

In FIG. 42, the effect on the probabilistic forwarding tables will be illustrated for the previous sequence shown in FIG. 41. After the message arrives from node 1000, the forwarding probabilities to node 1000 for node 1004 are updated. The width of the associated link will be proportional to the probability. For node 1004 the probability of link 1020b is increased and the probabilities for links 1028b, 1032a, 1040a and 1044a are decreased. After the message arrives from node 1004, the forwarding probabilities to node 1000 for node 1006 are updated. For node 1006 the probability of link 1032b is increased and the probabilities for links 1048a and 1052a are decreased. After the message arrives from node 1006, the forwarding probabilities to node 1000 for node 1012 are updated. For node 1012 the probability of link 1052b is increased and the probabilities for links 1060b and 1072a are decreased.

FIG. 43 illustrates the generation of a subsequent ant from the destination node 1000. In this instance the designated source node was randomly chosen as node 1014. The message 1150 [a, 0, h] containing destination node 1000, cost (0) and source node 1014 is sent on one of the links 1024 towards node 1006 with a link cost of (5) 1026. The message 1152 [a, 5, h] would arrive at node 1006 with a total cost at this point of (5) reflecting the cost (5) 1026 of link 1024. At this point the forwarding tables on node 1006 would be updated reflecting the cost back to the destination node 1000. Node 1006 will forward the message 1154 [a, 5, h] on one of the links to the designated source node. At this point, link 1048 was determined from the probabilities for the forwarding path to node 1014 from node 1006. The message 1156 [a, 8, h] would arrive at node 1010 with a total cost at this point of (8) reflecting the cost (3) 1050 of link 1048. At this point the forwarding tables on node 1010 would be updated reflecting the cost back to the destination node 1000. Node 1010 will forward the message 1158 [a, 8, g] on one of the links to the designated source node. At this point link 1068 was determined from the probabilities for the forwarding path to node 1014 from node 1010. The message 1160 [a, 10, h] would arrive at node 1014 with a total cost at this point of (10) reflecting the cost (2) 1070 of link 1068. At this point the forwarding tables on node 1014 would be updated reflecting the cost back to the destination node 1000. At the designated source node 1014 for the ant under discussion, the message would be terminated.

In FIG. 44, the effect on the probabilistic forwarding tables will be illustrated for the previous sequence shown in FIG. 43. After the message arrives from node 1000, the forwarding probabilities to node 1000 for node 1006 are updated. The width of the associated link will be proportional to the probability. For node 1006 the probability of link 1024b is increased and the probabilities for links 1032b, 1048a and 1052a are decreased. After the message arrives from node 1006, the forwarding probabilities to node 1000 for node 1010 are updated. For node 1010 the probability of link 1048b is increased and the probabilities for links 1044b, 1056b, 1060a and 1068a are decreased. After the message arrives from node 1010, the forwarding probabilities to node 1000 for node 1014 are updated. For node 1014 the probability of link 1068b is increased and the probabilities for links 1064b and 1072b are decreased.

At this point, it is apparent that the least cost paths will continue to increase in probability, while the remaining probabilities will continue to diminish. With continued reinforcement of the least cost paths, the remaining paths will tend to become unused with diminishing probabilities approaching zero. In FIG. 45, the least cost paths, 1016b, 1020b, 1024b, 1040b, 1048b, 1052b and 1068b will increase in probability. Conversely, the unused paths, 1036a, 1040a, 1052a, 1064a, 1068a and 1072a will approach probabilities nearing zero. With sufficient ant traffic, the probabilities will converge to a stable state. This is shown in FIG. 46 where the least cost paths, 1016b, 1020b, 1024b, 1040b, 1048b, 1052b and 1068b from each node to the destination node 1000 will converge to one. The remaining paths, 1028a, 1028b, 1032a, 1032b, 1036a, 1036b, 1040a, 1044a, 1044b, 1048a, 1052a, 1056a 1056b, 1060a, 1060b, 1064a, 1064b, 1068a, 1072a and 1072b will converge to zero. This property is a major shortcoming of the regular ant algorithm as there is no provision for finding alternate paths once a least cost path has failed.

The uniform ant algorithm is similar to the regular ant algorithm with the primary difference occurring with the forwarding policies. Where the regular ants are biased towards the forwarding probabilities, the uniform ant is unbiased and will explore all paths with equal probability and lend a natural tendency for multi-path routing. The uniform ant has a very simple structure, [the destination node, the total cost back to the destination node], lacking a designated source node. The uniform ant is not restricted to symmetrical cost links as with the regular ant. The uniform ant will have a time to live in order to arrive at a reasonable exploratory domain.

Using the same simple network in FIG. 35, FIG. 47 will illustrate the behavior of the uniform ant algorithm. As with the regular ant, we will use a destination node 1000. A message or ant would be generated and sent on one of the links with equal probability. The cost is set to zero and a message 1170 [a, 0] is sent on link 1020. The message 1172 [a, 4] would arrive at node 1004 with a total cost at this point of (4) reflecting the cost (4) 1022 of link 1020. At this point the forwarding tables on node 1004 would be updated reflecting the cost back to the destination node 1000. Node 1004 will forward the message 1174 [a, 4] on one of the links with equal probability, link 1028 in this instance. The message 1176 [a, 7] would arrive at node 1002 with a total cost at this point of (7) reflecting the cost (3) 1030 of link 1028. At this point the forwarding tables on node 1002 would be updated reflecting the cost back to the destination node 1000. Node 1002 will forward the message 1178 [a, 7] on one of the links with equal probability, link 1036 in this instance. The message 1180 [a, 9] would arrive at node 1008 with a total cost at this point of (9) reflecting the cost (2) 1038 of link 1036. At this point the forwarding tables on node 1008 would be updated reflecting the cost back to the destination node 1000. Node 1008 will forward the message 1182 [a, 9] on one of the links with equal probability, link 1056 in this instance. The message 1184 [a, 13] would arrive at node 1010 with a total cost at this point of(13) reflecting the cost (4) 1058 of link 1056. At this point the forwarding tables on node 1010 would be updated reflecting the cost back to the destination node 1000. Node 1010 will forward the message 1186 [a, 13] on one of the links with equal probability, link 1048 in this instance. The message 1188 [a, 16] would arrive at node 1006 with a total cost at this point of (16) reflecting the cost (3) 1050 of link 1048. At this point the forwarding tables on node 1006 would be updated reflecting the cost back to the destination node 1000. At this point, assume the time to live for the message has elapsed and the message would be terminated.

In FIG. 48, the effect on the probabilistic forwarding tables will be illustrated for the initial sequence shown in FIG. 47. After the message arrives from node 1000, the forwarding probabilities to node 1000 for node 1004 are updated. The width of the associated link will be proportional to the probability. For node 1004 the probability of link 1020b is increased and the probabilities for links 1028b, 1032a, 1040a and 1044a are decreased. After the message arrives from node 1004, the forwarding probabilities to node 1000 for node 1002 are updated. For node 1002 the probability of link 1028a is increased and the probabilities for links 1016b and 1036a are decreased. After the message arrives from node 1002, the forwarding probabilities to node 1000 for node 1008 are updated. For node 1008 the probability of link 1036b is increased and the probabilities for links 1040b, 1056a and 1064a are decreased. After the message arrives from node 1008, the forwarding probabilities to node 1000 for node 1010 are updated. For node 1010 the probability of link 1056b is increased and the probabilities for links 1044b, 1048b, 1060a and 1068a are decreased. After the message arrives from node 1010, the forwarding probabilities to node 1000 for node 1010 are updated. For node 1010 the probability of link 1048a is increased and the probabilities for links 1024b, 1032a and 1052a are decreased.

FIG. 49 illustrates the generation of a subsequent ant from the destination node 1000. A message or ant would be generated and sent on one of the links with equal probability. The cost is set to zero and a message 1190 [a, 0] is sent on link 1024. The message 1192 [a, 5] would arrive at node 1006 with a total cost at this point of (5) reflecting the cost (5) 1026 of link 1024. At this point the forwarding tables on node 1006 would be updated reflecting the cost back to the destination node 1000. Node 1004 will forward the message 1194 [a, 5] on one of the links with equal probability, link 1052 in this instance. The message 1196 [a, 9] would arrive at node 1012 with a total cost at this point of (9) reflecting the cost (4) 1054 of link 1052. At this point the forwarding tables on node 1012 would be updated reflecting the cost back to the destination node 1000. Node 1012 will forward the message 1198 [a, 9] on one of the links with equal probability, link 1060 in this instance. The message 1200 [a, 12] would arrive at node 1010 with a total cost at this point of (12) reflecting the cost (3) 1062 of link 1060. At this point the forwarding tables on node 1010 would be updated reflecting the cost back to the destination node 1000. Node 1010 will forward the message 1202 [a, 12] on one of the links with equal probability, link 1068 in this instance. The message 1204 [a, 14] would arrive at node 1014 with a total cost at this point of (14) reflecting the cost (2) 1070 of link 1068. At this point the forwarding tables on node 1014 would be updated reflecting the cost back to the destination node 1000. Node 1014 will forward the message 1206 [a, 14] on one of the links with equal probability, link 1064 in this instance. The message 1208 [a, 17] would arrive at node 1008 with a total cost at this point of (17) reflecting the cost (3) 1066 of link 1064. At this point the forwarding tables on node 1008 would be updated reflecting the cost back to the destination node 1000. Node 1008 will forward the message 1210 [a, 17] on one of the links with equal probability, link 1040 in this instance. The message 1212 [a, 21] would arrive at node 1004 with a total cost at this point of (21) reflecting the cost (4) 1042 of link 1040. At this point the forwarding tables on node 1004 would be updated reflecting the cost back to the destination node 1000. At this point, assume the time to live for the message has elapsed and the message would be terminated.

In FIG. 50, the effect on the probabilistic forwarding tables will be illustrated for the initial sequence shown in FIG. 49. After the message arrives from node 1000, the forwarding probabilities to node 1000 for node 1006 are updated. The width of the associated link will be proportional to the probability. For node 1006 the probability of link 1024b is increased and the probabilities for links 1032b, 1048a and 1052a are decreased. After the message arrives from node 1006, the forwarding probabilities to node 1000 for node 1012 are updated. For node 1012 the probability of link 1052b is increased and the probabilities for links 1060b and 1072a are decreased. After the message arrives from node 1012, the forwarding probabilities to node 1000 for node 1010 are updated. For node 1010 the probability of link 1060a is increased and the probabilities for links 1044b, 1048b, 1056b and 1068a are decreased. After the message arrives from node 1010, the forwarding probabilities to node 1000 for node 1014 are updated. For node 1014 the probability of link 1068b is increased and the probabilities for links 1064b and 1072b are decreased. After the message arrives from node 1014, the forwarding probabilities to node 1000 for node 1008 are updated. For node 1008 the probability of link 1064a is increased and the probabilities for links 1036b, 1040b and 1056a are decreased. After the message arrives from node 1008, the forwarding probabilities to node 1000 for node 1004 are updated. The width of the associated link will be proportional to the probability. For node 1004 the probability of link 1040a is increased and the probabilities for links 1020b, 1028b, 1032a and 1044a are decreased.

As with the regular ant algorithm, it is apparent that the least cost paths will continue to increase in probability, while the remaining probabilities will continue to diminish. But, with the uniform ant algorithm the probabilities will not converge to one for the least cost paths and to zero for the remaining paths, but the steady state probabilities will be proportional to the normalized inverses of the costs at each node. In FIG. 51, the least cost paths, 1016b, 1020b, 1024b, 1040b, 1048b, 1052b and 1068b are still found and have the highest probabilities at each node. The remaining paths, 1028a, 1028b, 1032a, 1032b, 1036a, 1036b, 1040a, 1044a, 1044b, 1048a, 1052a, 1056a 1056b, 1060a, 1060b, 1064a, 1064b, 1068a, 1072a and 1072b will not converge to zero. This probabilistic proportioning will balance the traffic over the links at each node providing a natural multi-path forwarding. This property would also provide discovery of an alternate path once a least cost path has failed. This splitting of traffic can also lead to jitter in the data if traffic is split over unequal paths.

Scout is a simple backward learning exploratory algorithm exhibiting many of the attributes of ant based algorithms. Similar to ant based algorithms, the scout algorithm sends small messages, scouts, from the destination nodes to explore the network. The algorithm exhibits tolerance to dynamic changes in the topology. The destination nodes are communication end points as with the ant based algorithms. The destination nodes will periodically flood the network with scout messages. The destination node would send a scout message to all links (or neighbors) every broadcast interval (BI). The scout message contains [the destination node, the total cost back to the destination node, sequence number corresponding with the current BI]. When the neighboring node receives the scout message from the sending node, the sequence number is validated to confirm the scout is for the current BI. If the scout is not from the current BI, the message is discarded. If the destination node in the message is the receiving node, drop the packet. If the scout is valid, add the cost of the incoming link to the total cost in the message and store the scout if it is the least cost scout. For the receiving node, the designated neighbor would be the neighbor that provided the least cost path in the previous BI. If the receiving node has not forwarded a scout from the destination node for the current BI, forward the scout to all links except for the link on which the scout was received. If the scout is from the designated neighbor forward the current least cost scout to all links except for the designated neighbor. Update the forwarding table with the current least cost path.

Using the same simple network in FIG. 35, FIG. 52 will illustrate the behavior of the scout algorithm. As with the ant algorithms, we will use a destination node 1000. For the example illustration, at each node, the link delays from connected nodes will be in increasing magnitude order with increasing alphanumeric order. Additionally, the sum of any two different links will be greater than any other single link. This does not change the basic behavior, but simplifies the discussion. For the initial broadcast interval (BI), the destination node would send a scout message [a, 0, 1] 1214, 1218 and 1222 on each of its links 1016, 1020 and 1024 to its neighboring nodes 1002, 1004 and 1006, respectively. Each of the initial scout messages would contain the destination node, zero initial cost and the initial sequence number [a, 0, 1]. For node 1002, the message [a, 0, 1] 1214 from node 1000 would be received and its sequence number would be validated as the first BI. The cost for the message would be updated with a total cost (7) reflecting the cost (7) 1018 of the link 1016 and the forwarding table would be updated. Since this is the first message received from the destination node 1000 during the current BI, node 1002 would forward the updated message [a, 7, 1] 1226 and 1230 on each of its links 1028 and 1036 to its neighboring nodes 1004 and 1008, respectively. For node 1004, the message [a, 0, 1] 1218 from node 1000 would be received and its sequence number would be validated as the first BI. The cost for the message would be updated with a total cost (4) reflecting the cost (4) 1022 of the link 1020 and the forwarding table would be updated. Since this is the first message received from the destination node 1000 during the current BI, node 1004 would forward the updated message [a, 4, 1] 1234, 1238, 1242 and 1246 on each of its links 1028, 1032, 1040 and 1044 to its neighboring nodes 1002, 1006, 1008 and 1010, respectively. For node 1006, the message [a, 0, 1] 1222 from node 1000 would be received and its sequence number would be validated as the first BI. The cost for the message would be updated with a total cost (5) reflecting the cost (5) 1026 of the link 1024 and the forwarding table would be updated. Since this is the first message received from the destination node 1000 during the current BI, node 1006 would forward the updated message [a, 5, 1] 1250, 1254 and 1258 on each of its links 1032, 1048 and 1052 to its neighboring nodes 1004, 1010 and 1012, respectively. For node 1008, the message [a, 7, 1] 1230 from node 1002 would be received and its sequence number would be validated as the first BI. The cost for the message would be updated with a total cost (9) reflecting the cost (2) 1038 of the link 1036 and the forwarding table would be updated. Since this is the first message received from the destination node 1000 during the current BI, node 1008 would forward the updated message [a, 9, 1] 1262, 1266 and 1270 on each of its links 1040, 1056 and 1064 to its neighboring nodes 1004, 1010 and 1014, respectively. For node 1010, the message [a, 4, 1] 1246 from node 1004 would be received and its sequence number would be validated as the first BI. The cost for the message would be updated with a total cost (11) reflecting the cost (7) 1046 of the link 1044 and the forwarding table would be updated. Since this is the first message received from the destination node 1000 during the current BI, node 1010 would forward the updated message [a, 11, 1] 1274, 1278, 1282 and 1286 on each of its links 1048, 1056, 1060 and 1068 to its neighboring nodes 1006, 1008, 1012 and 1014, respectively. For node 1012, the message [a, 5, 1] 1258 from node 1006 would be received and its sequence number would be validated as the first BI. The cost for the message would be updated with a total cost (9) reflecting the cost (4) 1054 of the link 1052 and the forwarding table would be updated. Since this is the first message received from the destination node 1000 during the current BI, node 1012 would forward the updated message [a, 9, 1] 1290 and 1294 on each of its links 1060 and 1072 to its neighboring nodes 1010 and 1014, respectively. For node 1014, the message [a, 9 1] 1270 from node 1008 would be received and its sequence number would be validated as the first BI. The cost for the message would be updated with a total cost (12) reflecting the cost (3) 1066 of the link 1064 and the forwarding table would be updated. Since this is the first message received from the destination node 1000 during the current BI, node 1014 would forward the updated message [a, 12, 1] 1298 and 1302 on each of its links 1068 and 1072 to its neighboring nodes 1010 and 1012, respectively. At this point in time, because of the link delay conditions stated earlier, these stated messages were the first message to arrive at each node during this BI and would be the forwarded message for this BI. With each receiving node forwarding the message to each of its neighboring nodes, several nodes will receive additional occurrences of messages from alternate paths to the destination node 1000.

These forwarded messages would be received by several nodes during the next step in the current BI. Node 1002 receives an additional message [a, 4, 1] 1234 from node 1004 and the sequence number would be validated. The cost for the message would be updated with a total cost (7) reflecting the cost (3) 1030 of the link 1028. This cost is not less than the current least cost (7), thus the forwarding table would not be updated and the designated neighbor would be the node 1000 associated with the least cost path. Node 1004 receives additional messages [a, 7, 1] 1226 from node 1002 [a, 5, 1] 1250 from node 1006 and [a, 9, 1] 1262 from node 1008. The sequence numbers would be validated. The cost for the message from node 1002 would be updated with a total cost (10) reflecting the cost (3) 1030 of the link 1028. The cost for the message from node 1006 would be updated with a total cost (8) reflecting the cost (3) 1034 of the link 1032. The cost for the message from node 1008 would be updated with a total cost (13) reflecting the cost (4) 1042 of the link 1040. The least cost (4) would remain the same and the forwarding table would not be updated and the designated neighbor would be the node 1000 associated with the least cost path. Node 1006 receives additional messages [a, 4, 1] 1238 from node 1004 and [a, 11, 1] 1274 from node 1010. The sequence numbers would be validated. The cost for the message from node 1004 would be updated with a total cost (7) reflecting the cost (3) 1034 of the link 1032. The cost for the message from node 1010 would be updated with a total cost (14) reflecting the cost (3) 1050 of the link 1048. The least cost (5) would remain the same and the forwarding table would not be updated and the designated neighbor would be the node 1000 associated with the least cost path. Node 1008 receives additional messages [a, 4, 1] 1242 from node 1004 and [a, 11, 1] 1278 from node 1010. The sequence numbers would be validated. The cost for the message from node 1004 would be updated with a total cost (8) reflecting the cost (4) 1042 of the link 1040. The cost for the message from node 1010 would be updated with a total cost (15) reflecting the cost (4) 1058 of the link 1056. The least cost (8) would replace the current cost of (9) from node 1002 and the forwarding table would be updated and the designated neighbor would be the node 1004 associated with the least cost path. Node 1010 receives additional messages [a, 5, 1] 1254 from node 1006, [a, 9, 1] 1266 from node 1008, [a, 9, 1] 1290 from node 1012 and [a, 12, 1] 1298 from node 1014. The sequence numbers would be validated. The cost for the message from node 1006 would be updated with a total cost (8) reflecting the cost (3) 1050 of the link 1048. The cost for the message from node 1008 would be updated with a total cost (13) reflecting the cost (4) 1058 of the link 1056. The cost for the message from node 1012 would be updated with a total cost (12) reflecting the cost (3) 1062 of the link 1060. The cost for the message from node 1014 would be updated with a total cost (14) reflecting the cost (2) 1070 of the link 1068. The least cost (8) would replace the current cost of (11) from node 1004 and the forwarding table would be updated and the designated neighbor would be the node 1006 associated with the least cost path. Node 1012 receives additional messages [a, 11, 1] 1282 from node 1010 and [a, 12, 1] 1302 from node 1014. The sequence numbers would be validated. The cost for the message from node 1010 would be updated with a total cost (14) reflecting the cost (3) 1062 of the link 1060. The cost for the message from node 1014 would be updated with a total cost (16) reflecting the cost (4) 1074 of the link 1072. The least cost (9) would remain the same and the forwarding table would not be updated and the designated neighbor would be the node 1006 associated with the least cost path. Node 1014 receives additional messages [a, 11, 1] 1286 from node 1010 and [a, 9, 1] 1012 from node 1012. The sequence numbers would be validated. The cost for the message from node 1010 would be updated with a total cost (13) reflecting the cost (2) 1070 of the link 1068. The cost for the message from node 1012 would be updated with a total cost (13) reflecting the cost (4) 1074 of the link 1072. The least cost (12) would remain the same and the forwarding table would not be updated and the designated neighbor would be the node 1008 associated with the least cost path. This ends the current BI.

After the first BI, the designated neighbors are illustrated in FIG. 53. For mode 1002, the designated neighbor is node 1000 on link 1016. For node 1004, the designated neighbor is node 1000 on link 1020. For node 1006, the designated neighbor is node 1000 on link 1024. For node 1008, the designated neighbor is node 1004 on link 1040. For node 1010, the designated neighbor is node 1006 on link 1048. For node 1012, the designated neighbor is node 1006 on link 1052. For node 1014, the designated neighbor is node 1008 on link 1064. At this point, after one BI, the least costs paths have been found for all nodes except for node 1014.

For the next broadcast interval (BI), the destination node would send a scout message [a, 0, 2] 1306, 1310 and 1314 on each of its links 1016, 1020 and 1024 to its neighboring nodes 1002, 1004 and 1006, respectively. Each of the scout messages would contain the destination node, zero initial cost and the sequence number [a, 0, 2]. For node 1002, the message [a, 0, 2] 1306 from node 1000 would be received and its sequence number would be validated as the current BI. The cost for the message would be updated with a total cost (7) reflecting the cost (7) 1018 of the link 1016. Since the message received is from the designated neighbor 1000, node 1002 would forward the updated message [a, 7, 2] 1318 and 1322 on each of its links 1028 and 1036 to its neighboring nodes 1004 and 1008, respectively and the forwarding table would be updated. For node 1004, the message [a, 0, 2] 1310 from node 1000 would be received and its sequence number would be validated as the current BI. The cost for the message would be updated with a total cost (4) reflecting the cost (4) 1022 of the link 1020. Since the message received is from the designated neighbor 1000, node 1004 would forward the updated message [a, 4, 2] 1326, 1330, 1334 and 1338 on each of its links 1028, 1032, 1040 and 1044 to its neighboring nodes 1002, 1006, 1008 and 1010, respectively and the forwarding table would be updated. For node 1006, the message [a, 0, 2] 1314 from node 1000 would be received and its sequence number would be validated as the current BI. The cost for the message would be updated with a total cost (5) reflecting the cost (5) 1026 of the link 1024. Since the message received is from the designated neighbor 1000, node 1006 would forward the updated message [a, 5, 2] 1342, 1346 and 1350 on each of its links 1032, 1048 and 1052 to its neighboring nodes 1004, 1010 and 1012, respectively and the forwarding table would be updated. For node 1008, the message [a, 7, 2] 1322 from node 1002 would be received and its sequence number would be validated as the current BI. The cost for the message would be updated with a total cost (9) reflecting the cost (2) 1038 of the link 1036. The scout is not from the designated neighbor 1004, so the message will be stored. For node 1010, the message [a, 4, 2] 1338 from node 1004 would be received and its sequence number would be validated as the current BI. The cost for the message would be updated with a total cost (11) reflecting the cost (7) 1046 of the link 1044. The scout is not from the designated neighbor 1006, so the message will be stored. For node 1012, the message [a, 5, 2] 1350 from node 1006 would be received and its sequence number would be validated as the current BI. The cost for the message would be updated with a total cost (9) reflecting the cost (4) 1054 of the link 1052. Since the message received is from the designated neighbor 1006, node 1012 would forward the updated message [a, 9, 2] 1382 and 1386 on each of its links 1060 and 1072 to its neighboring nodes 1010 and 1014, respectively and the forwarding table would be updated. For node 1014, the message [a, 9, 2] 1386 from node 1012 would be received and its sequence number would be validated as the current BI. The cost for the message would be updated with a total cost (13) reflecting the cost (4) 1074 of the link 1072. The scout is not from the designated neighbor 1008, so the message will be stored. At this point in time, because of the link delay conditions stated earlier, these stated messages were the first message to arrive at each node during this BI. Only nodes which received messages from their designated neighbors would have forwarded the messages during this step of the current BI.

These forwarded messages would be received by several nodes during the next step in the current BI. Node 1002 receives an additional message [a, 4, 2] 1326 from node 1004 and the sequence number would be validated. The cost for the message would be updated with a total cost (7) reflecting the cost (3) 1030 of the link 1028. The current least cost (7) would remain the same and the forwarding table would not be updated. Node 1004 receives additional messages [a, 7, 2] 1318 from node 1002 and [a, 5, 2] 1342 from node 1006. The sequence numbers would be validated. The cost for the message from node 1002 would be updated with a total cost (10) reflecting the cost (3) 1030 of the link 1028. The cost for the message from node 1006 would be updated with a total cost (8) reflecting the cost (3) 1034 of the link 1032. The least cost (4) would remain the same and the forwarding table would not be updated. Node 1006 receives an additional message [a, 4, 2] 1330 from node 1004 and the sequence number would be validated. The cost for the message would be updated with a total cost (7) reflecting the cost (3) 1034 of the link 1032. The current least cost (5) would remain the same and the forwarding table would not be updated. Node 1008 receives an additional message [a, 4, 2] 1334 from node 1004 and its sequence number would be validated as the current BI. The cost for the message would be updated with a total cost (8) reflecting the cost (4) 1042 of the link 1040. This also represents the least cost path, so the message would be stored. Since the message received is from the designated neighbor 1004, node 1008 would forward the updated message [a, 8, 2] 1354, 1358 and 1362 on each of its links 1036, 1056 and 1064 to its neighboring nodes 1002, 1010 and 1014, respectively and the forwarding table would be updated. Node 1010 receives additional messages [a, 5, 2] 1346 from node 1006 and [a, 9, 2] 1342 from node 1012. The sequence numbers would be validated. The cost for the message from node 1006 would be updated with a total cost (8) reflecting the cost (3) 1050 of the link 1048. The cost for the message from node 1012 would be updated with a total cost (12) reflecting the cost (3) 1062 of the link 1060. The message from node 1006 represents the least cost (8), so the message would be stored. Since the message received is from the designated neighbor 1006, node 1010 would forward the updated message [a, 8, 2] 1366, 1370, 1374 and 1378 on each of its links 1044, 1056, 1060 and 1068 to its neighboring nodes 1004, 1008, 1012 and 1014, respectively and the forwarding table would be updated. Node 1012 does not receive any additional messages at this step in the current BI. Node 1014 does not receive any additional messages at this step in the current BI.

During the next step in the current BI, additional messages will be received by several nodes throughout the network. Node 1002 receives an additional message [a, 8, 2] 1354 from node 1008 and the sequence number would be validated. The cost for the message would be updated with a total cost (10) reflecting the cost (2) 1038 of the link 1036. The current least cost (7) would remain the same and the forwarding table would not be updated. Node 1004 receives an additional message [a, 8, 2] 1366 from node 1010 and the sequence number would be validated. The cost for the message would be updated with a total cost (15) reflecting the cost (7) 1046 of the link 1044. The current least cost (4) would remain the same and the forwarding table would not be updated. Node 1006 does not receive any additional messages at this step in the current BI. Node 1008 receives an additional message [a, 8, 2] 1370 from node 1010 and the sequence number would be validated. The cost for the message would be updated with a total cost (12) reflecting the cost (4) 1058 of the link 1056. The current least cost (8) would remain the same and the forwarding table would not be updated. Node 1010 receives an additional message [a, 8, 2] 1358 from node 1008 and the sequence number would be validated. The cost for the message would be updated with a total cost (12) reflecting the cost (4) 1058 of the link 1056. The current least cost (8) would remain the same and the forwarding table would not be updated. Node 1012 receives an additional message [a, 8, 2] 1374 from node 1010 and the sequence number would be validated. The cost for the message would be updated with a total cost (11) reflecting the cost (3) 1062 of the link 1060. The current least cost (9) would remain the same and the forwarding table would not be updated. Node 1014 receives additional messages [a, 8, 2] 1362 from node 1008 and [a, 8, 2] 1378 from node 1010. The sequence numbers would be validated. The cost for the message from node 1008 would be updated with a total cost (11) reflecting the cost (3) 1066 of the link 1064. This also represents the least cost path, so the message would be stored. Since the message received is from the designated neighbor 1008, node 1014 would forward the updated message [a, 11, 2] 1390 and 1394 on each of its links 1068 and 1072 to its neighboring nodes 1010 and 1012, respectively and the forwarding table would be updated. The cost for the message from node 1010 would be updated with a total cost (10) reflecting the cost (2) 1070 of the link 1068. This also represents the least cost path, so the message would be stored. The scout is not from the designated neighbor 1008, so the message would not be forwarded. Since the least cost path has changed, the designated neighbor for node 1014 will now be node 1010 associated with the least cost path.

During the next step in the current BI, additional messages will be received by several nodes throughout the network. During the previous step, only node 1014 forwarded additional messages. Node 1010 receives an additional message [a, 11, 2] 1390 from node 1014 and the sequence number would be validated. The cost for the message would be updated with a total cost (13) reflecting the cost (2) 1070 of the link 1068. The current least cost (8) would remain the same and the forwarding table would not be updated. Node 1012 receives an additional message [a, 11, 2] 1394 from node 1014 and the sequence number would be validated. The cost for the message would be updated with a total cost (15) reflecting the cost (4) 1074 of the link 1072. The current least cost (9) would remain the same and the forwarding table would not be updated. This ends the current BI.

After the current BI, the designated neighbors are illustrated in FIG. 55. For node 1002, the designated neighbor is node 1000 on link 1016. For node 1004, the designated neighbor is node 1000 on link 1020. For node 1006, the designated neighbor is node 1000 on link 1024. For node 1008, the designated neighbor is node 1004 on link 1040. For node 1010, the designated neighbor is node 1006 on link 1048. For node 1012, the designated neighbor is node 1006 on link 1052. For node 1014, the designated neighbor is node 1010 on link 1068. After two broadcast intervals, the least costs paths have been found for all nodes. The scout algorithm converges very rapidly, but at a cost of high overhead typical of flooding based methods.

### SUMMARY OF THE INVENTION

The first objective of this invention defines a method to determine, establish and maintain a communication path between interconnected communication units (CU). The communication system is scalable to a very large Integrated Infrastructure (II) environment with integrated wired and wireless services. The Integrated Infrastructure implies that there is no clear border between the wired and wireless domains. Every device is potentially fixed, non-fixed, multi-homed, and mobile nodes interconnected with wired and wireless links. Furthermore, the overall topology of II changes dynamically due to spatial or provisional diversity integrated into various components of the network. The method incorporates an agile, plug and play, fault-tolerant, scalable and secure networking layer that is also incrementally deployable and backward compatible with IP in existing network infrastructures.

The Small World Infrastructure (SWI) is a method to determine, establish and maintain a communication path between interconnected communication units (CU). The Small World Infrastructure (SWI) is implemented as an underlay network. The CUs will exhibit many social and physical relationships creating numerous contacts resulting in multiple overlapping small world networks. SWI utilizes the relational attributes inherit in the CU's which are incorporated in a general packet communications network to determine paths between CU's. These contact relationships are incorporated into the packet communication network as attributes for managing the traffic flows. The influential extension of association is reduced to a manageable domain allowing incorporation of complex provisioning and context attributes. These contact paths are implemented as the defining method for composing the Hierarchical Label Switched Path (H-LSP) in a MPLS or GMPLS domain.

The service model provides both indirection and direction services while maintaining the same IP semantics of traditional network infrastructures for backward compatibility. The model incorporates an underlay network supporting a rendezvous based communication abstraction. For indirection services, the rendezvous based communication abstraction decouples the act of sending from the act of receiving without changing existing IP semantics on CUs. For direction services, the sender directly communicates with the receiver maintaining backward compatibility with existing IP forwarding paradigms. The choice of direction or indirection services invoked for a connection and the propagation path is under the control of the source or destination nodes. By defining the Hierarchal Label Switched Path (H-LSP) in a hop-by-hop basis utilizing concatenated relational contacts, the rendezvous based abstraction service model can be implemented utilizing existing forwarding mechanisms (IP or MPLS).

Stigmergic systems, such as ant communities, exhibit many desirable attributes desired in communication networks. Stimergic systems are decentralized groups of components exhibiting no direct communication, but indirect communication through modification of their local or common environment. A Stigmergic system exhibits a complexity which is independent of community or colony size. The system is self-organized in nature and has no global coordination. Each individual component (node) has independent influence on its domain or virtual colony utilizing its own set of virtual ants to explore the colony.

Virtual ants perform initialization, configuration, discovery, maintenance and optimization functions within the Small World Infrastructure (SWI) network. Virtual ants are implemented as separate messages as well as embedded within the components of normal traffic packets within the SWI network. Virtual Ants are linked with the creation of LSP's and H-LSP's within the SWI network.

Another objective of this invention is to provide the apparatus to enable the implementation of Virtual Ants within a Small World Infrastructure underlay network in an efficient, scalable and flexible packet communications system independent of the underlying network routing protocols.

### BRIEF DESCRIPTION OF THE DRAWINGS

FIG. 1 illustrates the degrees of separation between contacts in a small world relationship graph;

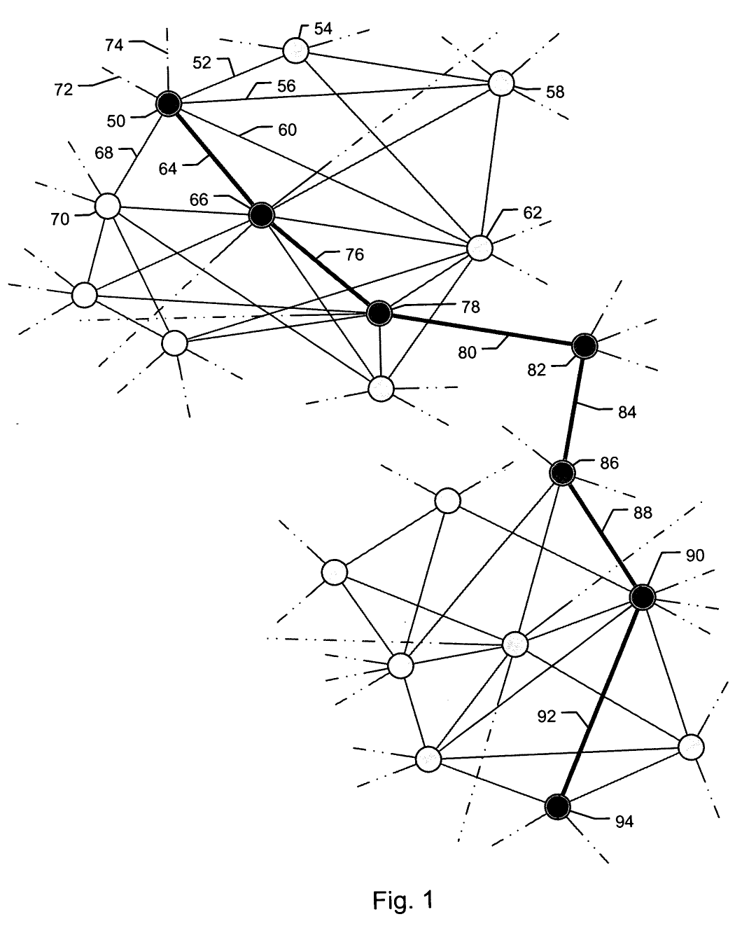

FIG. 2 illustrates the contact domain associated with a node in a small world relationship graph;

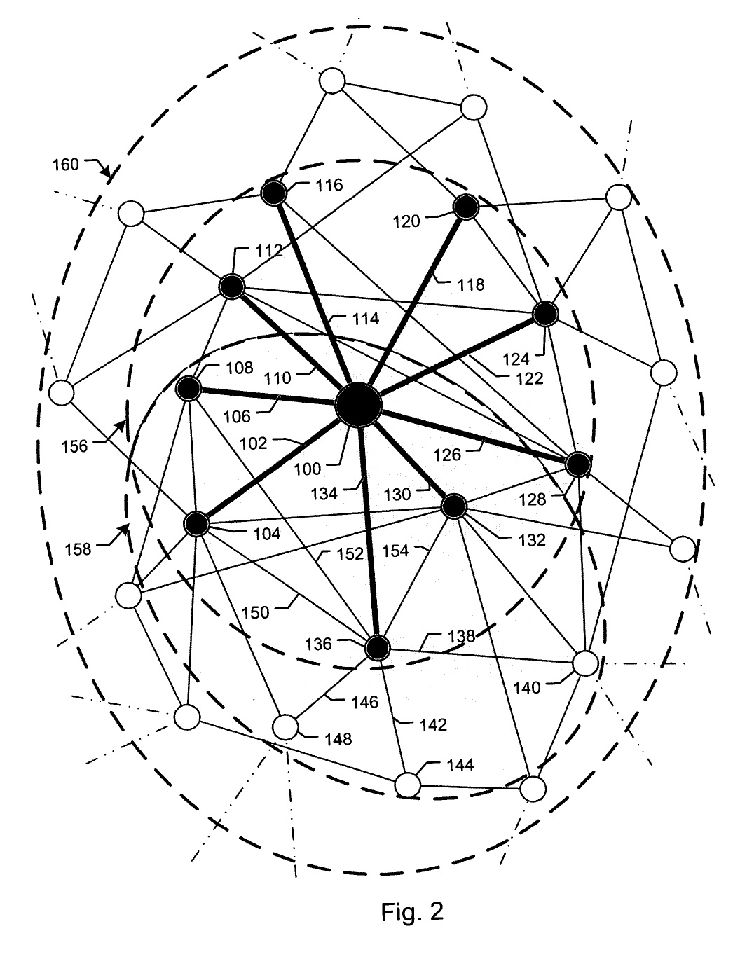

FIG. 3 illustrates the effect of reach in multiple contact domains in a small world relationship graph;

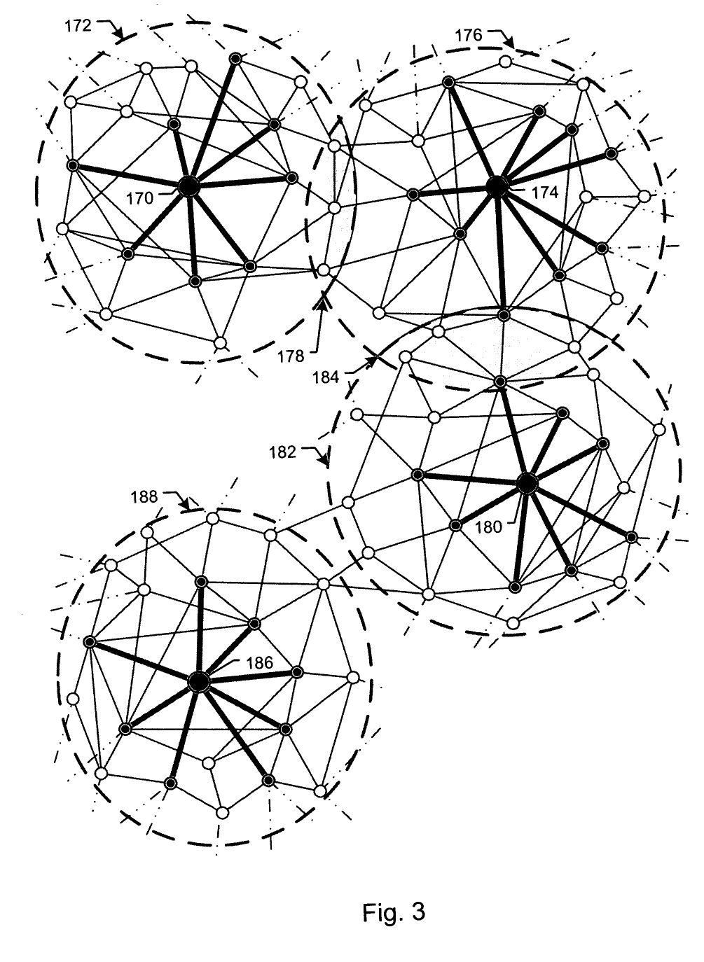

FIG. 4 illustrates a small world relationship graph with a stationary node and a mobile node in its initial position with overlapping contact domains;

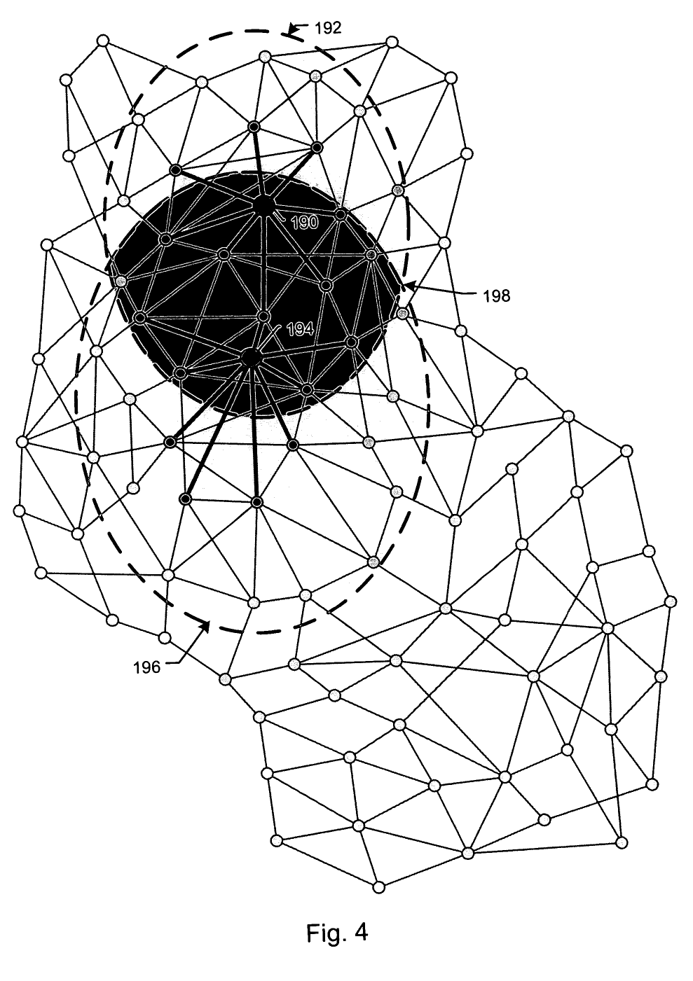

FIG. 5 illustrates a small world relationship graph with a stationary node and a mobile node in an intermediate position with overlapping contact domains;

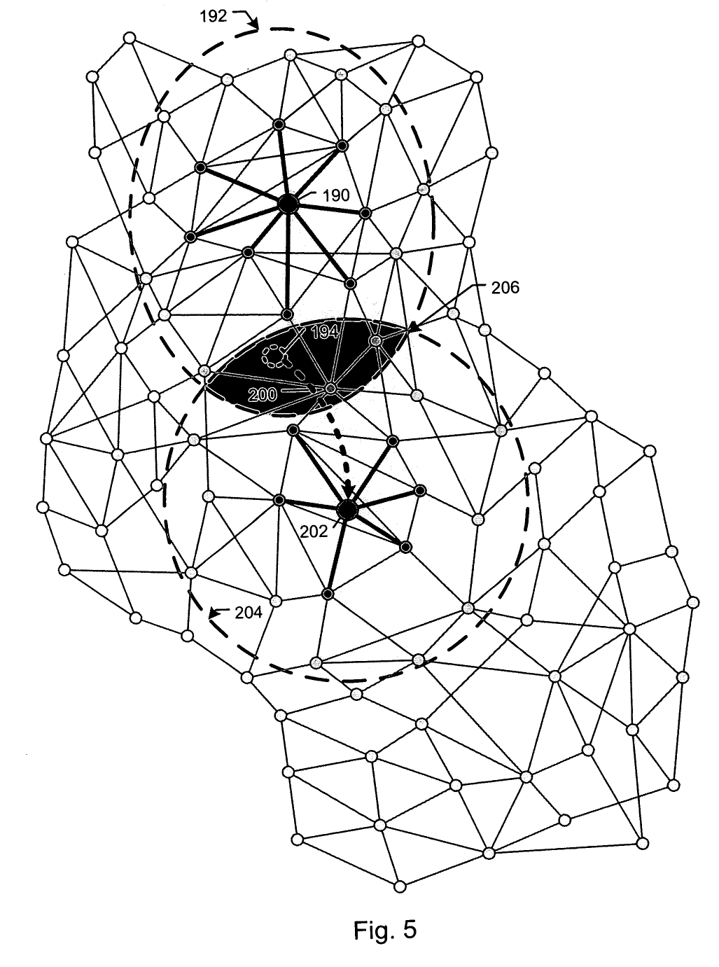

FIG. 6 illustrates a small world relationship graph with a stationary node and a mobile node in an intermediate position with non-overlapping contact domains;

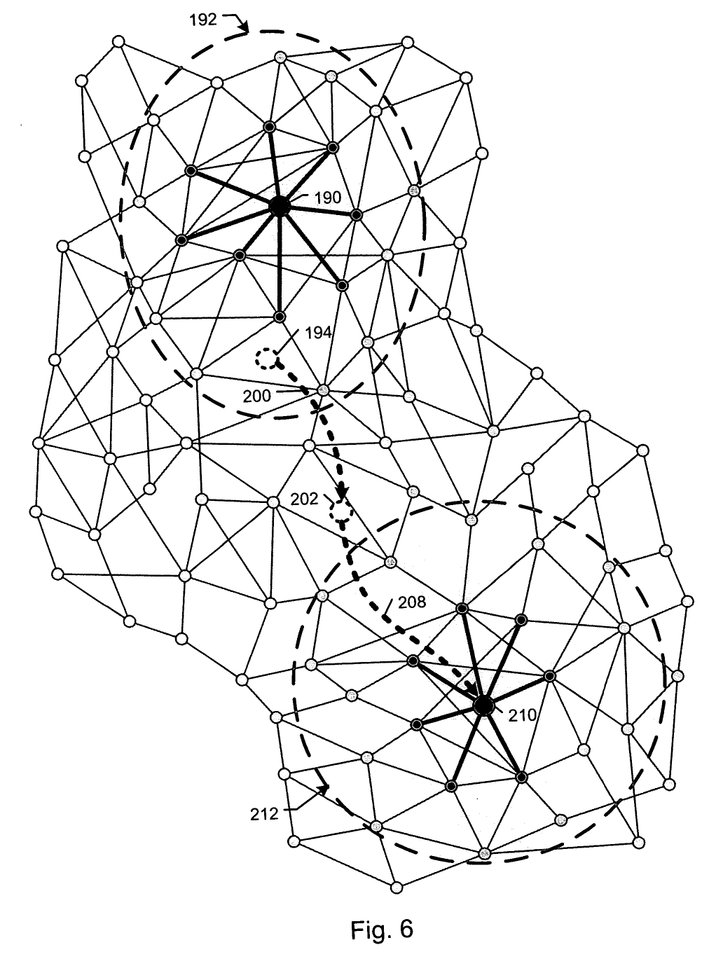

FIG. 7 illustrates a small world relationship graph with a stationary node and a mobile node in an intermediate position with non-overlapping contact domains with the introduction of an extension contact node;

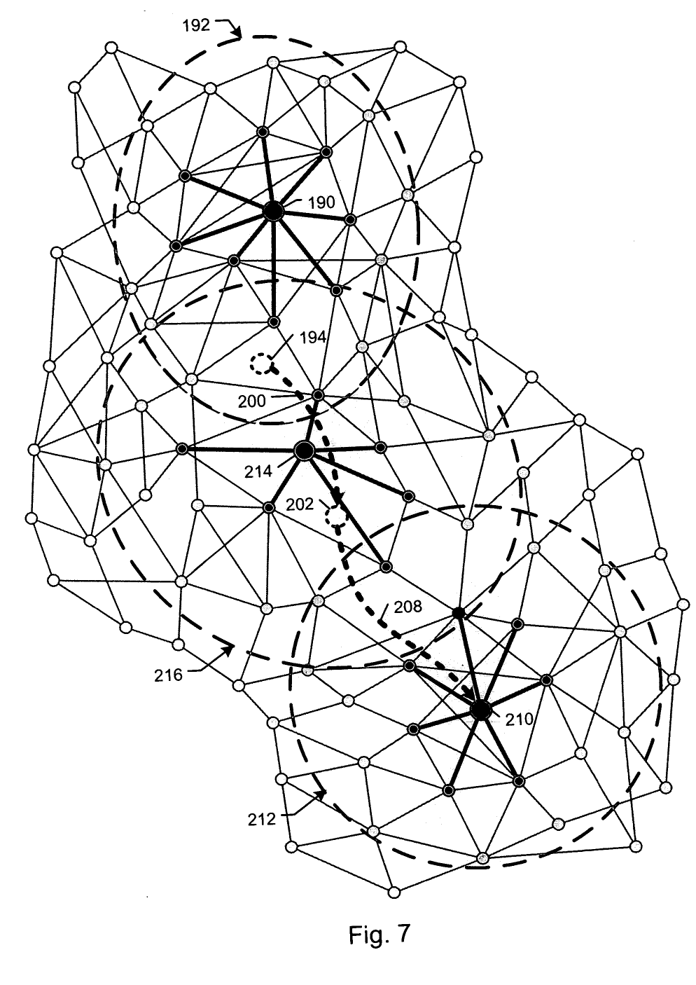

FIG. 8 illustrates a MPLS domain with multiple Label Switched Paths;

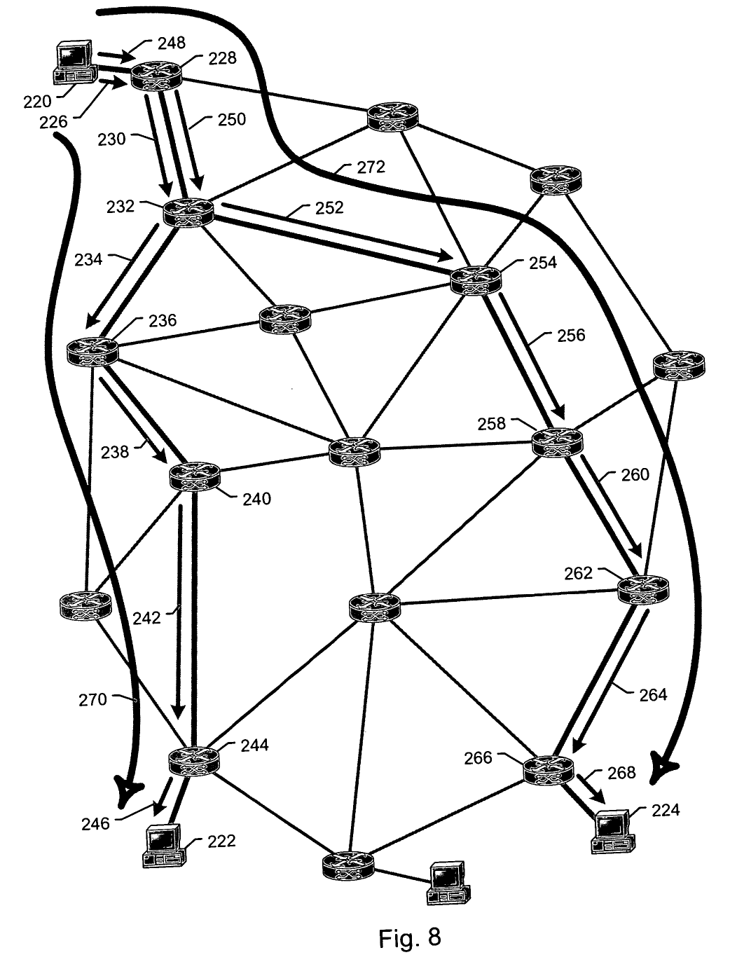

FIG. 9 illustrates a MPLS domain showing the distribution of label mappings in the creation of a Label Switched Path;

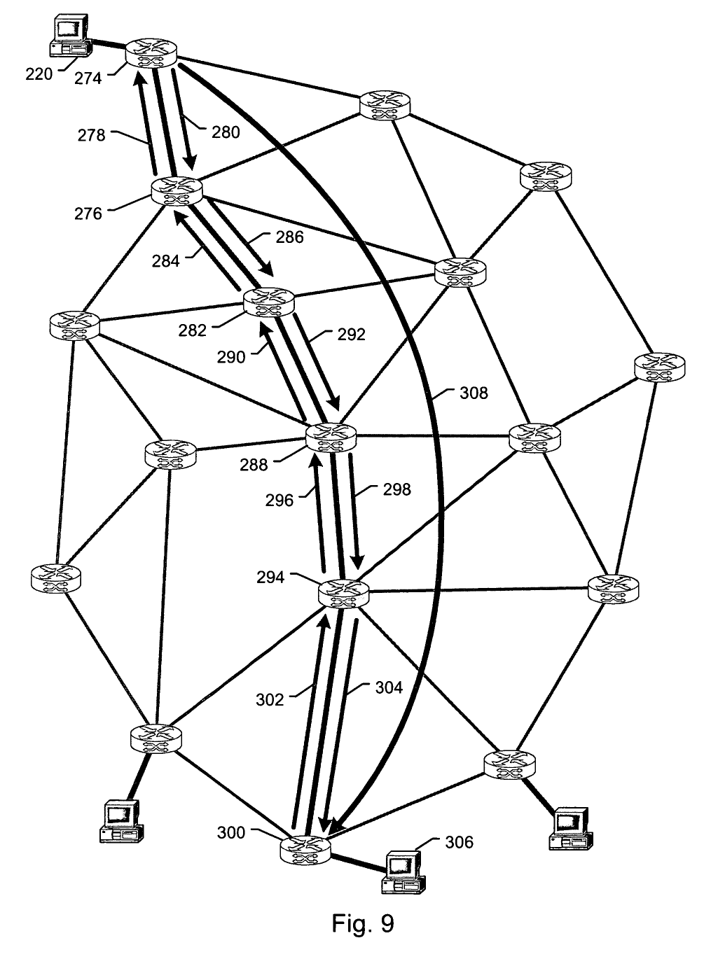

FIG. 10 illustrates an Internet Indirection Infrastructure, using rendezvous based communications in a unicast situation;

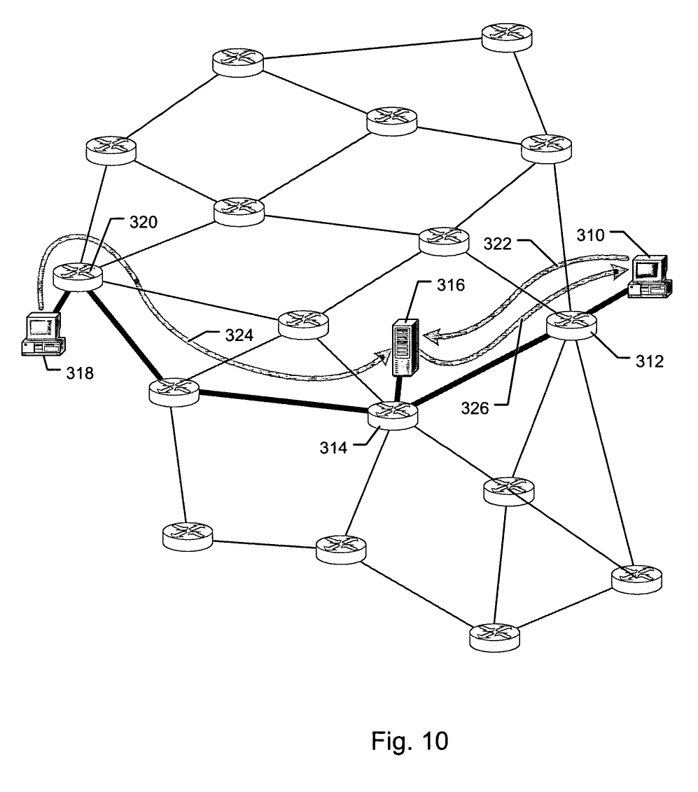

FIG. 11 illustrates an Internet Indirection Infrastructure, using rendezvous based communications in a multicast situation;

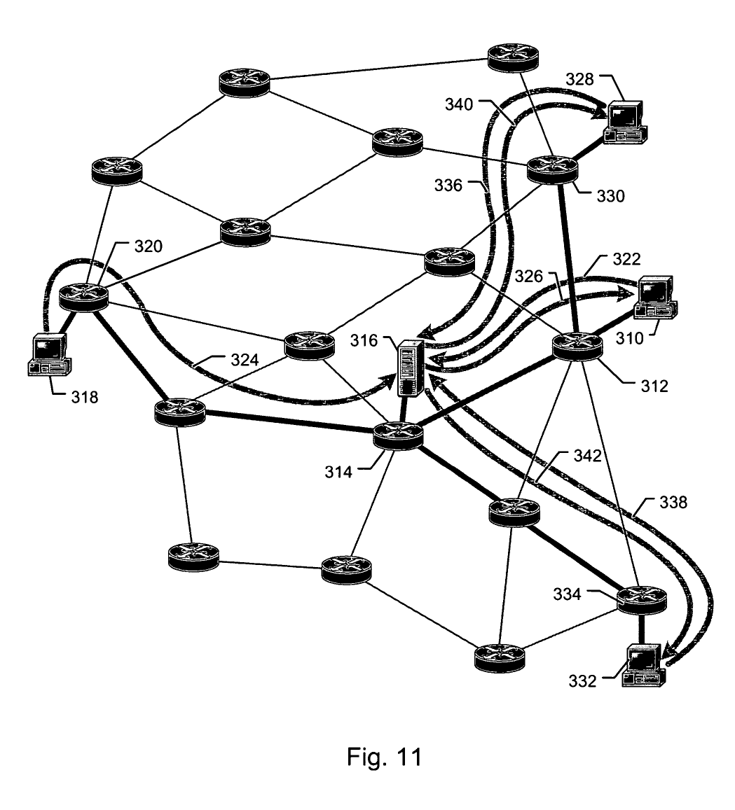

FIG. 12 illustrates an Internet Indirection Infrastructure, using rendezvous based communications in an anycast situation;

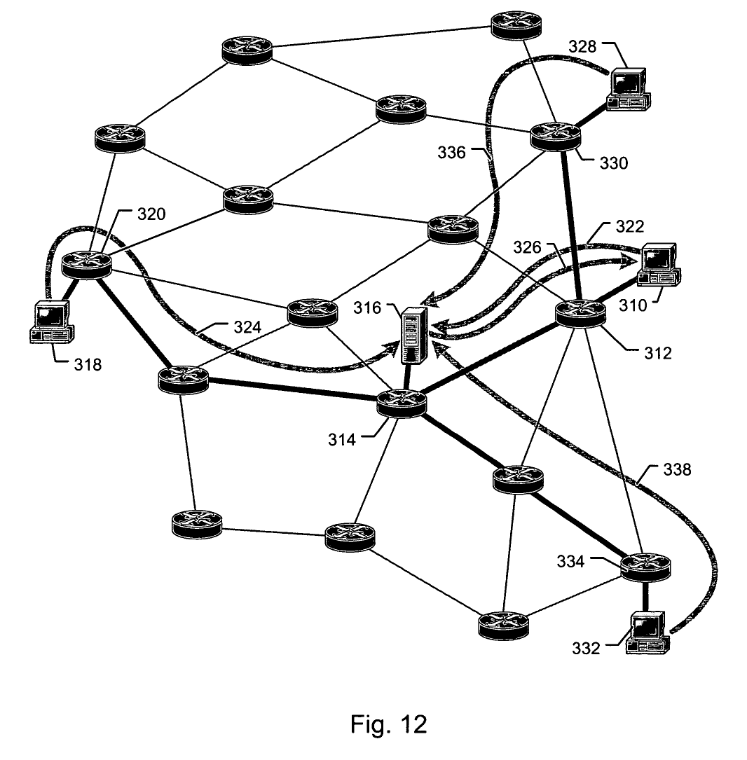

FIG. 13 illustrates an Internet Indirection Infrastructure, using rendezvous based communications in a mobile dynamic situation;

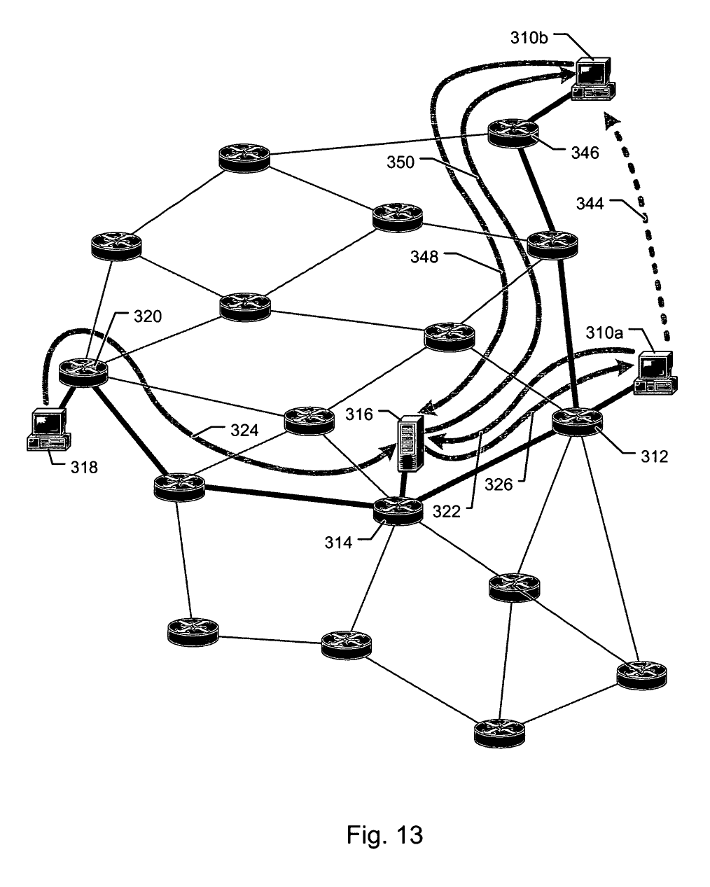

FIG. 14 illustrates a MPLS domain showing label merging or flow aggregation;

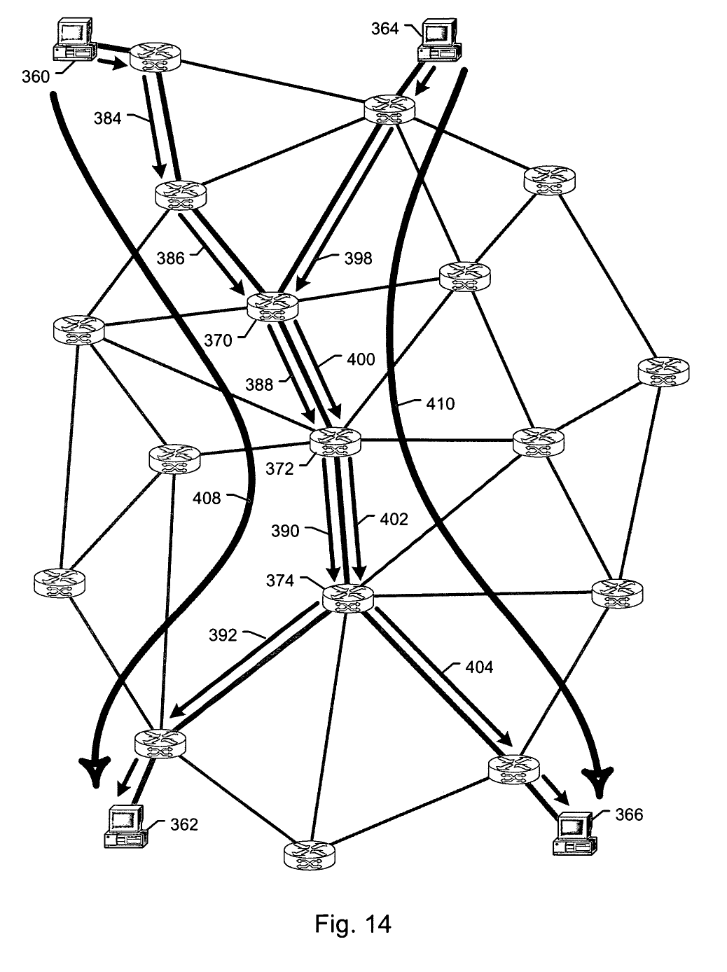

FIG. 15 illustrates a GMPLS domain showing hierarchical structure occurring in bandwidth or flow aggregation;

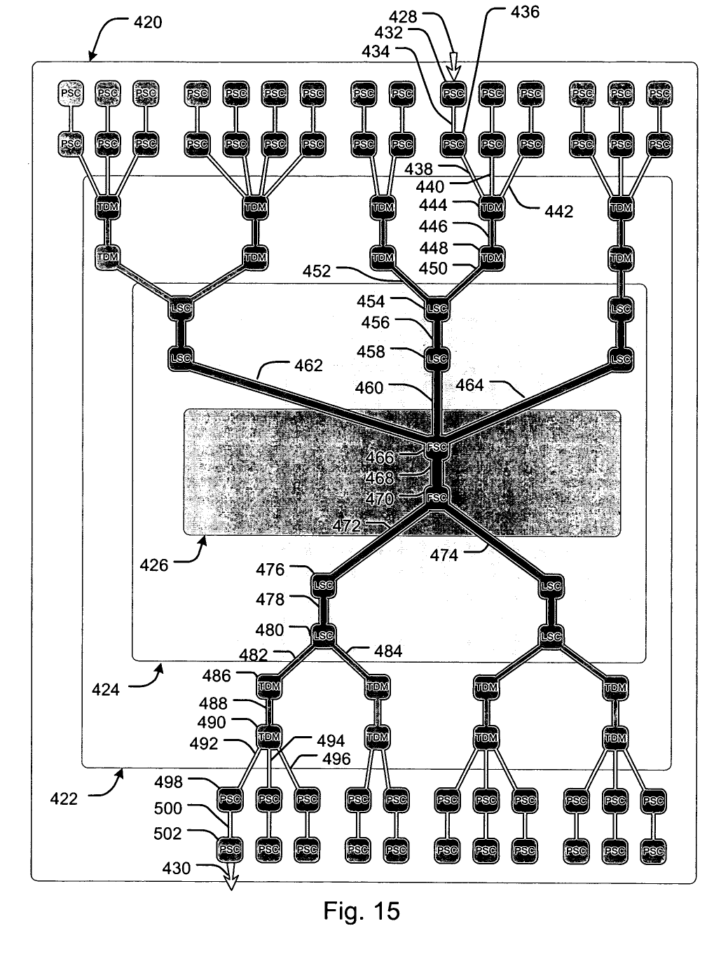

FIG. 16 illustrates a GMPLS domain showing the Hierarchal LSP creation process used in bandwidth or flow aggregation;

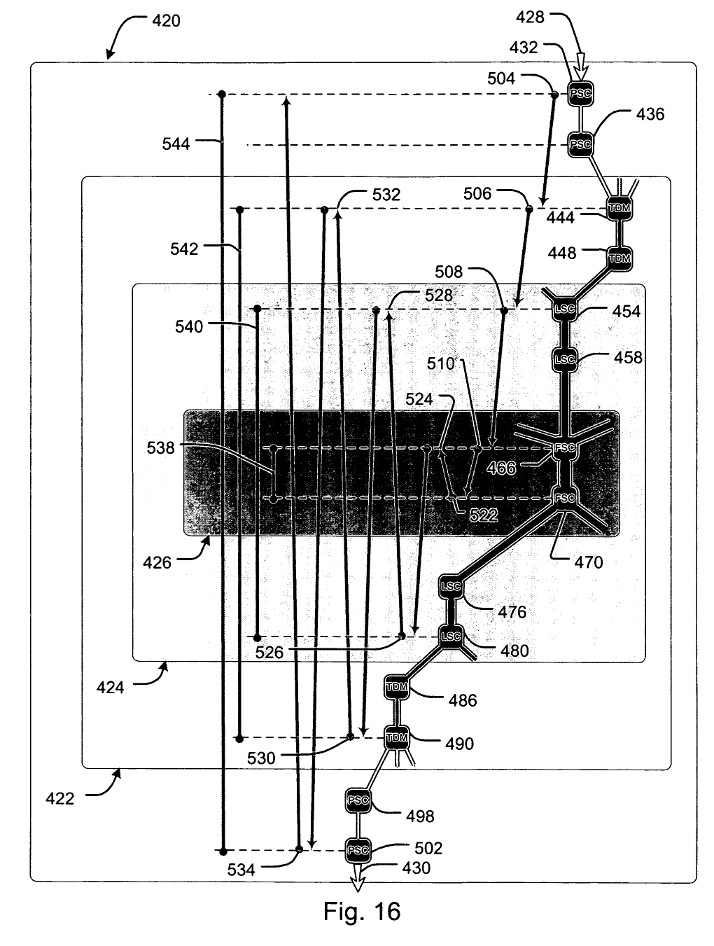

FIG. 17 illustrates label stacking for a homogeneous Hierarchical LSP sequence;

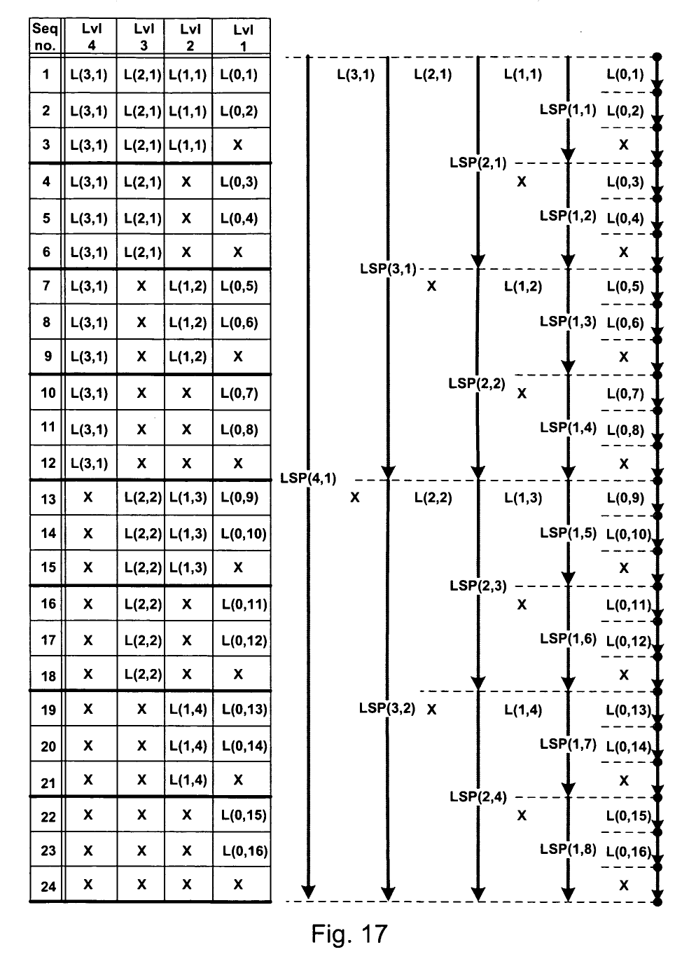

FIG. 18 illustrates label stacking for an inhomogeneous Hierarchical LSP sequence;

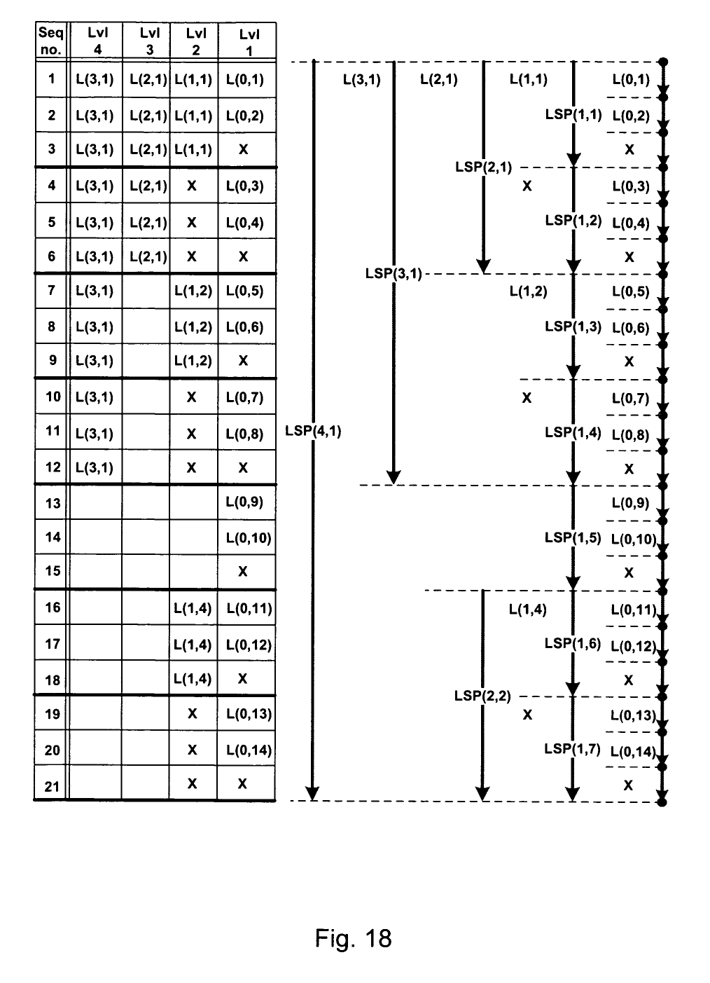

FIG. 19 illustrates contact mapping in a MPLS domain;

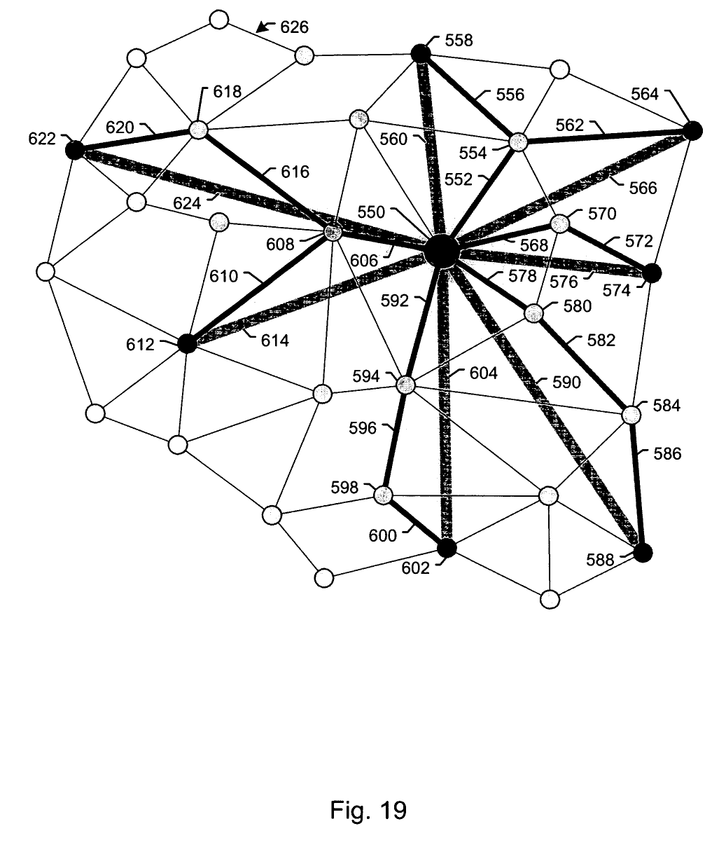

FIG. 20 illustrates extending contact mapping in a MPLS domain;

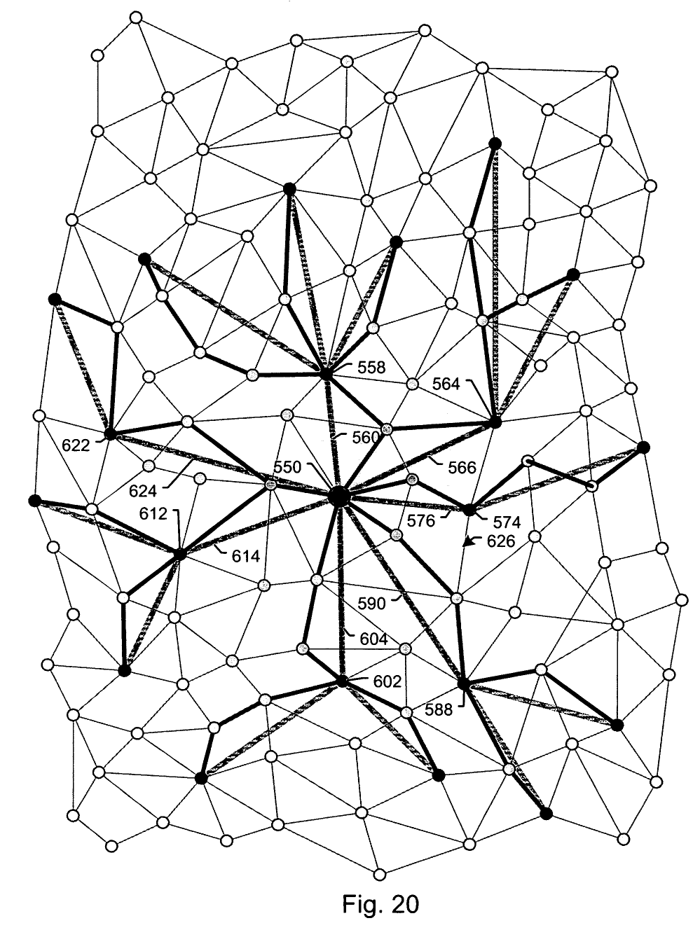

FIG. 21 illustrates extending contact mapping in a MPLS domain;

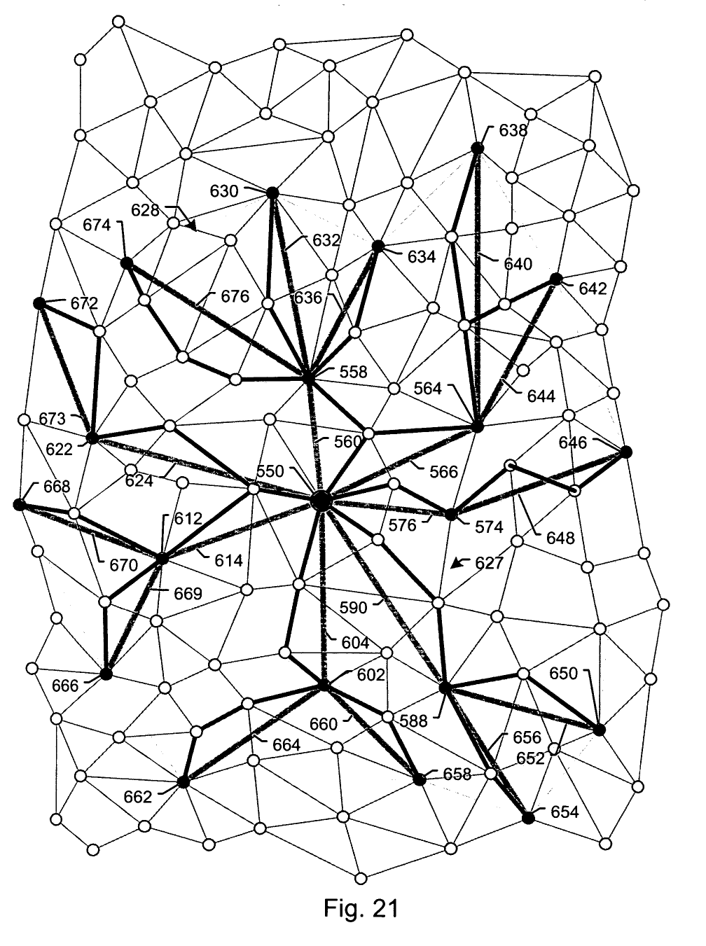

FIG. 22 illustrates contact hierarchy in a MPLS domain;

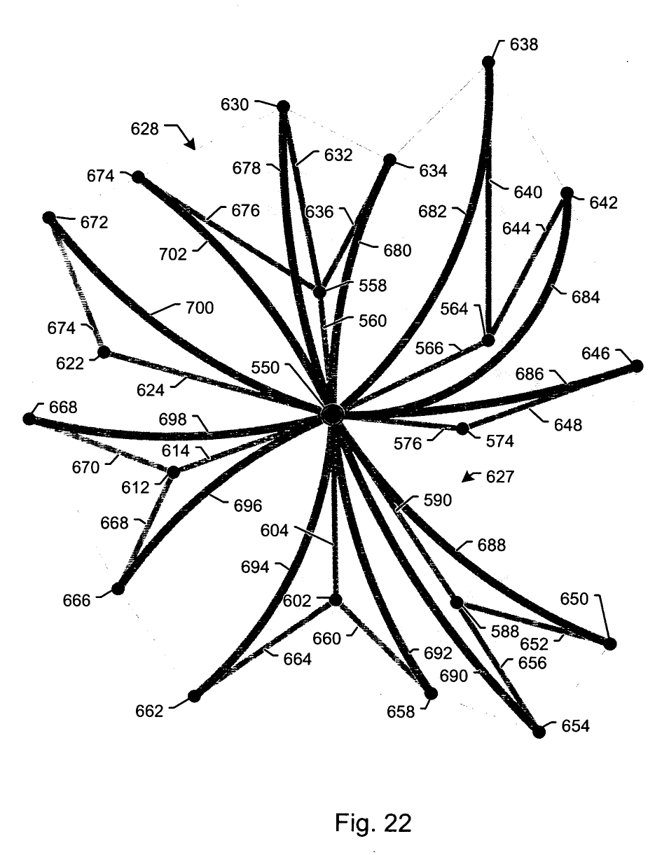

FIG. 23 illustrates a level 2 contact domain;

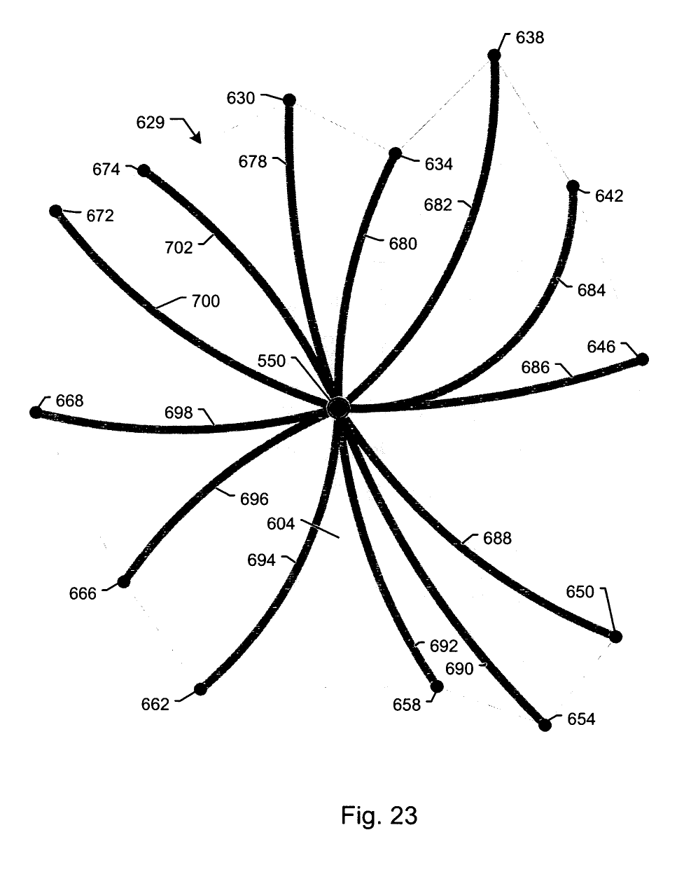

FIG. 24 illustrates Small World Infrastructure rendezvous based communications from receiver to rendezvous point for indirection service;

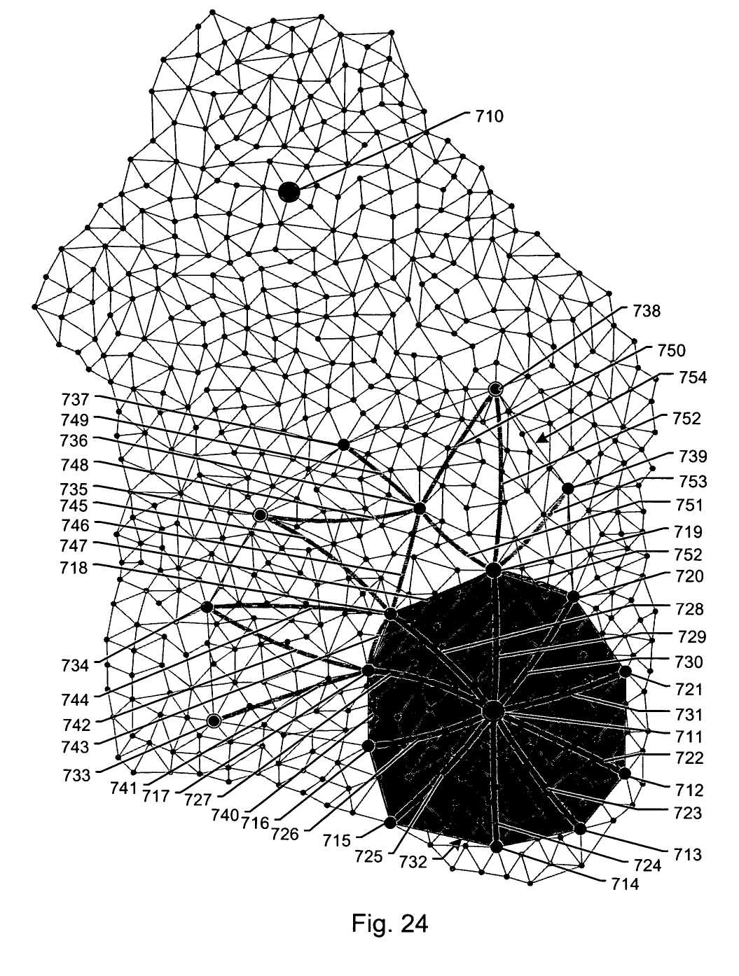

FIG. 25 illustrates Small World Infrastructure triggers for indirection service;

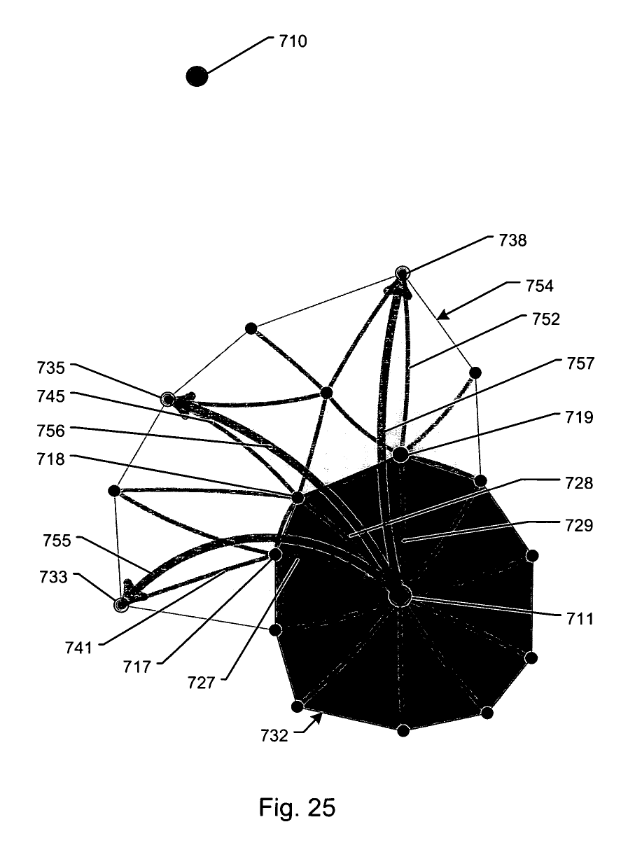

FIG. 26 illustrates Small World Infrastructure rendezvous based communications from sender to rendezvous point for indirection service;

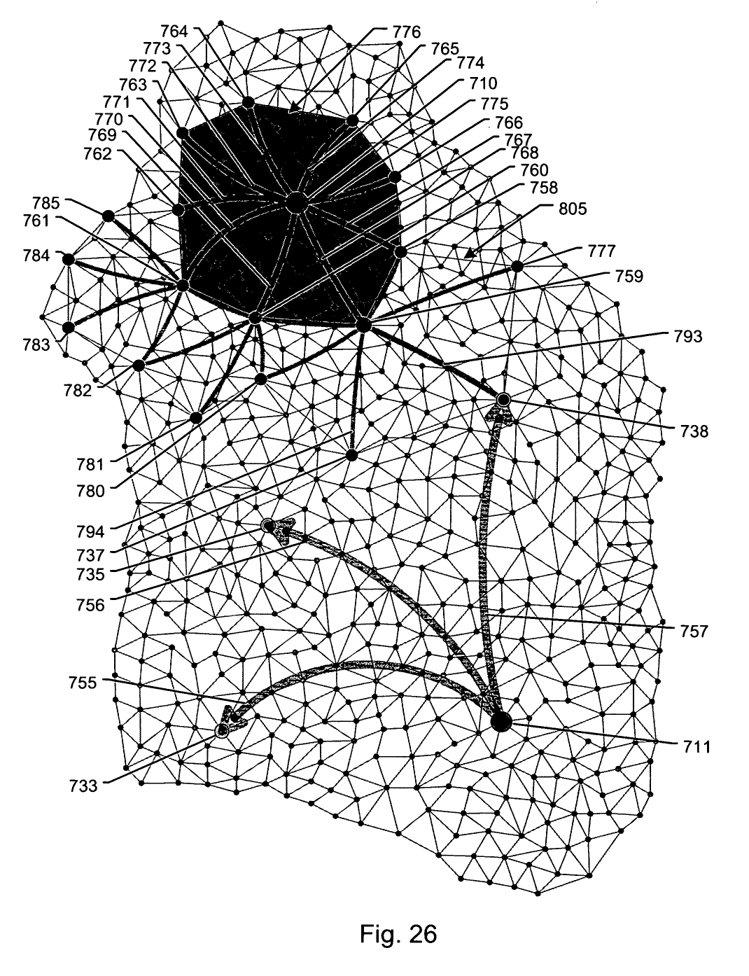

FIG. 27 illustrates Small World Infrastructure identifier lookup for indirection service;

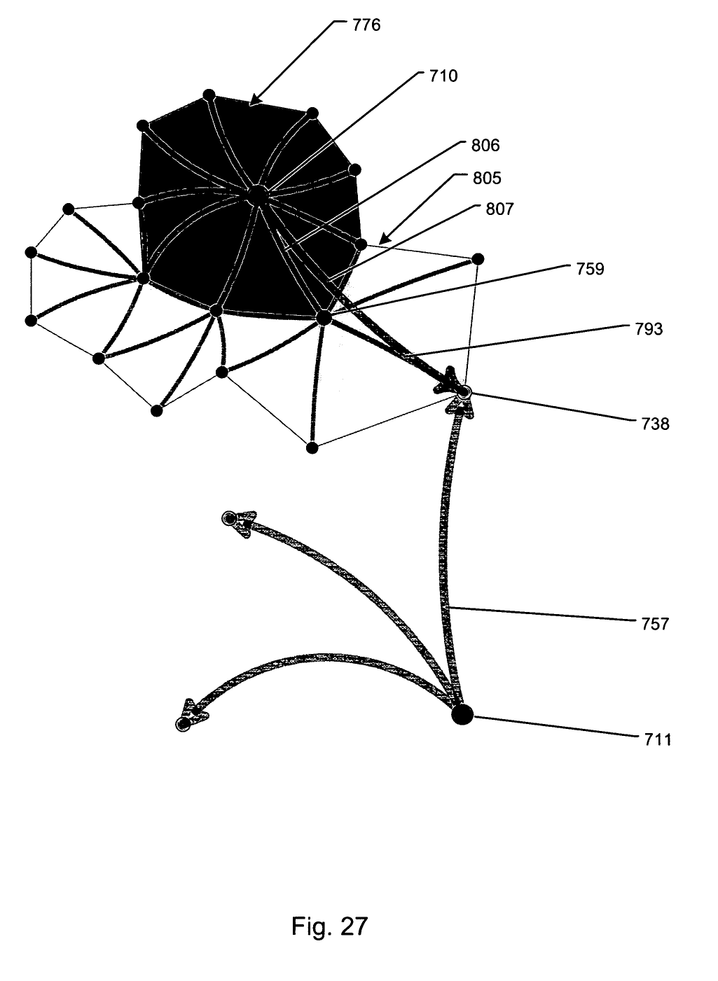

FIG. 28 illustrates Small World Infrastructure rendezvous based communications from sender to receiver for indirection service;

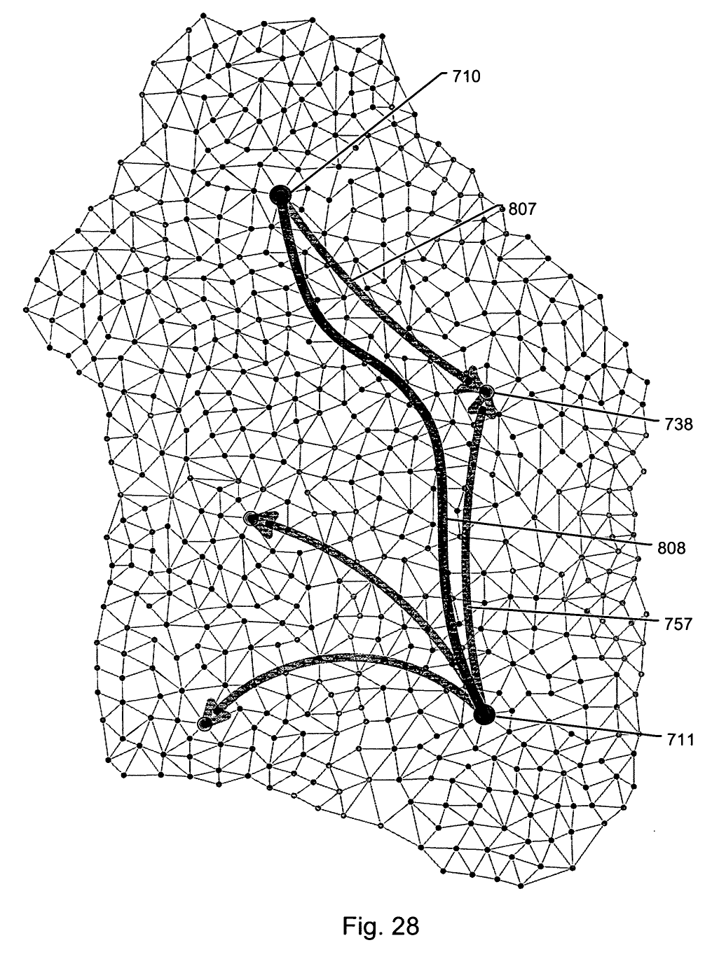

FIG. 29 illustrates Small World Infrastructure rendezvous based communications from sender to receiver for direction service;

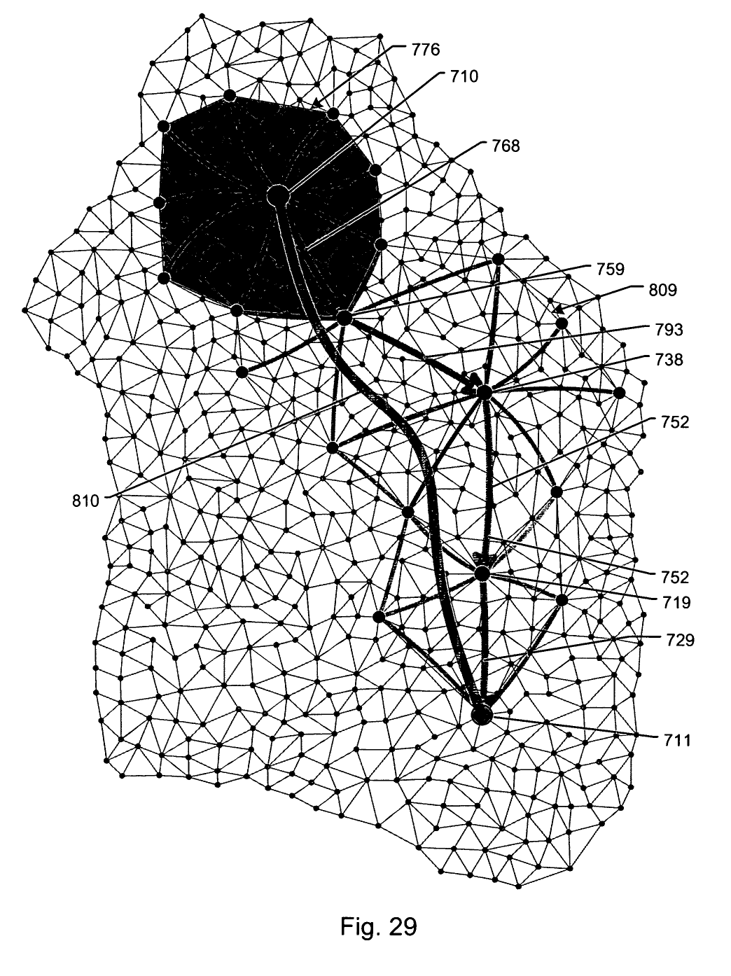

FIG. 30 illustrates Small World Infrastructure rendezvous based communications from sender to receiver for a mobile indirection service;

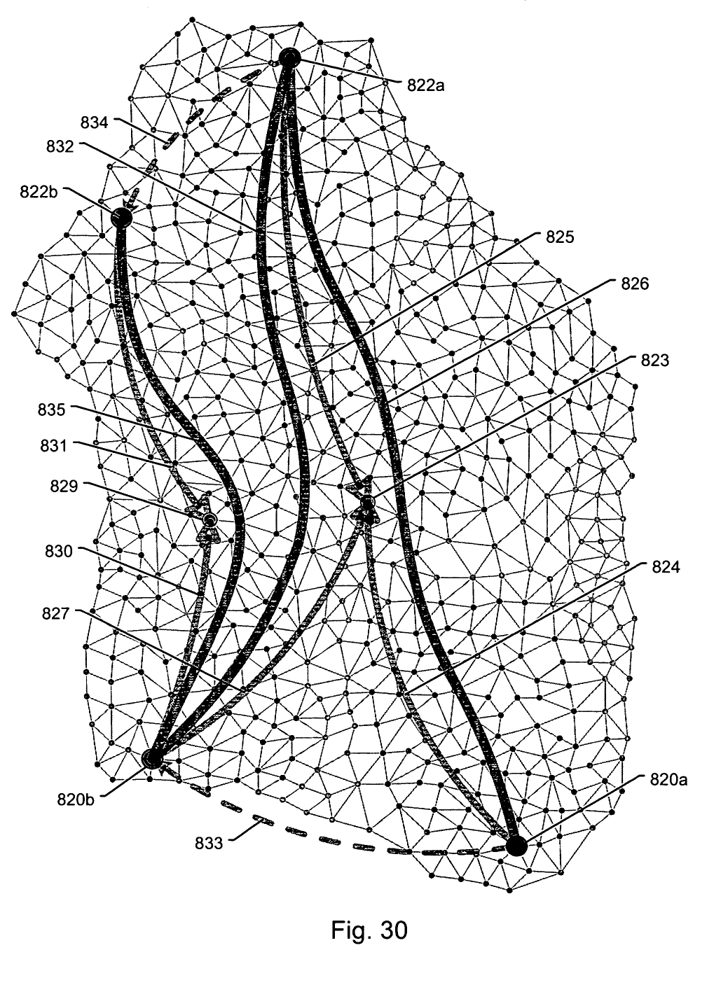

FIG. 31 illustrates Small World Infrastructure rendezvous based communications from sender to receiver for a multicast indirection service;

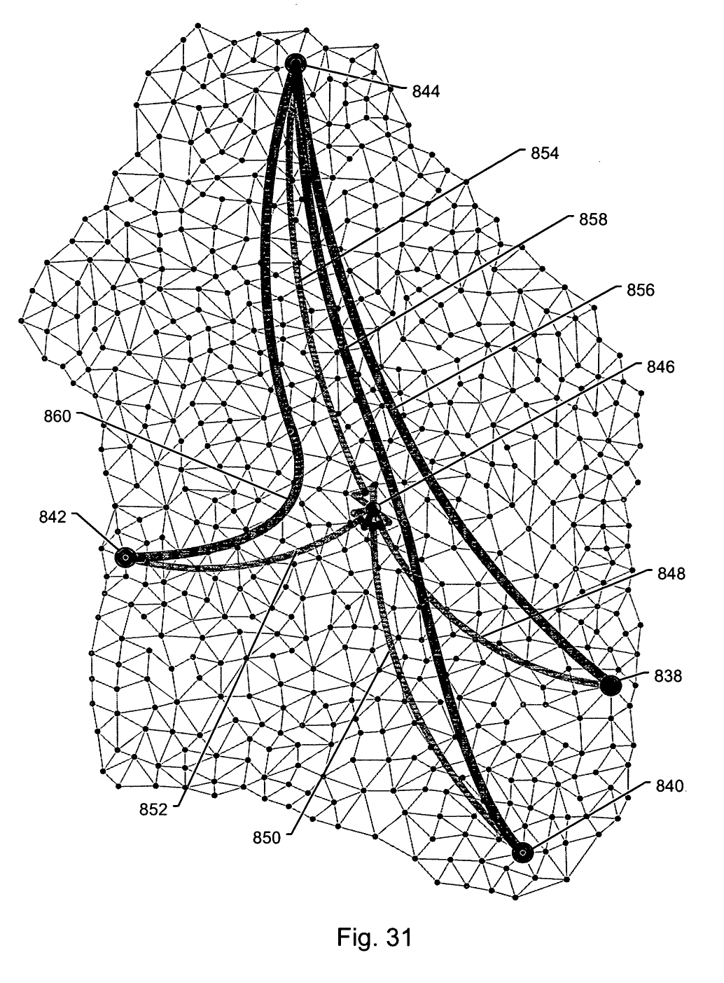

FIG. 32 illustrates Small World Infrastructure rendezvous based communications from sender to receiver for an anycast indirection service;

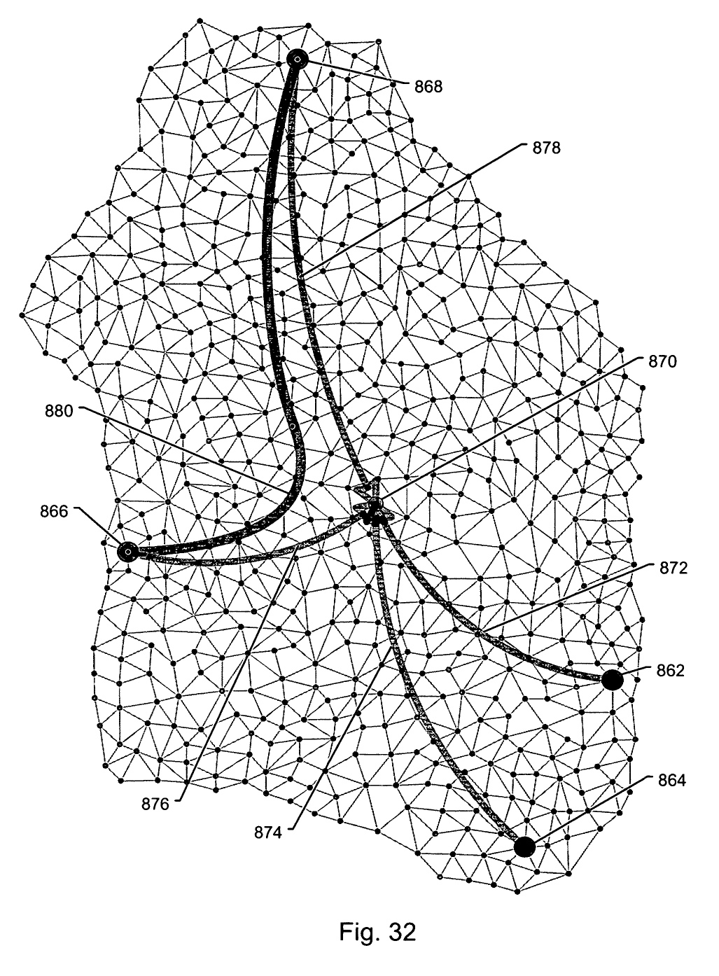

FIG. 33 illustrates ID stacking in Small World Infrastructure rendezvous based communications from sender to receiver for indirection service;

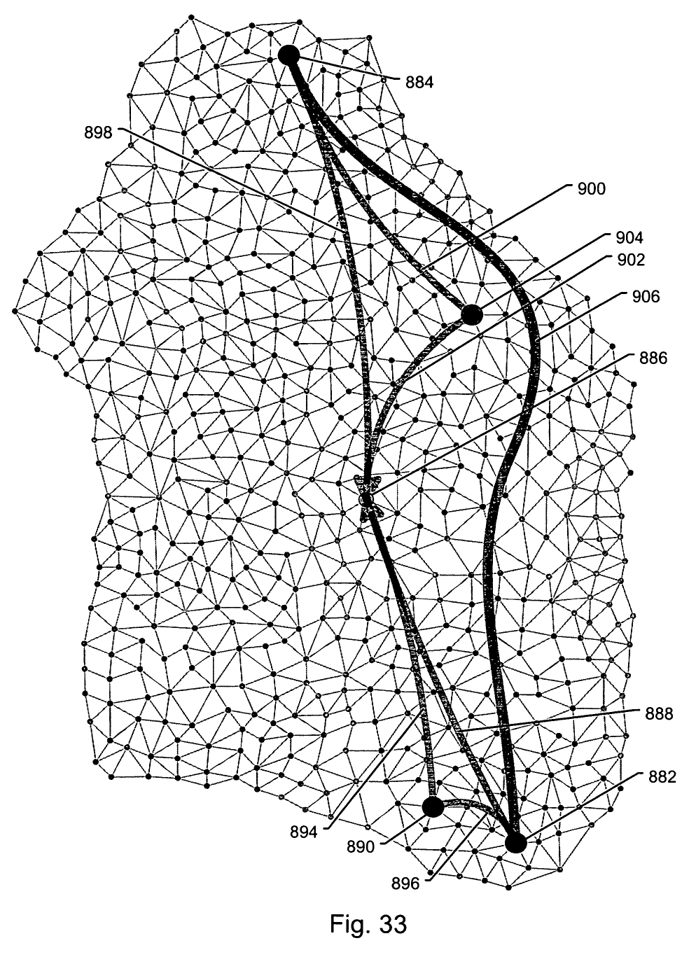

FIG. 34 illustrates generalized trigger in Small World Infrastructure rendezvous based communications from sender to receiver for indirection service;

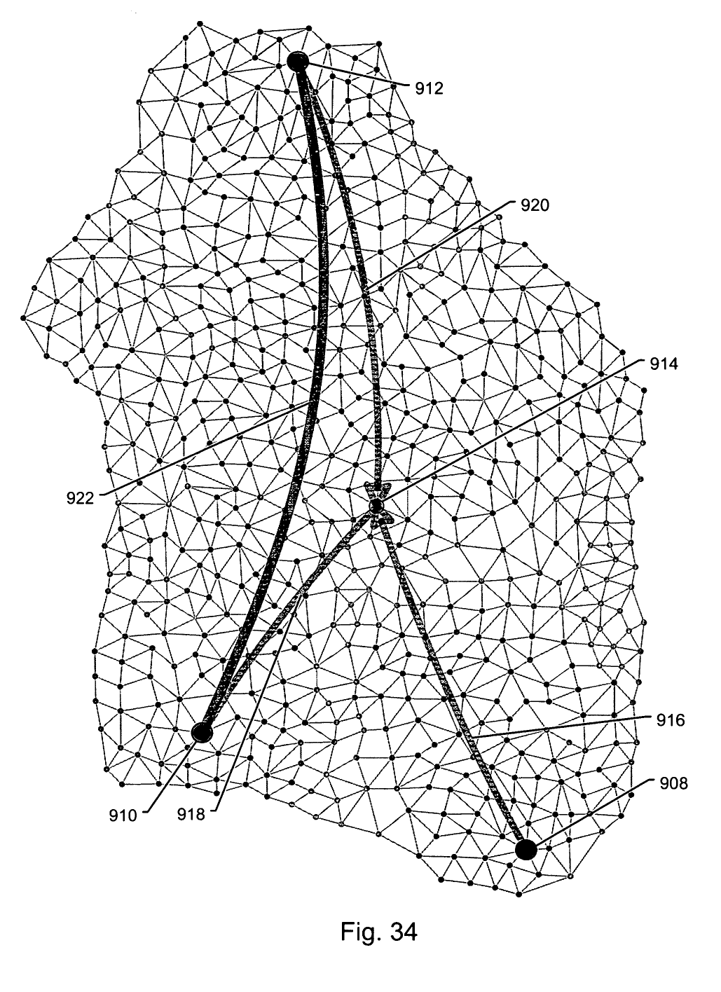

FIG. 35 illustrates a simple network topology with non-uniform link costs;

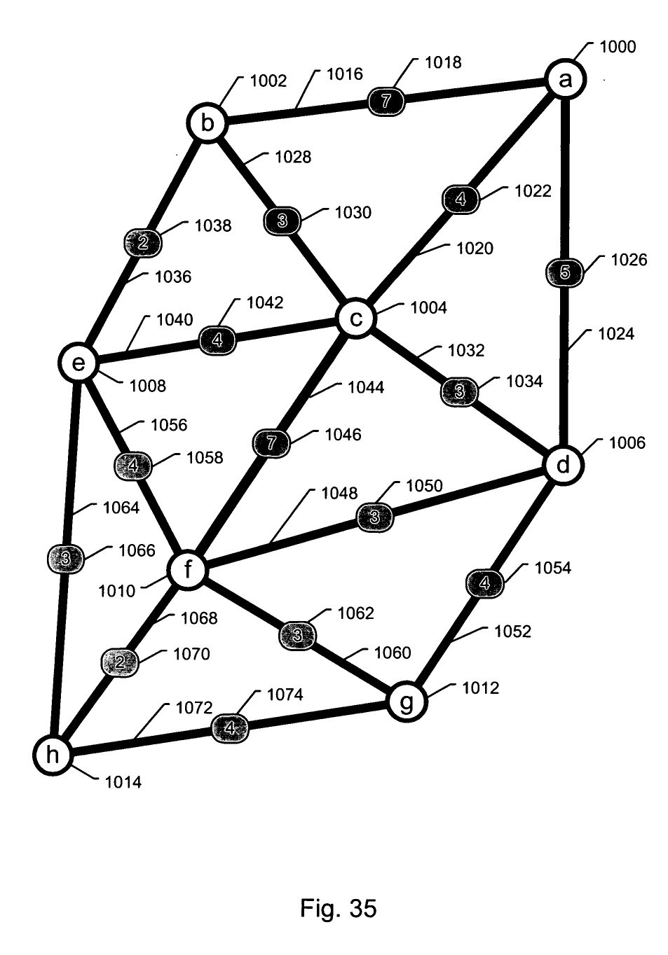

FIG. 36 illustrates a simple network topology with non-uniform link costs with accumulated link costs for destination node a;

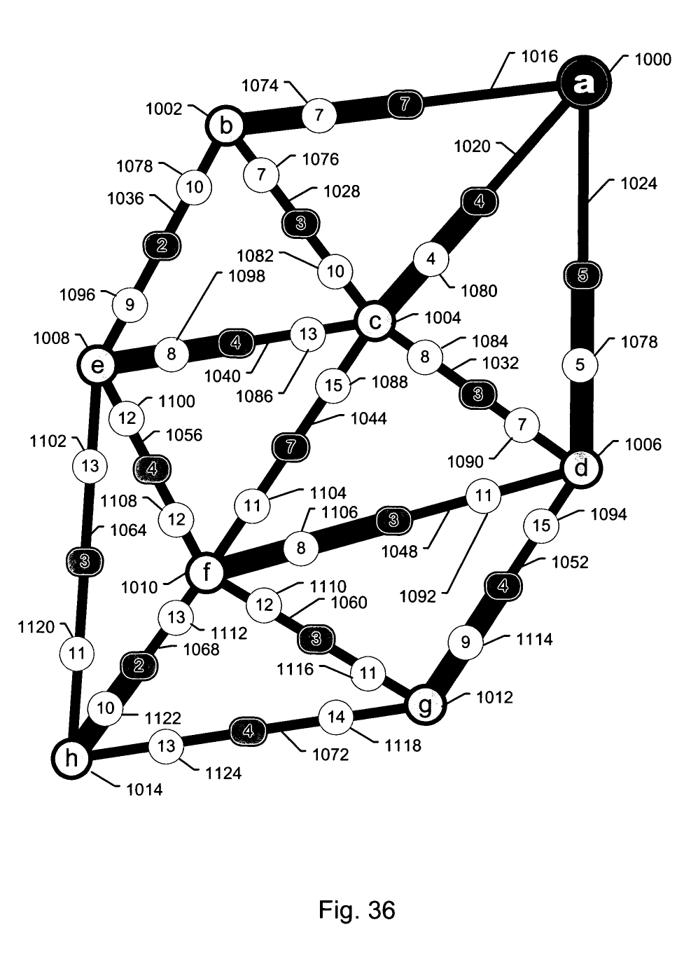

FIG. 37 illustrates a simple network topology with non-uniform link costs with accumulated link costs for destination node h;

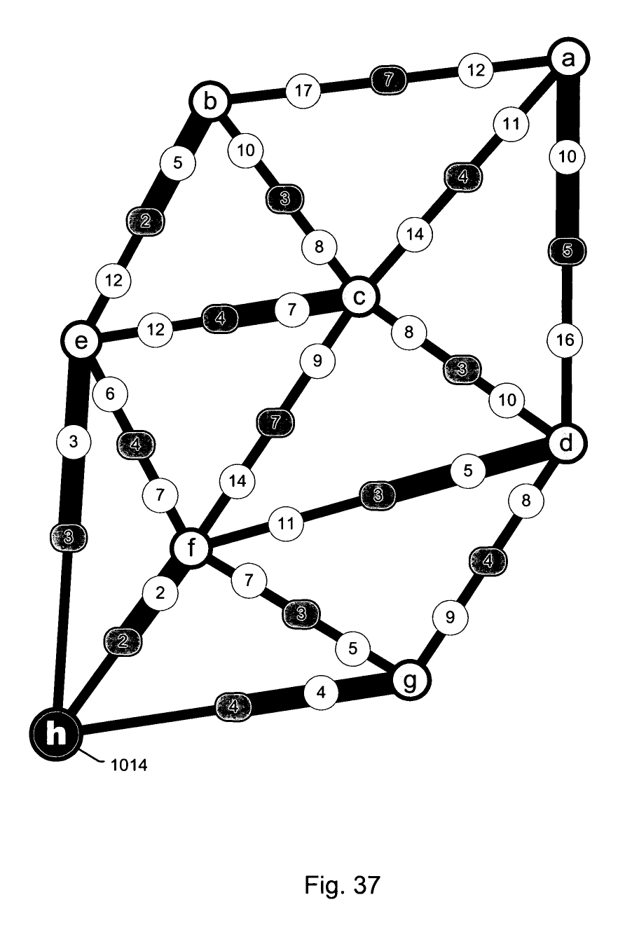

FIG. 38 illustrates a simple network topology with non-uniform link costs with accumulated link costs for destination node g;

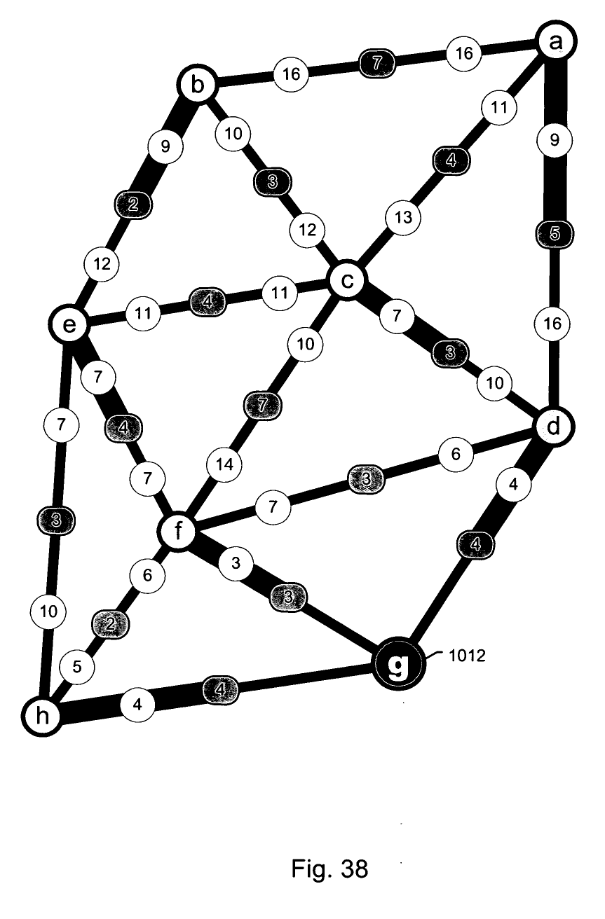

FIG. 39 illustrates the initial deployment of regular exploratory ants in a simple network topology;

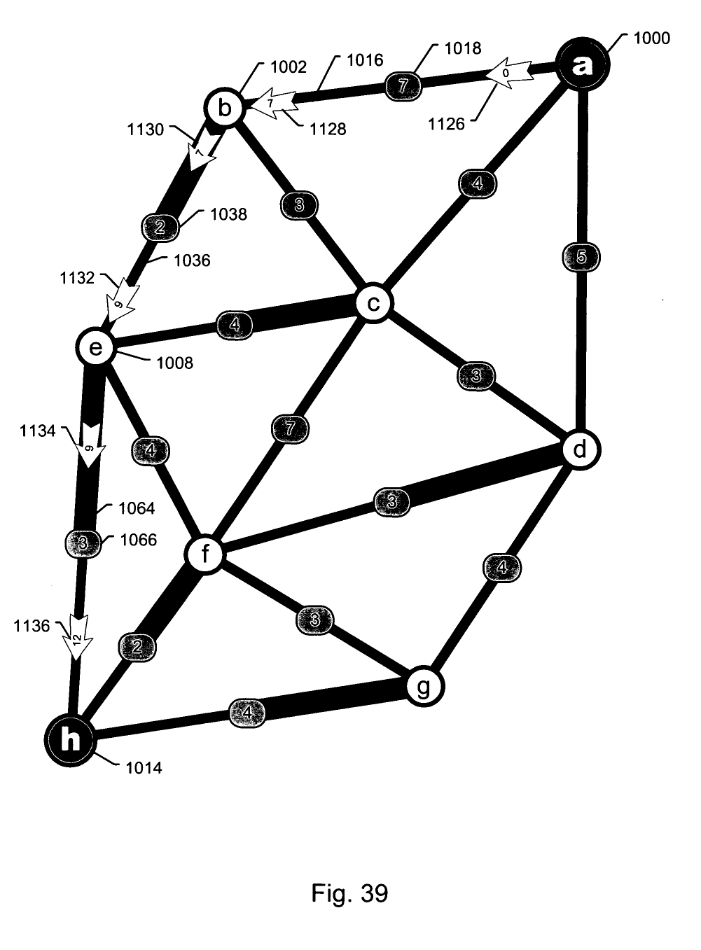

FIG. 40 illustrates the impact of regular ants on the router forwarding probabilities;

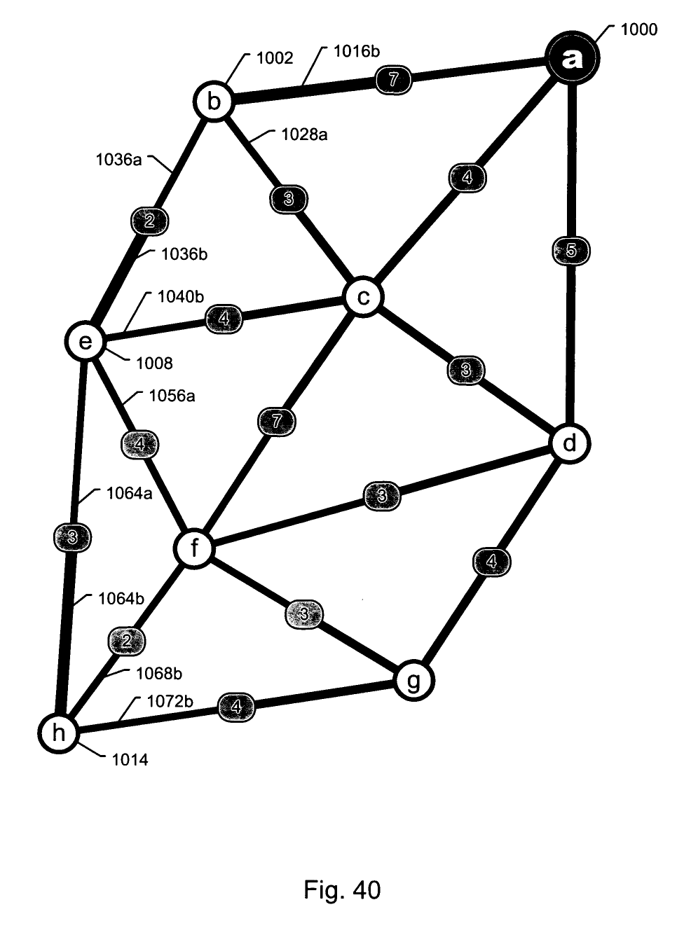

FIG. 41 illustrates an intermediate deployment of regular exploratory ants in a simple network topology;

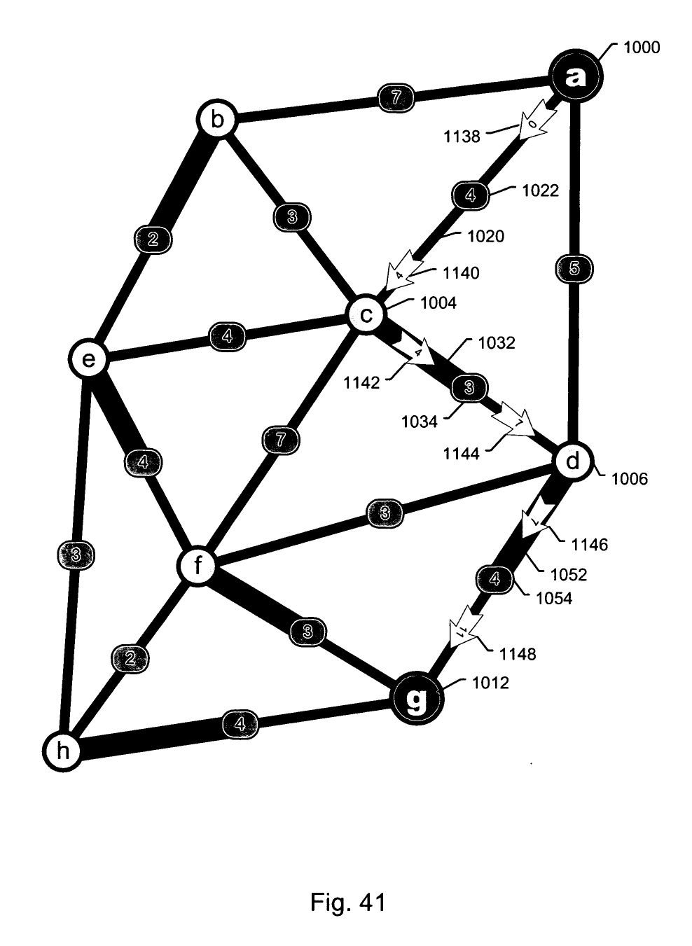

FIG. 42 illustrates an intermediate state of the router forwarding probabilities with regular exploratory ants;

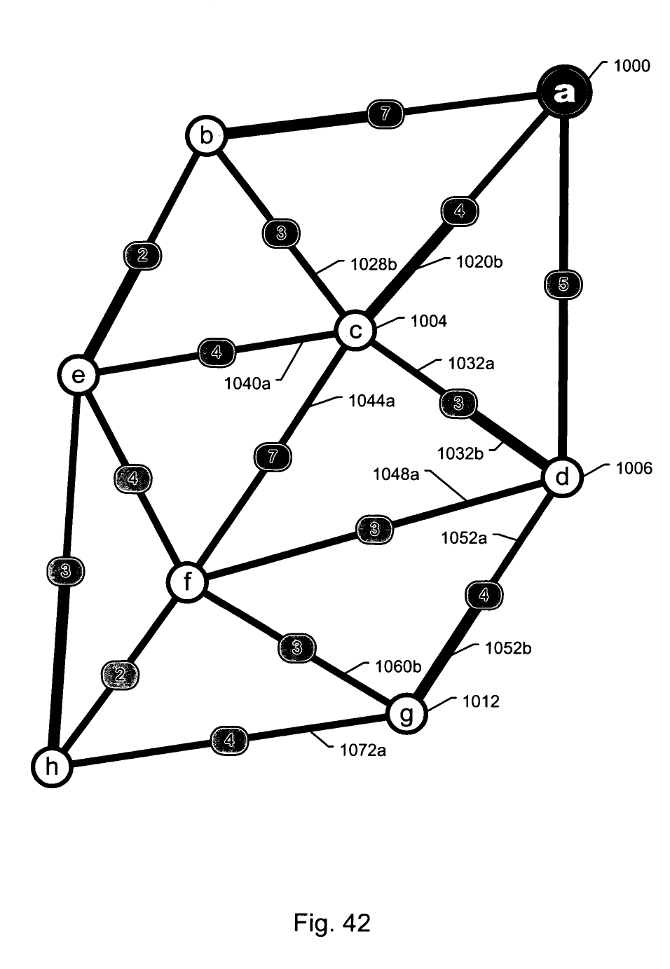

FIG. 43 illustrates an intermediate deployment of regular exploratory ants in a simple network topology;

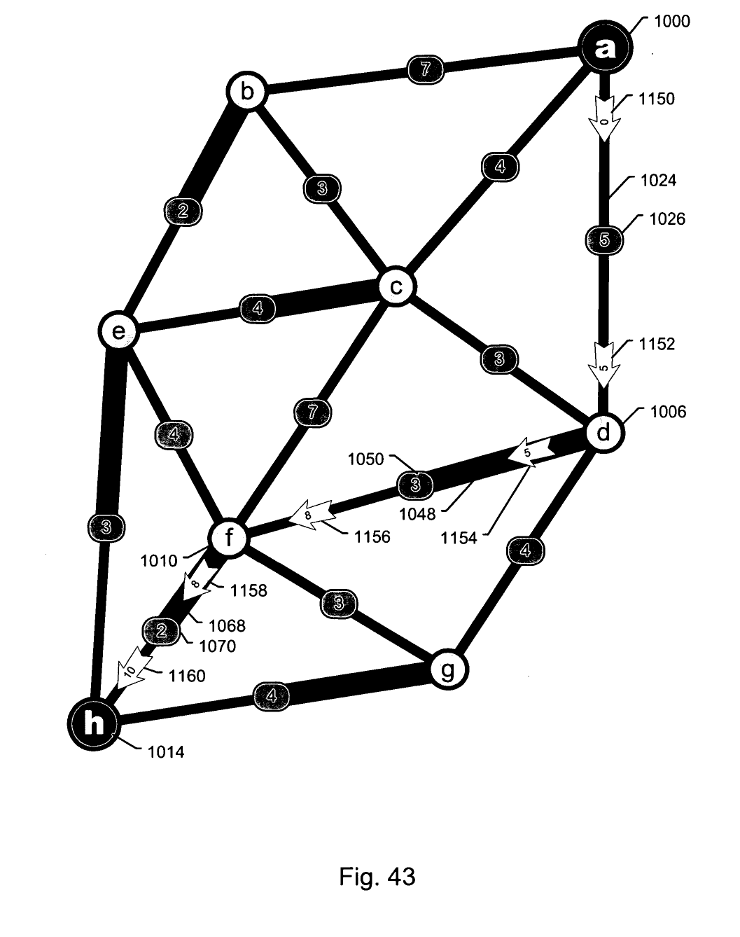

FIG. 44 illustrates an intermediate state of the router forwarding probabilities with regular exploratory ants;

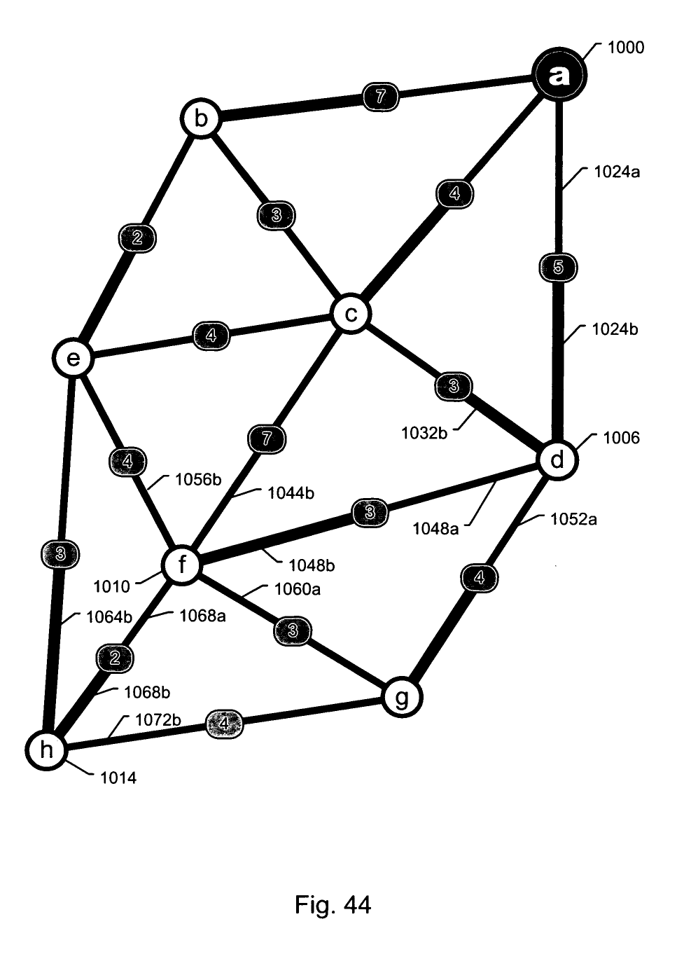

FIG. 45 illustrates an intermediate state of the router forwarding probabilities with inactive link probabilities converging to zero with regular exploratory ants;

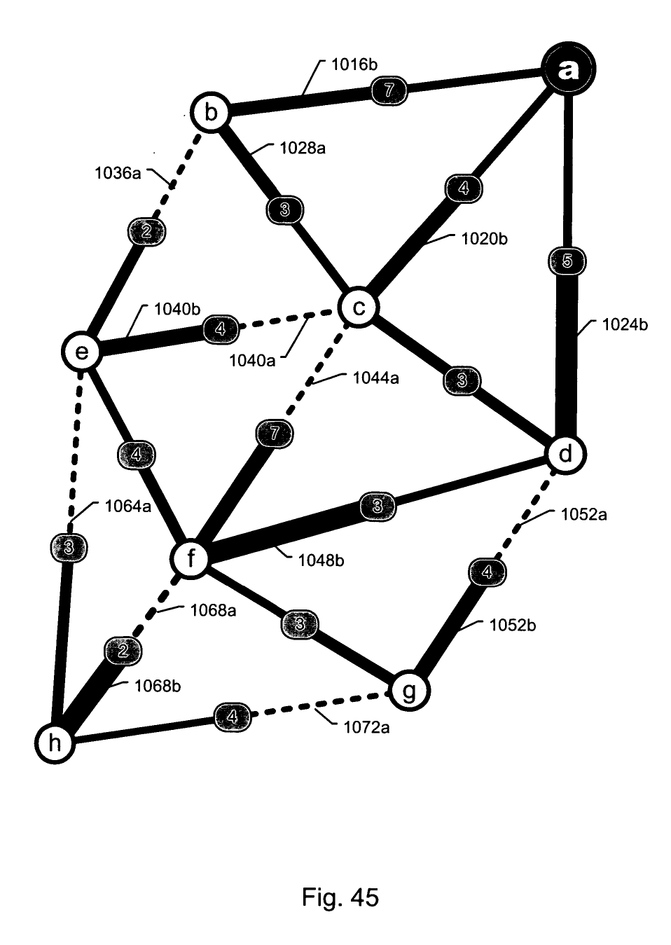

FIG. 46 illustrates the final state of the router forwarding probabilities with inactive link probabilities converging to zero with regular exploratory ants;

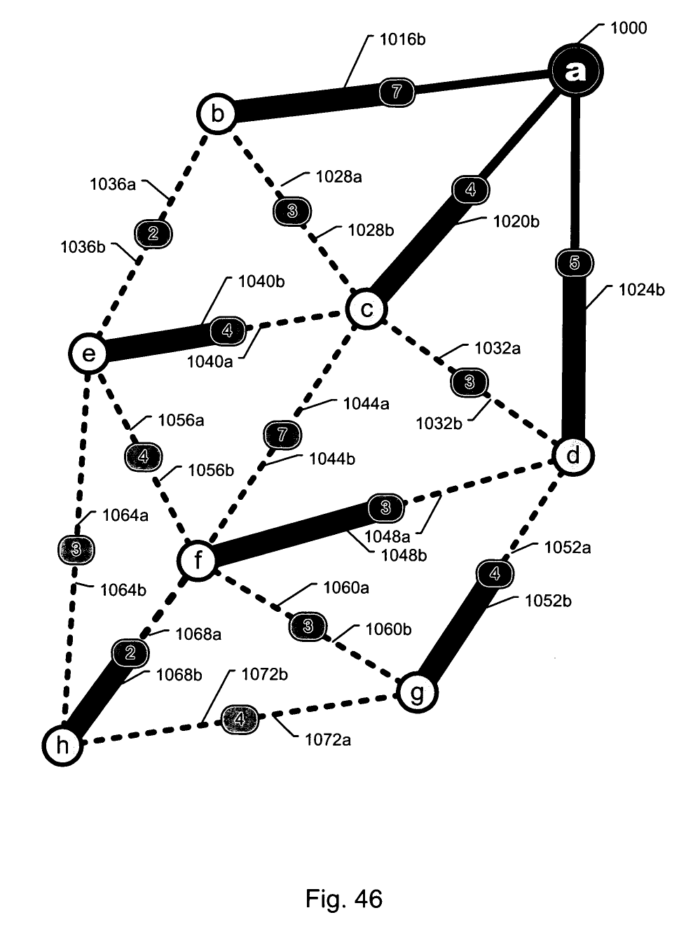

FIG. 47 illustrates the initial deployment of uniform exploratory ants in a simple network topology;

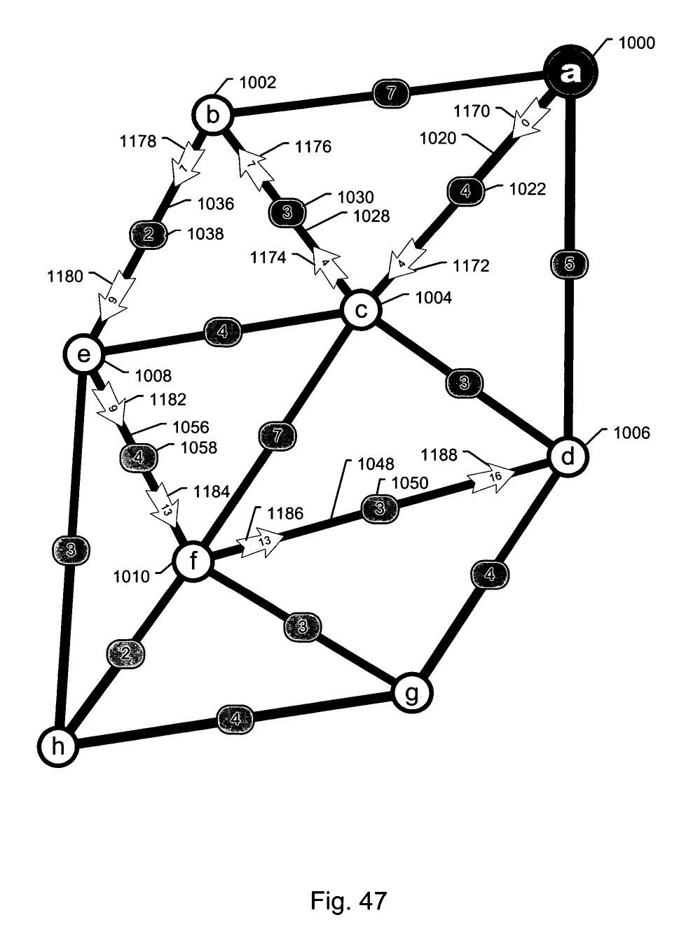

FIG. 48 illustrates the impact of uniform ants on the router forwarding probabilities;

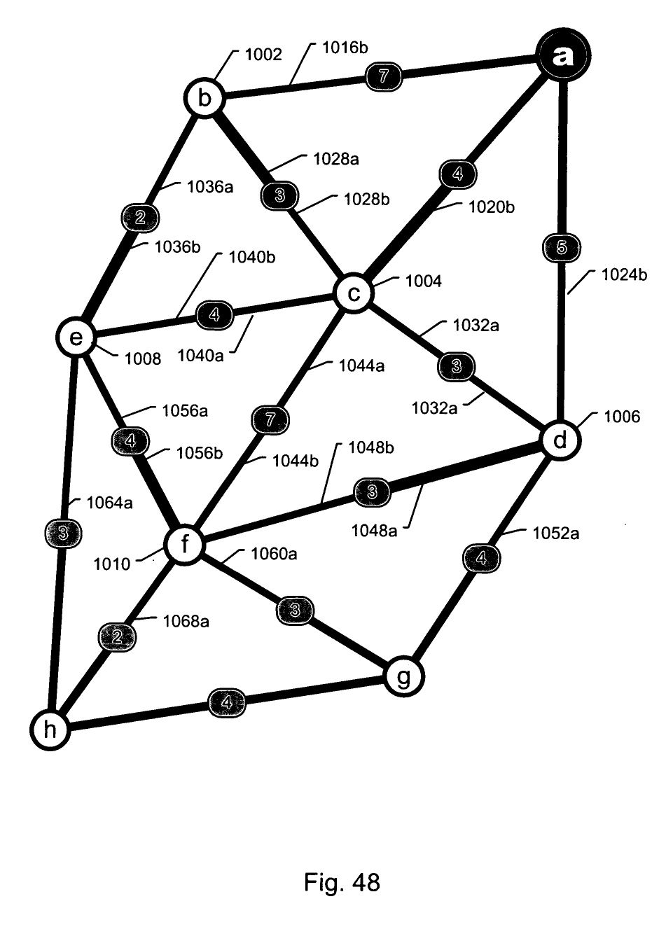

FIG. 49 illustrates an intermediate deployment of uniform exploratory ants in a simple network topology;

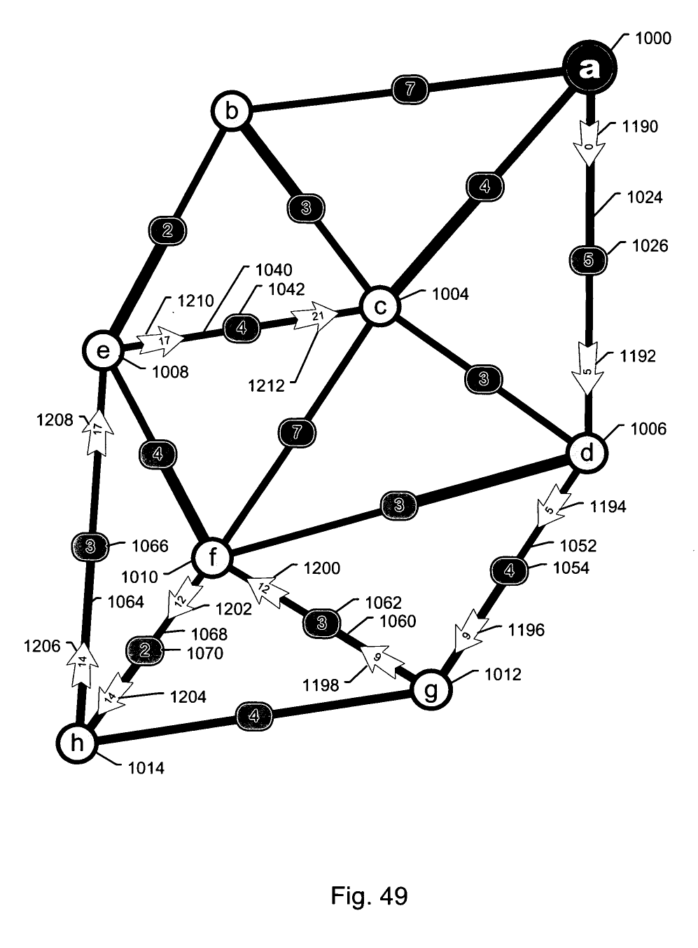

FIG. 50 illustrates an intermediate state of the router forwarding probabilities with uniform exploratory ants;

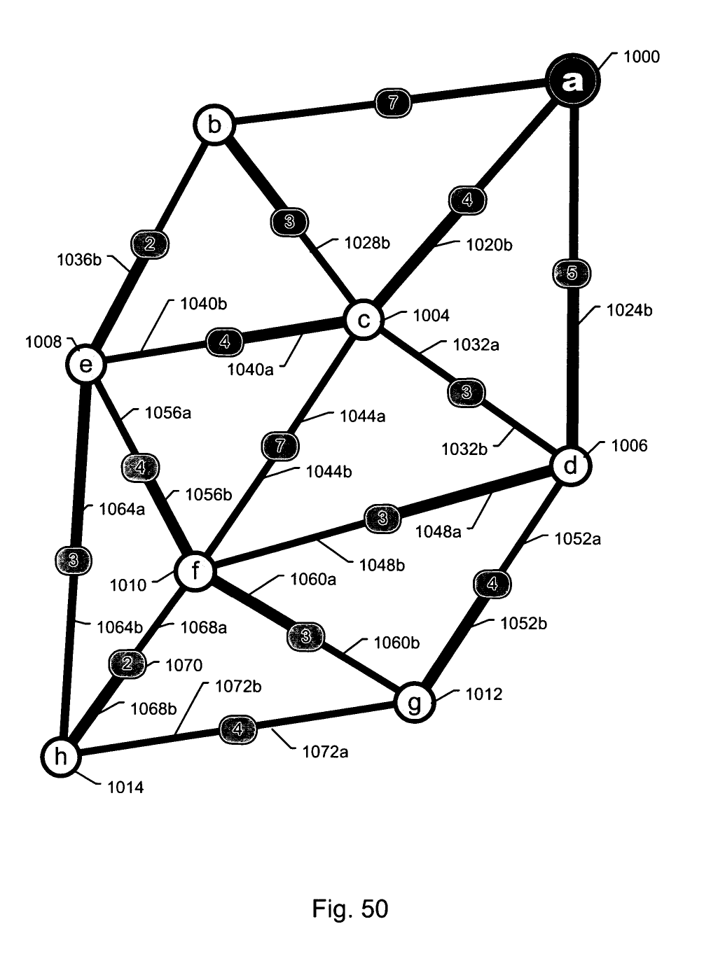

FIG. 51 illustrates the final state of the router forwarding probabilities with uniform exploratory ants;

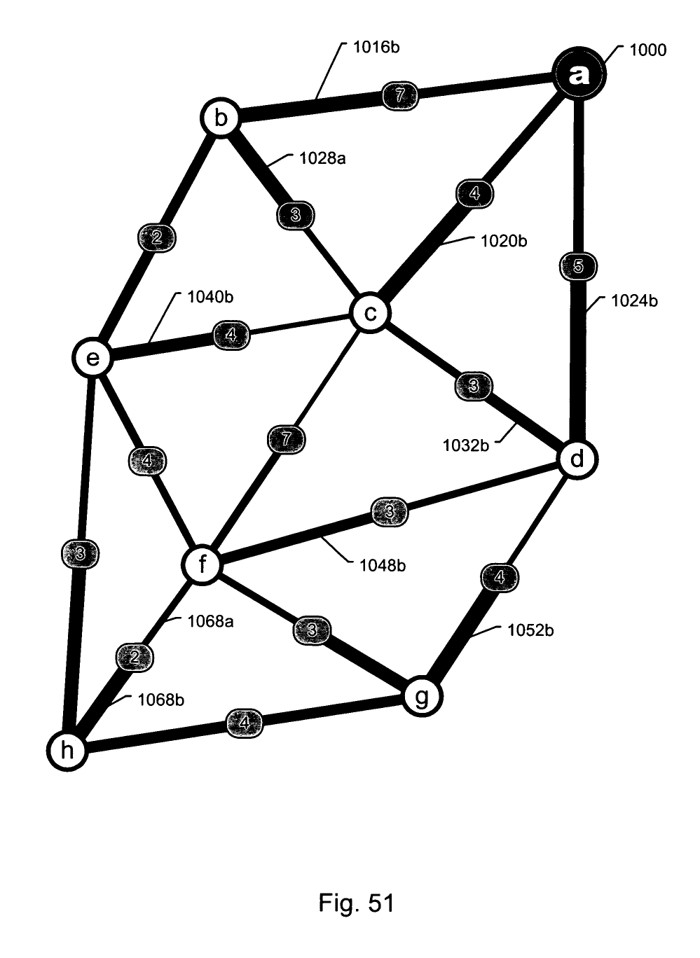

FIG. 52 illustrates the deployment of exploratory scouts in a simple network topology for the initial broadcast interval;

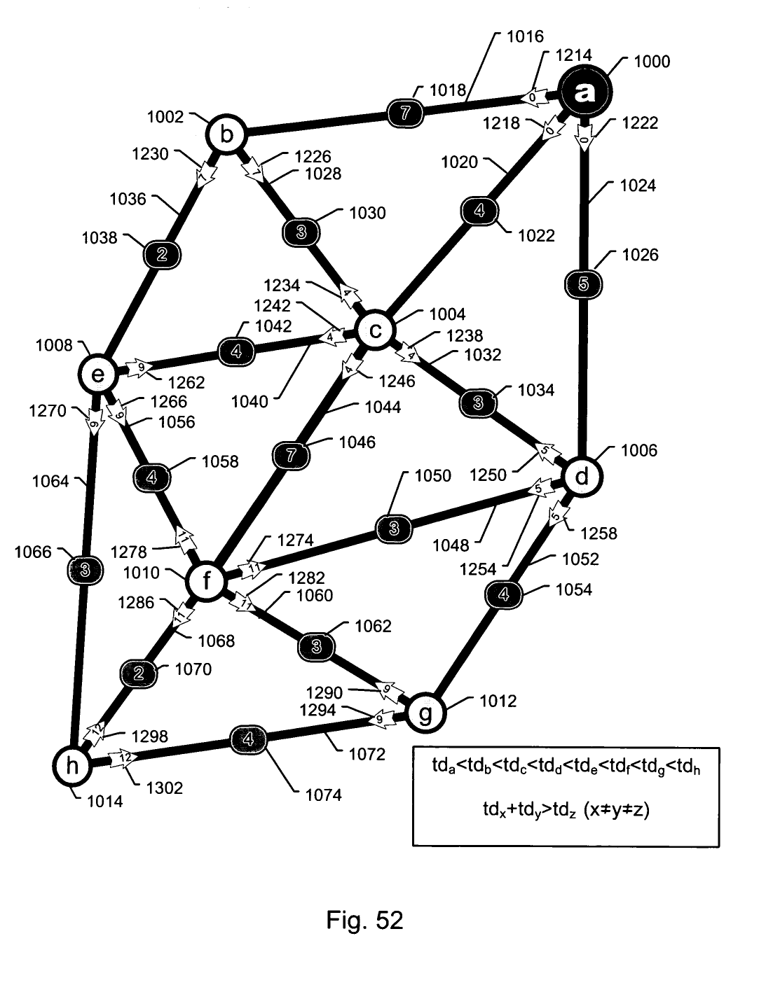

FIG. 53 illustrates the resulting designated neighbors after the initial broadcast interval of exploratory scouts;

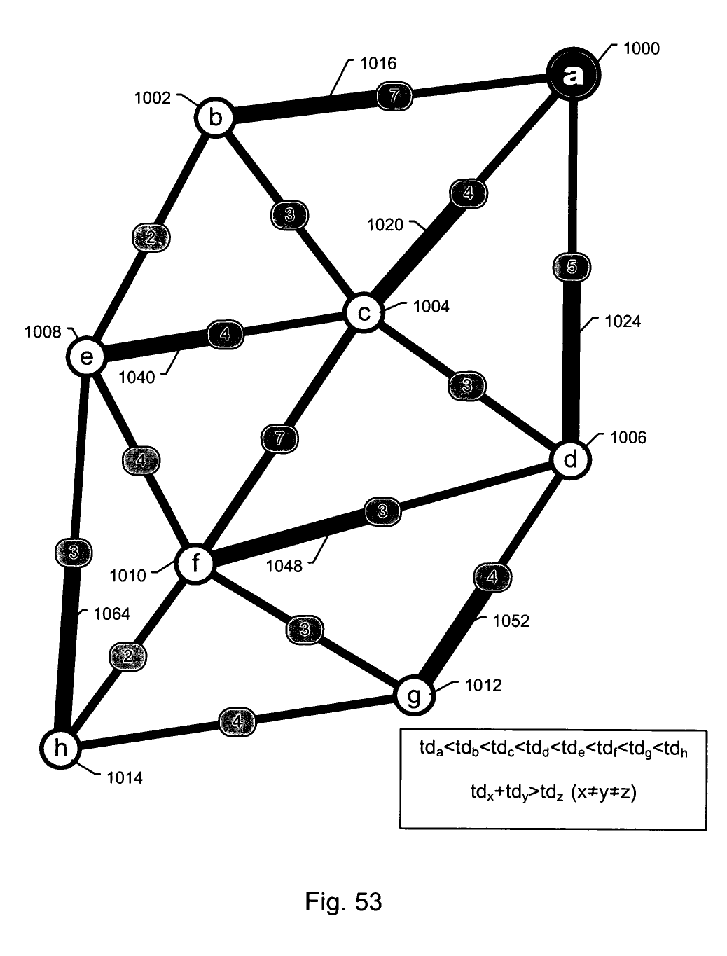

FIG. 54 illustrates the deployment of exploratory scouts in a simple network topology for the second broadcast interval;

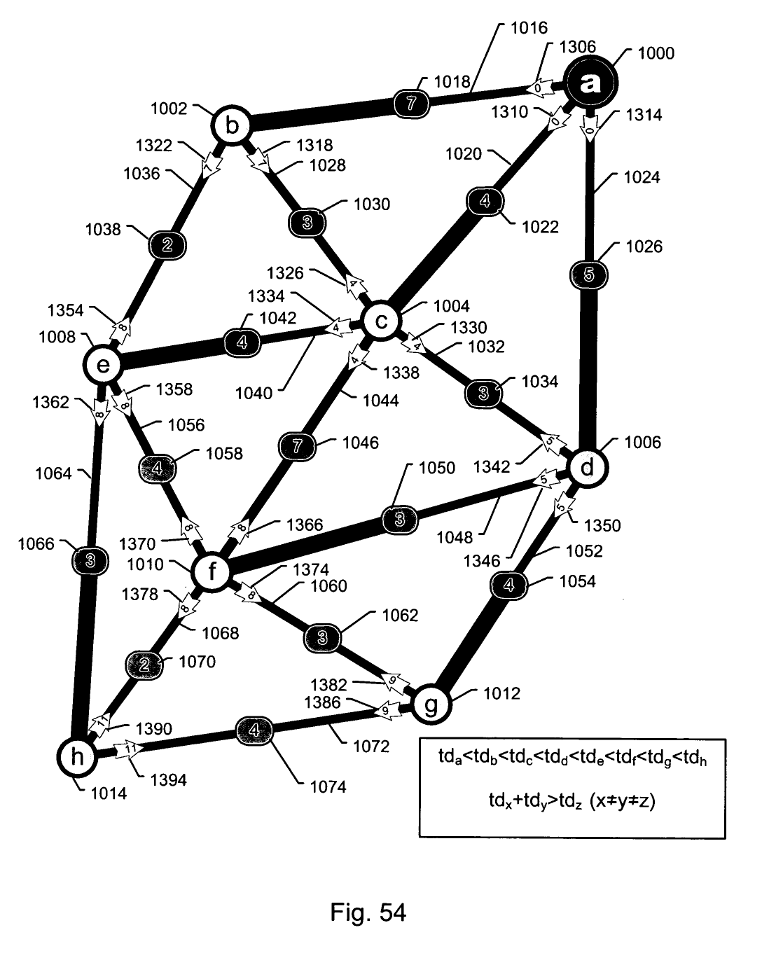

FIG. 55 illustrates the designated neighbors after convergence with exploratory scouts;

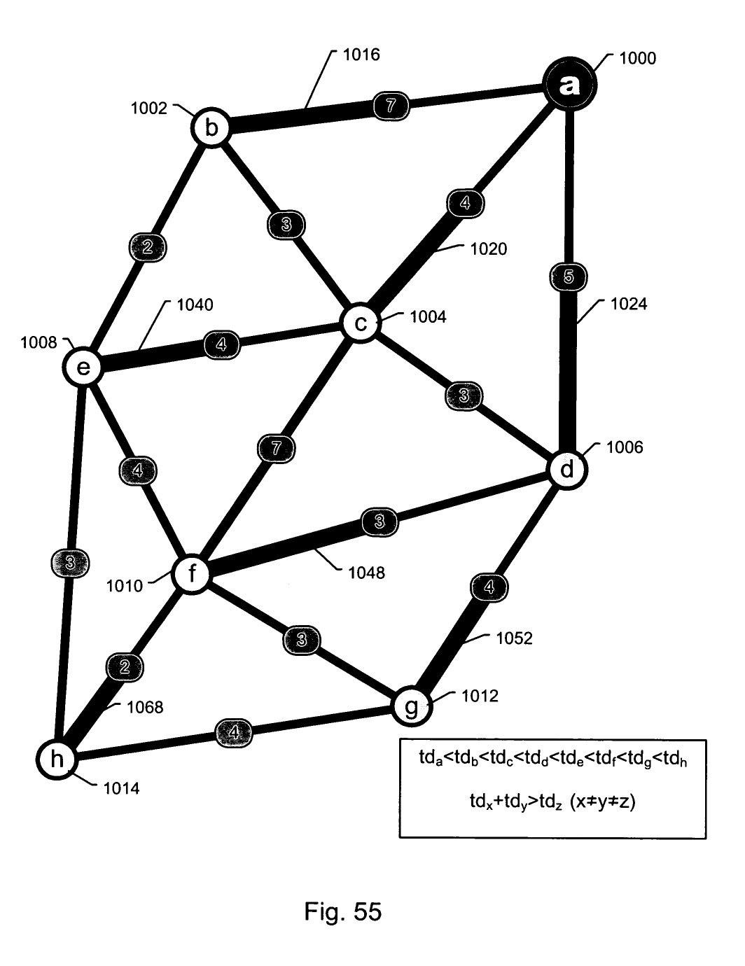

FIG. 56 illustrates a SWI network fragment with the introduction of a new node in a Stigmergic Capable Network;

FIG. 57 illustrates a SWI network fragment showing the initial generation of Quantum Virtual Ants;

FIG. 58 illustrates a SWI network fragment showing the initial first hop LSP's;

FIG. 59 illustrates a SWI network fragment showing the first hop generation of Quantum Virtual Ants;

FIG. 60 illustrates a SWI network fragment showing the second hop LSP's;

FIG. 61 illustrates a SWI network fragment showing the second hop generation of Quantum Virtual Ants;

FIG. 62 illustrates a SWI network fragment showing the third hop LSP's for the exploratory region;

FIG. 63 illustrates a SWI network fragment showing the initial contact domain;

FIG. 64 illustrates a SWI network fragment and participation in a rendezvous based communication;

FIG. 65 illustrates a SWI network fragment illustrating dynamic failures;

FIG. 66 illustrates a SWI network fragment resulting from dynamic failures;

FIG. 67 illustrates a SWI network fragment showing several Uniform Virtual Ants;

FIG. 68 illustrates a SWI network fragment showing several Uniform Virtual Ants;

FIG. 69 illustrates a SWI network fragment showing new LSP's discovered after dynamic failures;

FIG. 70 illustrates a SWI network with sender and receiver nodes;

FIG. 71 illustrates a SWI network with receiver node Virtual Domain;

FIG. 72 illustrates a SWI network with extended receiver Virtual Domain;

FIG. 73 illustrates a SWI network with extended receiver Virtual Domain;

FIG. 74 illustrates a SWI network with receiver H-LSP to rendezvous point;

FIG. 75 illustrates a SWI network with sender node Virtual Domain;

FIG. 76 illustrates a SWI network with extended sender Virtual Domain;

FIG. 77 illustrates a SWI network with sender H-LSP to rendezvous point;

FIG. 78 illustrates a SWI network with alternate H-LSP from sender to receiver;

FIG. 79 illustrates a SWI network with a mobile node;

FIG. 80 illustrates a SWI network with a mobile node and initial Virtual Domain;

FIG. 81 illustrates a SWI network with a relocated mobile node;

FIG. 82 illustrates a SWI network with a relocated mobile node and initial Virtual Domain;

FIG. 83 illustrates a SWI network with a relocated mobile node;

FIG. 84 illustrates a SWI network with a mobile node and initial Virtual Domain;

### DETAILED DESCRIPTION OF THE INVENTION

A method to determine, establish and maintain a communication path between interconnected communication units (CU) utilizing Virtual Ants (VA) in a Small World Infrastructure (SWI) network is an aspect of this invention. Virtual Ants are used to initialize configuration, discover, maintain and optimize the Small World Infrastructure (SWI) network. A Stigmergic Capable Node (SCN) is a CU that is capable of generating and supporting Virtual Ants. A SCN can support several types of Virtual Ants, with each type providing specific services to the generating node. All Virtual Ants carry information related to the generating SCN, such as identification, sequence information, cost, etc. Not all information is carried by every type of ant. The cost related information can be calculated with a basis on several parameters such as delay, bandwidth, latency, hops or other network significant factors. Additionally, the total cost may be updated at the SCN based on several accumulation models. Two such models are a total accumulated costs based on path followed by the ant and an accumulation based on a best current cost update for the SCN at the time the ant exits the SCN.

The Virtual Ants interaction with the SCN is through alteration of the forwarding table entries associated with the destination which generated the Virtual Ant. Each entry will have a forwarding probability dependant on its Virtual Capacitance (VC) reflecting the memory properties of the entry. Each entry can be changed dependant on the parametric information carried by the Virtual Ant, by its Virtual Charging Factor (VCF) and Virtual Dissipation Factor (VDF). The VC will impose limitations on the upper and lower bounds of the entry. The VCF influences the rate at which the entry can be changed while the VDF influences the rate of decay or dissipation of the entry. The behavior properties of the VC, VCF and VDF can be influenced by the SCN directly or from external influences such as Virtual Ants. The net effect of VC results in a memory property to the forwarding table, where the VCF will control the net learning rate while the VDF will control the retention rate.

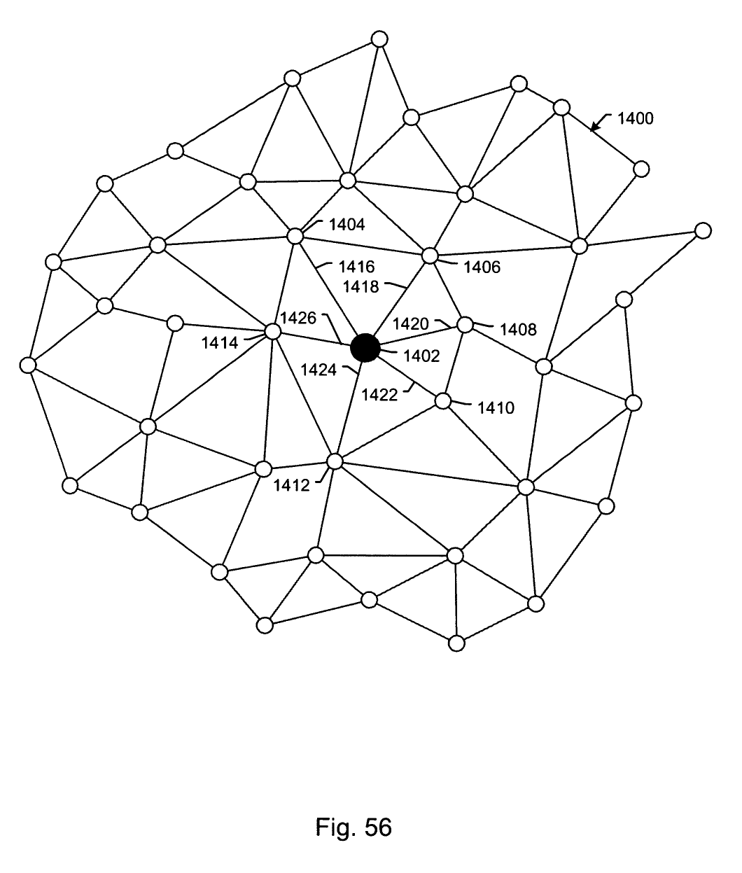

An illustrative portion of a SWI network is shown in FIG. 56. As defined for a SWI network it is MPLS capable. The SWI network 1400 consists of interconnected Stigmergic Capable Nodes (SCN). A SCN capable node 1402 is introduced into the stable SWI network with no pre-configuration information. The node 1402 will have links 1416, 1418, 1420, 1422, 1424 and 1426 connected to nodes 1404, 1406, 1408, 1410, 1412 and 1414, respectively. At this point, node 1402 is not aware of the neighboring nodes, but only aware of its physical interfaces to links 1416, 1418, 1420, 1422, 1424 and 1426. The node would need to seed itself within the network in order to provide or utilize any services. A Quantum Virtual Ant (QVA) is used to initialize its presence in the region very rapidly. The QVA is similar to exploratory scouts being a flooding algorithm. The QVA will have a finite range based on limiting some cost factor such as hops, delay or other link or node costs associated with the path transversal process.

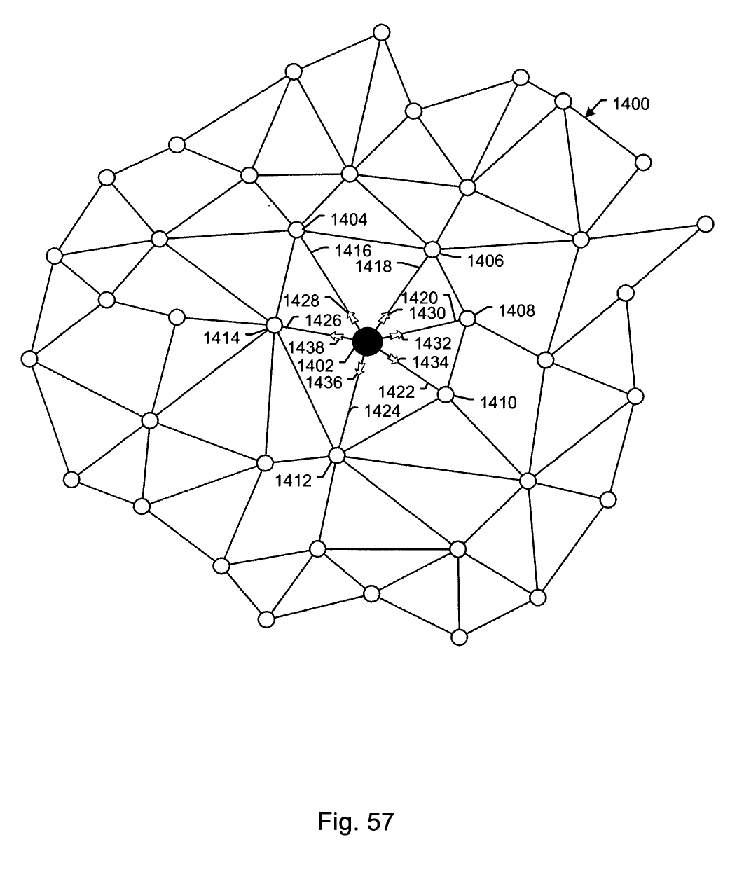

For the example SWI network 1400 of interconnected Stigmergic Capable Nodes (SCN), the first step is shown in FIG. 57. Node 1402 would generate QVA's for each known interface. For simplicity and clarity in the example it is assumed that all link costs are equal and the node costs are zero. It will also be assumed that the QVA's arrive at each node in the order of increasing node number for each broadcast interval. Node 1402 would generate QVA's on each of its known interfaces containing information for destination node 1402, the accumulated cost, sequence information for the current broadcast interval and other optional payload information. QVA 1428 would be sent on link 1416 to node 1404, where the QVA information would be processed. The forwarding table would be updated to reflect the cost to node 1402 as well as the creation of a bi-directional LSP from node 1402 to node 1404 comprised of link 1416. The status of the QVA 1428 would be updated and terminated if cost factor has reached its limit. QVA 1430 would be sent on link 1418 to node 1406, where the QVA information would be processed. The forwarding table would be updated to reflect the cost to node 1402 as well as the creation of a bidirectional LSP from node 1402 to node 1406 comprised of link 1418. The status of the QVA 1430 would be updated and terminated if cost factor has reached its limit. QVA 1432 would be sent on link 1420 to node 1408, where the QVA information would be processed. The forwarding table would be updated to reflect the cost to node 1402 as well as the creation of a bidirectional LSP from node 1402 to node 1408 comprised of link 1420. The status of the QVA 1432 would be updated and terminated if cost factor has reached its limit. QVA 1434 would be sent on link 1422 to node 1410, where the QVA information would be processed. The forwarding table would be updated to reflect the cost to node 1402 as well as the creation of a bidirectional LSP from node 1402 to node 1410 comprised of link 1422. The status of the QVA 1434 would be updated and terminated if cost factor has reached its limit. QVA 1436 would be sent on link 1424 to node 1412, where the QVA information would be processed. The forwarding table would be updated to reflect the cost to node 1402 as well as the creation of a bidirectional LSP from node 1402 to node 1412 comprised of link 1424. The status of the QVA 1436 would be updated and terminated if cost factor has reached its limit. QVA 1438 would be sent on link 1426 to node 1414, where the QVA information would be processed. The forwarding table would be updated to reflect the cost to node 1402 as well as the creation of a bidirectional LSP from node 1402 to node 1414 comprised of link 1426. The status of the QVA 1438 would be updated and terminated if cost factor has reached its limit.

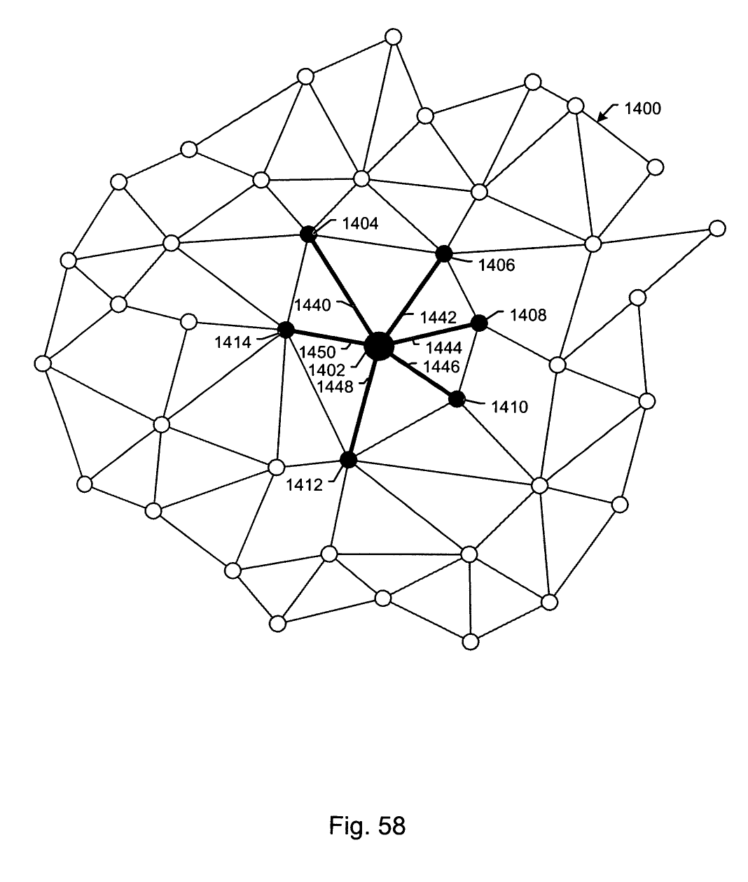

The resulting LSP's are shown in FIG. 58. LSP 1440 from node 1402 to node 1404, LSP 1442 from node 1402 to node 1406, LSP 1444 from node 1402 to node 1408, LSP 1446 from node 1402 to node 1410, LSP 1448 from node 1402 to node 1412 to node LSP 1450 from node 1402 to node 1414.

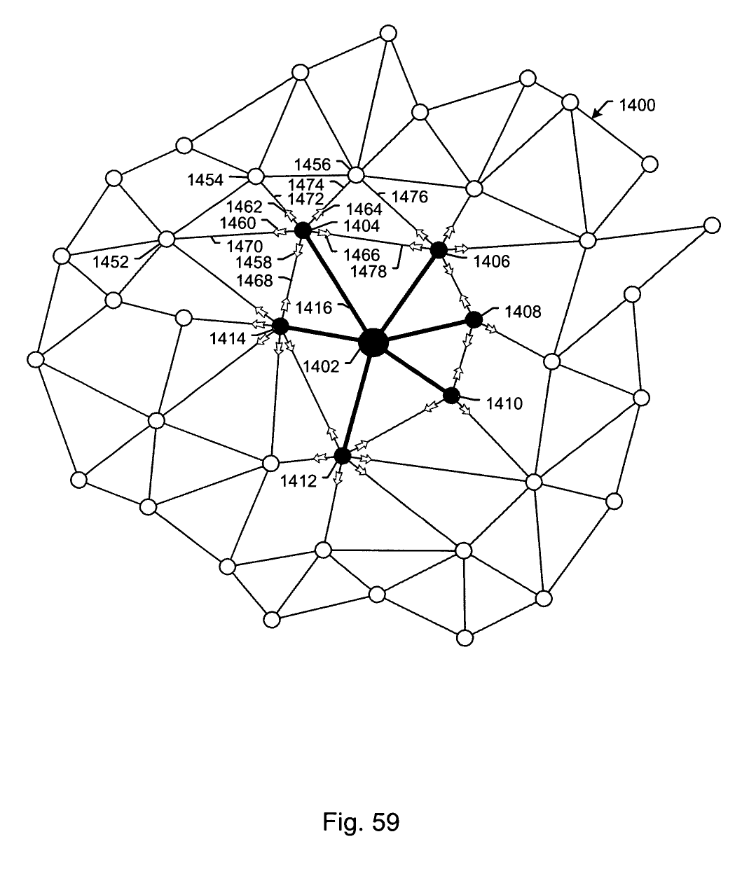

The first hop nodes receiving the QVA's would each forward the QVA on each of its known active interfaces. This is shown in FIG. 59 for node 1404. QVA 1458 would be sent on link 1468 to node 1414, where the QVA information would be processed. The forwarding table would not be updated to and no LSP is created since it is not the least cost path. The status of the QVA 1468 would be updated and terminated if cost factor has reached its limit. QVA 1460 would be sent on link 1470 to node 1452, where the QVA information would be processed. The forwarding table would be updated to reflect the cost to node 1402 as well as the creation of a bi-directional LSP from node 1402 to node 1452 comprised of links 1440 and 1470. The status of the QVA 1460 would be updated and terminated if cost factor has reached its limit. QVA 1462 would be sent on link 1472 to node 1454, where the QVA information would be processed. The forwarding table would be updated to reflect the cost to node 1402 as well as the creation of a bidirectional LSP from node 1402 to node 1454 comprised of links 1440 and 1472. The status of the QVA 1462 would be updated and terminated if cost factor has reached its limit. QVA 1464 would be sent on link 1474 to node 1456, where the QVA information would be processed. The forwarding table would be updated to reflect the cost to node 1402 as well as the creation of a bidirectional LSP from node 1402 to node 1456 comprised of links 1440 and 1474. The status of the QVA 1464 would be updated and terminated if cost factor has reached its limit. QVA 1466 would be sent on link 1478 to node 1406, where the QVA information would be processed. The forwarding table would not be updated to and no LSP is created since it is not the least cost path. The status of the QVA 1466 would be updated and terminated if cost factor has reached its limit. A similar process would occur on nodes 1406, 1408, 1410, 1412 and 1414, where QVA's would be forwarded on all known active interfaces.

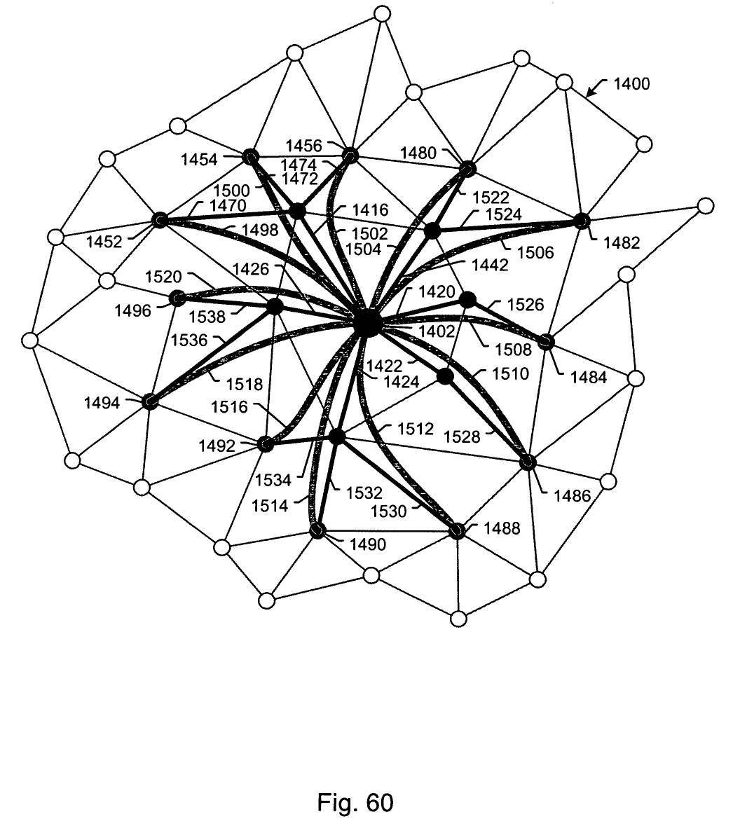

The resulting LSP's to this next set of nodes are shown in FIG. 60. LSP 1498 from node 1402 to node 1452 comprised of links 1440 and 1470. LSP 1500 from node 1402 to node 1454 comprised of links 1440 and 1472. LSP 1502 from node 1402 to node 1456 comprised of links 1440 and 1474. LSP 1504 from node 1402 to node 1480 comprised of links 1442 and 1522. LSP 1506 from node 1402 to node 1482 comprised of links 1442 and 1524. LSP 1508 from node 1402 to node 1484 comprised of links 1444 and 1522. LSP 1510 from node 1402 to node 1486 comprised of links 1446 and 1528. LSP 1512 from node 1402 to node 1488 comprised of links 1448 and 1532. LSP 1514 from node 1402 to node 1490 comprised of links 1448 and 1532. LSP 1516 from node 1402 to node 1492 comprised of links 1448 and 1534. LSP 1518 from node 1402 to node 1494 comprised of links 1450 and 1536. LSP 1520 from node 1402 to node 1496 comprised of links 1450 and 1538.

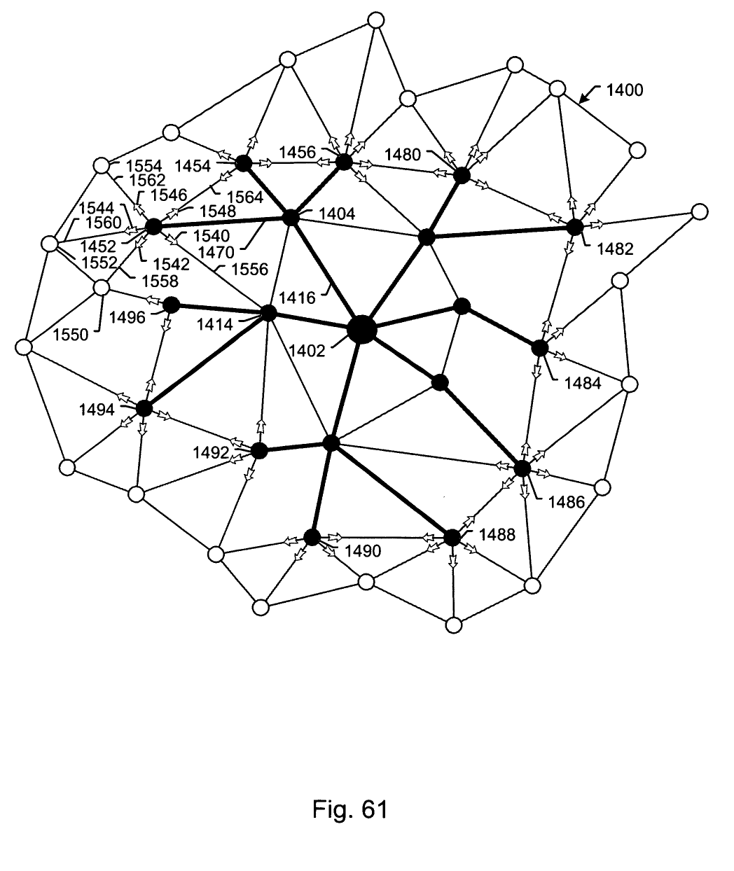

The second hop nodes receiving the QVA's would each forward the QVA on each of its known active interfaces. This is shown in FIG. 61 for node 1452. QVA 1540 would be sent on link 1556 to node 1414, where the QVA information would be processed. The forwarding table would not be updated to and no LSP is created since it is not the least cost path. The status of the QVA 1540 would be updated and terminated if cost factor has reached its limit. QVA 1542 would be sent on link 1558 to node 1550, where the QVA information would be processed. The forwarding table would be updated to reflect the cost to node 1402 as well as the creation of a bidirectional LSP from node 1402 to node 1550 comprised of links 1440, 1470 and 1558. The status of the QVA 1542 would be updated and terminated if cost factor has reached its limit. QVA 1544 would be sent on link 1560 to node 1552, where the QVA information would be processed. The forwarding table would be updated to reflect the cost to node 1402 as well as the creation of a bidirectional LSP from node 1402 to node 1552 comprised of links 1440, 1470 and 1560. The status of the QVA 1544 would be updated and terminated if cost factor has reached its limit. QVA 1546 would be sent on link 1562 to node 1554, where the QVA information would be processed. The forwarding table would be updated to reflect the cost to node 1402 as well as the creation of a bidirectional LSP from node 1402 to node 1554 comprised of links 1440, 1470 and 1562. The status of the QVA 1546 would be updated and terminated if cost factor has reached its limit. QVA 1548 would be sent on link 1564 to node 1454, where the QVA information would be processed. The forwarding table would not be updated to and no LSP is created since it is not the least cost path. The status of the QVA 1548 would be updated and terminated if cost factor has reached its limit. We will assume all the QVA's have reached their cost limits and would terminate at this point. A similar process would occur on nodes 1454, 1456, 1480, 1482, 1484, 1486, 1488, 1490, 1492, 1494 and 1496, where QVA's would be forwarded on all known active interfaces.

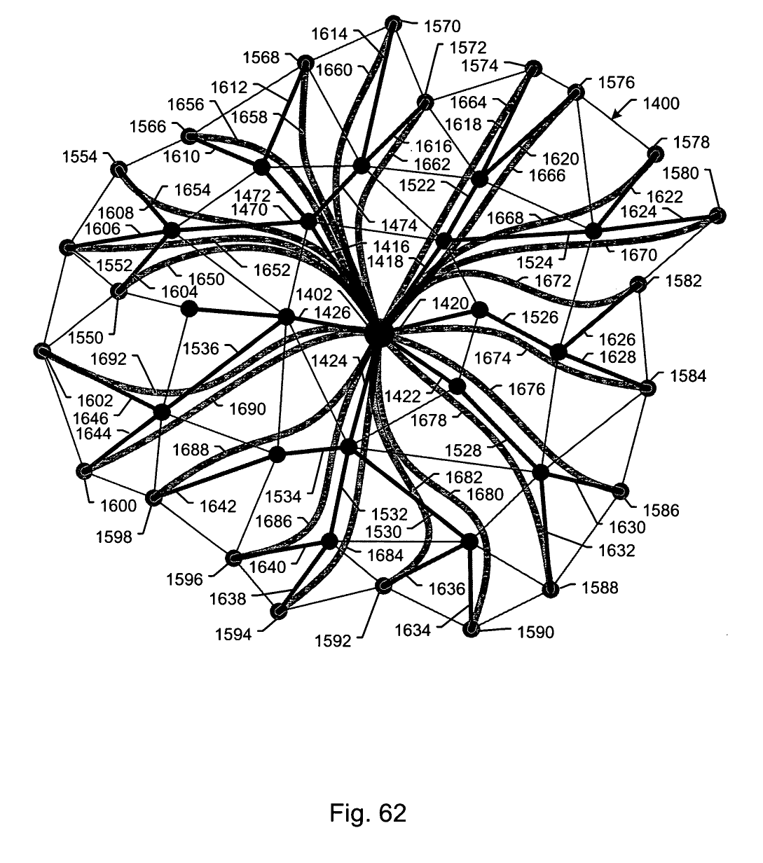

The resulting LSP's to this next set of nodes are shown in FIG. 62. LSP 1650 from node 1402 to node 1550 comprised of links 1440, 1470 and 1604. LSP 1652 from node 1402 to node 1552 comprised of links 1440, 1470 and 1606. LSP 1654 from node 1402 to node 1554 comprised of links 1440, 1470 and 1608. LSP 1656 from node 1402 to node 1566 comprised of links 1440, 1472 and 1610. LSP 1658 from node 1402 to node 1568 comprised of links 1440, 1472 and 1612. LSP 1660 from node 1402 to node 1570 comprised of links 1440, 1474 and 1614. LSP 1662 from node 1402 to node 1572 comprised of links 1440, 1474 and 1616. LSP 1664 from node 1402 to node 1574 comprised of links 1442, 1522 and 1618. LSP 1666 from node 1402 to node 1576 comprised of links 1442, 1522 and 1620. LSP 1668 from node 1402 to node 1578 comprised of links 1442, 1524 and 1622. LSP 1670 from node 1402 to node 1580 comprised of links 1442, 1524 and 1624. LSP 1672 from node 1402 to node 1582 comprised of links 1444, 1526 and 1626. LSP 1674 from node 1402 to node 1584 comprised of links 1444, 1526 and 1628. LSP 1676 from node 1402 to node 1586 comprised of links 1446, 1528 and 1630. LSP 1678 from node 1402 to node 1588 comprised of links 1446, 1528 and 1632. LSP 1680 from node 1402 to node 1590 comprised of links 1448, 1530 and 1634. LSP 1682 from node 1402 to node 1592 comprised of links 1448, 1530 and 1636. LSP 1684 from node 1402 to node 1594 comprised of links 1448, 1532 and 1638. LSP 1686 from node 1402 to node 1596 comprised of links 1448, 1532 and 1640. LSP 1688 from node 1402 to node 1598 comprised of links 1448, 1534 and 1642. LSP 1690 from node 1402 to node 1600 comprised of links 1450, 1536 and 1644. LSP 1692 from node 1402 to node 1602 comprised of links 1450, 1536 and 1646.

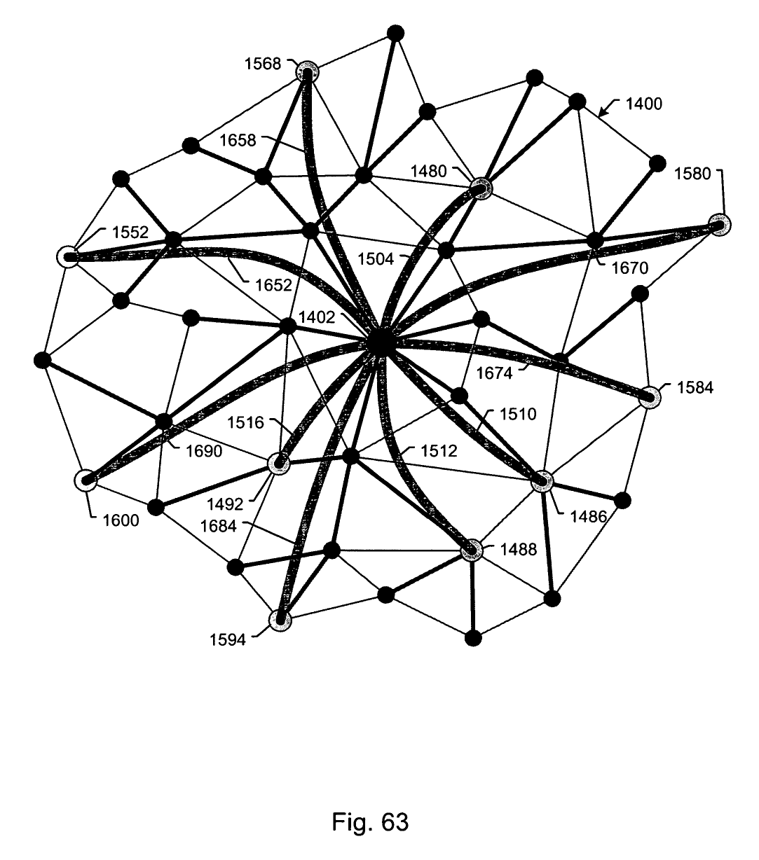

At this point LSP's have been created from the new node 1402 to all nodes within the exploratory region determined by the cost limits set for the QVA's. These LSP's are initially setup very quickly within a few Broadcast Intervals. With this initial set of LSP's, contacts within the region can make their presence known to the new node. This shown in FIG. 63 for the example SWI network 1400 of interconnected Stigmergic Capable Nodes (SCN). The initial exploratory region contained contacts 1480, 1486, 1488, 1492, 1552, 1568, 1580, 1584, 1594 and 1600 connected to node 1402 with LSP's 1504, 1510, 1512, 1516, 1652, 1658, 1670, 1674, 1684 and 1690, respectively. These initial set of contacts will makeup an initial contact domain for node 1402. The contacts will also be members of a SWI network with relationships to rendezvous points which may be in this contact domain, but it is not necessary for service provisioning. At this time node 1402 may place triggers at rendezvous points requesting any initialization services required. Once the node is initialized, it will become a member of the SWI network and contribute to the collective intelligence of the community. The initialization process is self organizing requiring no outside configuration. The node can offer services or just request services.

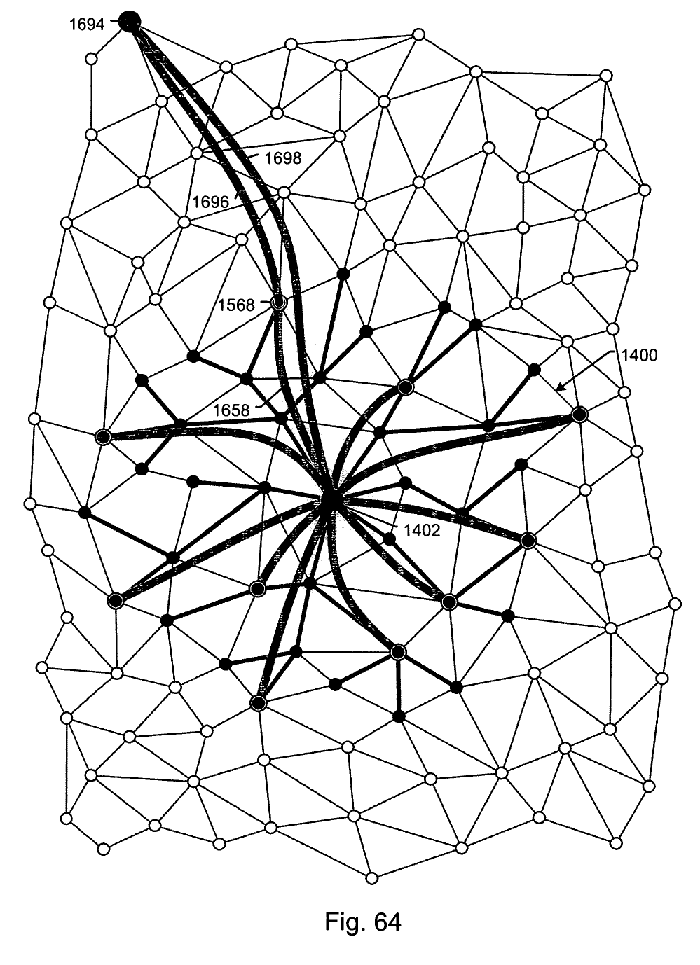

In FIG. 64 SWI network 1400 of interconnected Stigmergic Capable Nodes (SCN) is shown as part of a larger SWI network. If node 1402 is in need of a service, a trigger would be registered at rendezvous points. In the example an appropriate contact for a rendezvous point is found at node 1568. A sender providing the requested service is located at node 1694 and would locate the rendezvous point 1568 and service ID from node 1402. The LSP 1696 from the sender would be concatenated with the LSP 1658 from the receiver node 1402 to create the H-LSP 1698 between node 1402 and node 1694. The sender node 1694 would use this H-LSP 1698 to provide the service to 1402.

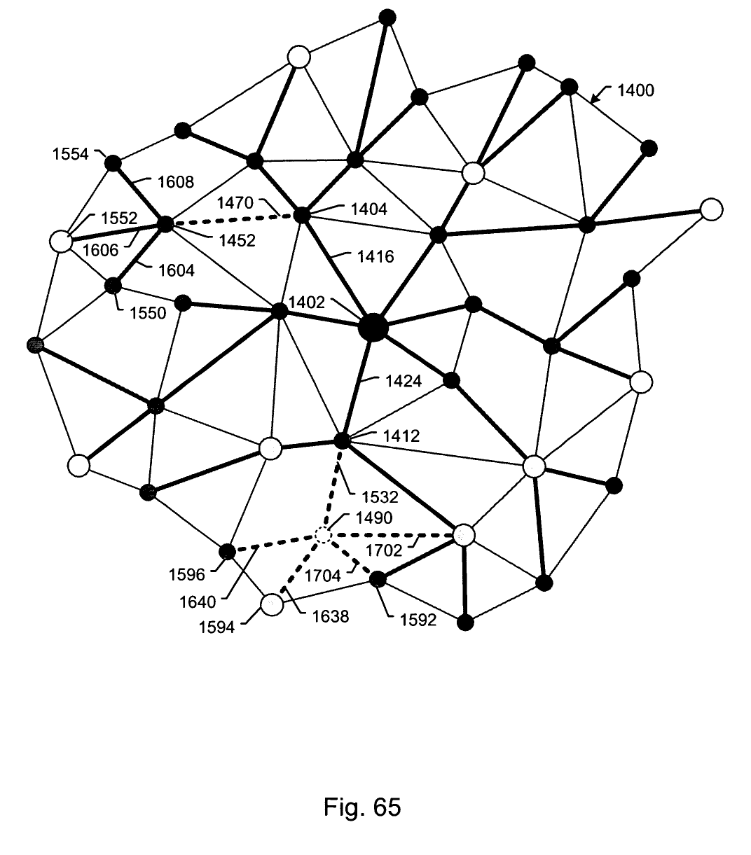

In order to maintain the forwarding tables within a Virtual Domain, a node will generate Uniform Virtual Ants (UVA) periodically. The generation rate of UVA's will be determined by the dynamic nature of the network topology. UVA's will follow the behavior of Uniform Ants in which all interfaces at a node are assumed to have equal probabilities. Changes may be a result of changing properties of the various components, such as costs, location, latency and service provisioning. Failures of the same components would also require adaptability of the network properties. In FIG. 65 an illustrative portion of a SWI network 1400 of interconnected Stigmergic Capable Nodes (SCN) is shown. We will assume that several dynamic changes in the network will occur requiring updating the network properties. A situation has occurred where a link 1470 has become inoperative. With the failure of link 1470, several LSP's will no longer be valid. LSP 1498 in FIG. 60 from node 1402 to node 1452, LSP 1650 in FIG. 62 from node 1402 to node 1450, LSP 1652 in FIG. 62 from node 1402 to node 1452 and LSP 1654 in FIG. 62 from node 1402 to node 1554 will become invalid. Another situation occurs where a node 1490 has become inoperative or out of service. This would result in links 1532, 1638, 1640, 1702 and 1704 becoming inoperable. These changes will result in several LSP's to be no longer valid. LSP 1514 in FIG. 60 from node 1402 to node 1490, LSP 1684 in FIG. 62 from node 1402 to node 1594 and LSP 1686 in FIG. 62 from node 1402 to node 1596 will become invalid. For simplicity, it is assumed that both failures have occurred about the same time and will be addressed together.

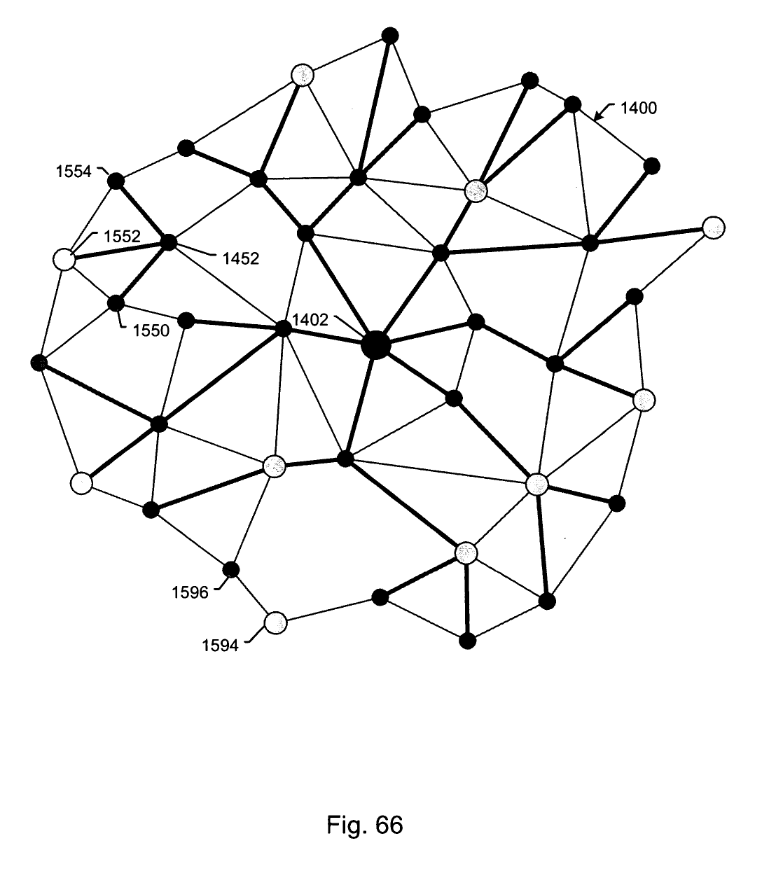

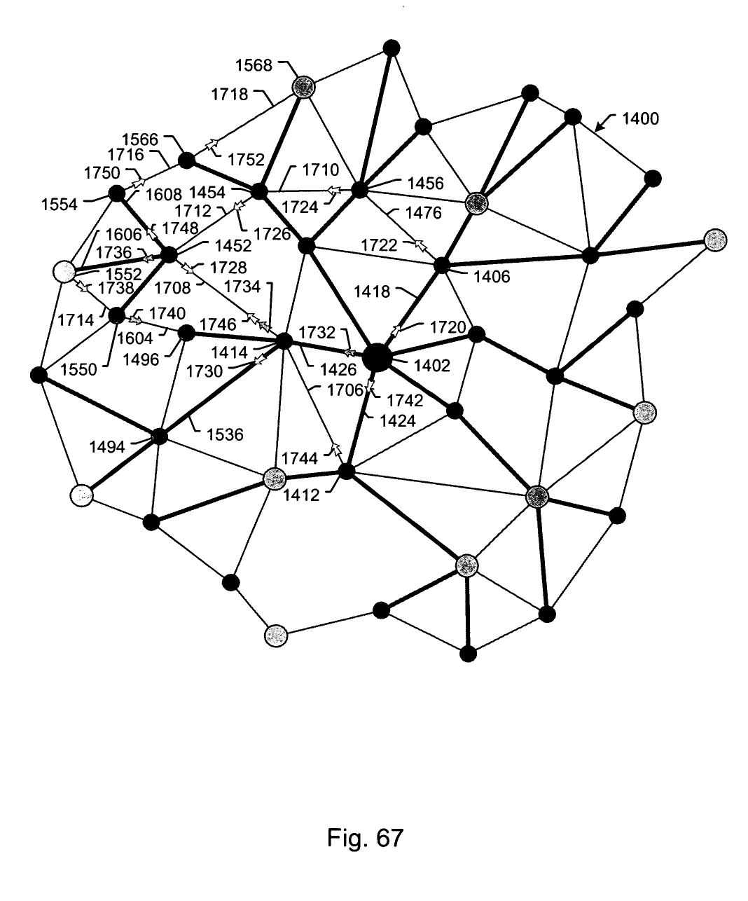

In FIG. 66 the resulting SWI network 1400 of interconnected Stigmergic Capable Nodes (SCN) after the failures is shown with the remaining valid LSP's removed for clarity. New paths from node 1402 to nodes 1452, 1550, 1552, 1554, 1594 and 1596 need to be found. After the failures have occurred, during a regular interval determined by node 1402 for maintenance of the Virtual Domain, UVA's would be generated and equally distributed through the network. Due to the equal probabilities that govern the behavior of the UVA's, every link would be traversed discovering the least cost path after network disruptions have occurred. As an illustration, in FIG. 67 for the resulting SWI network 66, several UVA's will be followed during their discovery or exploratory sequence for the failure of link 1470 in FIG. 65. Node 1402 generates UVA 1720 on link 1418 to node 1406. Node 1406 will forward the UVA 1722 on link 1426 to node 1456. Node 1456 will forward the UVA 1724 on link 1710 to node 1454. Node 1454 will forward the UVA 1726 on link 1712 to node 1452. Node 1452 will forward the UVA 1728 on link 1708 to node 1414. Node 1414 will forward the UVA 1730 on link 1536 to node 1494. The UVA would be terminated because of the cost limits imposed by node 1402. The nodes that received this UVA would use the cost information carried by the UVA to update the forwarding tables. Note that the UVA path is determined using equal probabilities at the interfaces for each node, thus traversing links that were determined to not have the least cost prior to the link failure such as links 1708 and 1712. Node 1402 generates another UVA 1732 on link 1426 to node 1414. Node 1414 will forward UVA 1734 on link 1708 to node 1452. Node 1452 will forward UVA 1736 on link 1606 to node 1552. Node will forward UVA 1738 on link 1714 to node 1550. Node 1550 will forward UVA 1740 on link 1604 to node 1496. The UVA would be terminated because of the cost limits imposed by node 1402. The UVA will also reinforce the path on link 1708. Node 1402 generates another UVA 1742 on link 1424 to node 1412. Node 1412 will forward the UVA 1744 on link 1706 to node 1414. Node 1414 will forward UVA 1746 on link 1708 to node 1452. Node 1452 will forward UVA 1748 on link 1608 to node 1554. Node 1554 will forward UVA 1750 on link 1716 to node 1566. Node 1566 will forward UVA 1752 on link 1718 to node 1568. The UVA would be terminated because of the cost limits imposed by node 1402. The UVA will also reinforce the path on link 1708.

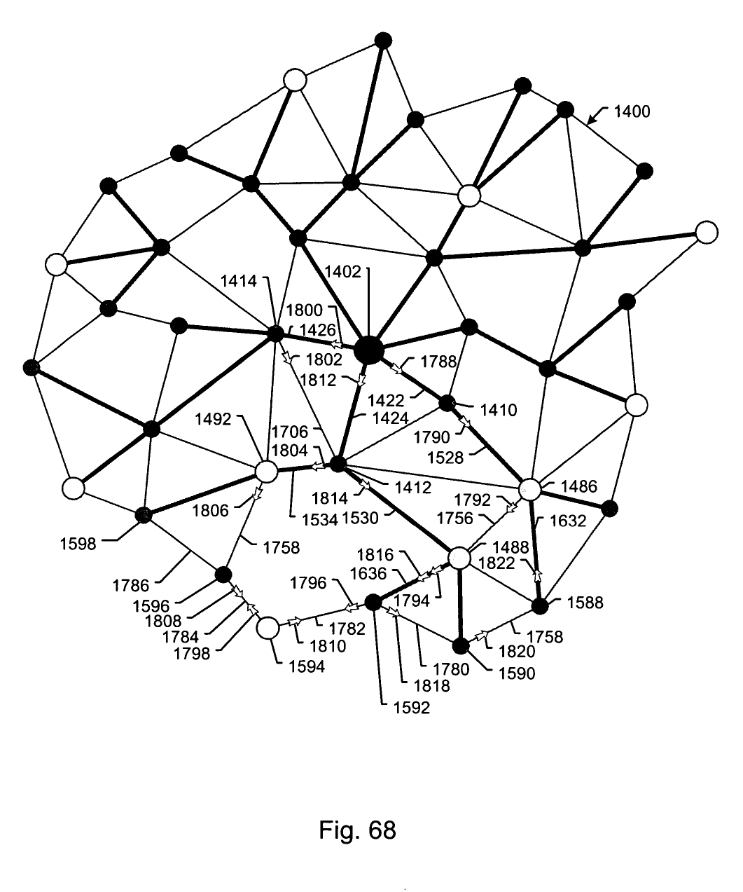

Continuation of the illustrative example, in FIG. 68 for the resulting SWI network 66, several UVA's will be followed during their discovery or exploratory sequence for the failure of node 1490 in FIG. 65. Node 1402 generates UVA 1788 on link 1422 to node 1790. Node 1790 forwards UVA 1790 on link 1528 to node 1486. Node 1486 forwards UVA 1792 on link 1756 to node 1488. Node 1488 forwards UVA 1794 on link 1636 to node 1592. Node 1592 forwards UVA on link 1780 to node 1590. Node 1590 forwards UVA 1820 on link 1758 to node 1588. Node 1588 forwards UVA 1822 on link 1632 to node 1486. The UVA would be terminated because of the cost limits imposed by node 1402. The nodes that received this UVA would use the cost information carried by the UVA to update the forwarding tables. Note that the UVA path is determined using equal probabilities at the interfaces for each node, thus traversing links that were determined to not have the least cost prior to the node failure such as links 1782 and 1784. Node 1402 generates UVA 1800 on link 1426 to node 1414. Node 1414 forwards UVA 1802 on link 1706 to node 1412. Node 1412 forwards UVA 1804 on link 1534 to node 1592. Node 1592 forwards UVA 1806 on link 1758 to node 1596. Node 1596 forwards UVA 1808 on link 1784 to node 1594. Node 1594 forwards UVA 1810 on link 1782 to node 1592. The UVA would be terminated because of the cost limits imposed by node 1402. The UVA will also reinforce the path on links 1706 and 1758. Node 1402 generates UVA 1812 on link 1424 to node 1412. Node 1412 forwards UVA 1814 on link 1530 to node 1488. Node 1488 forwards UVA 1816 on link 1636 to node 1592. Node 1592 forwards UVA 1818 on link 1780 to node 1590. Node 1590 forwards UVA 1820 on link 1758 to node 1588. Node 1588 forwards UVA 1822 on link 1632 to node 1486. The UVA would be terminated because of the cost limits imposed by node 1402.

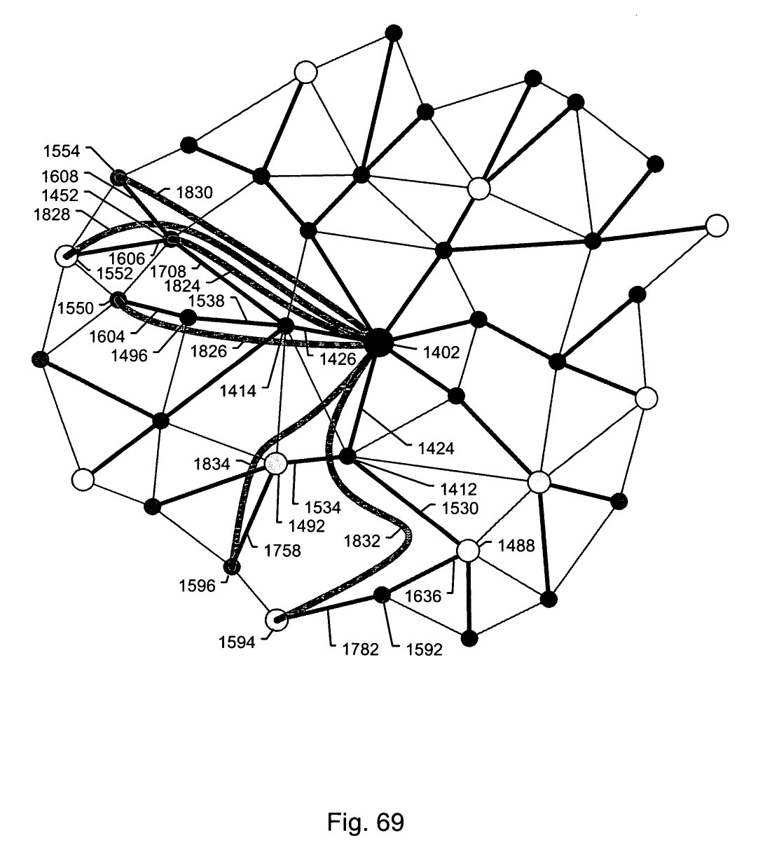

With generation of UVA's, the new LSP's for disruptive situations will be found. As shown in FIG. 69, new LSP's from node 1402 to nodes 1452, 1550, 1552, 1554, 1594 and 1596 will be discovered. LSP 1824 from node 1402 to node 1452 is comprised of links 1426 and 1708. LSP 1826 from node 1402 to node 1550 comprises links 1426, 1538 and 1604. LSP 1828 from node 1402 to node 1552 is comprised of links 1426, 1708 and 1606. LSP 1830 from node 1402 to node 1554 is comprised of links 1426, 1708 and 1608. UVA can effectively be used to maintain LSP's discovering alternate paths within the Virtual Domain.

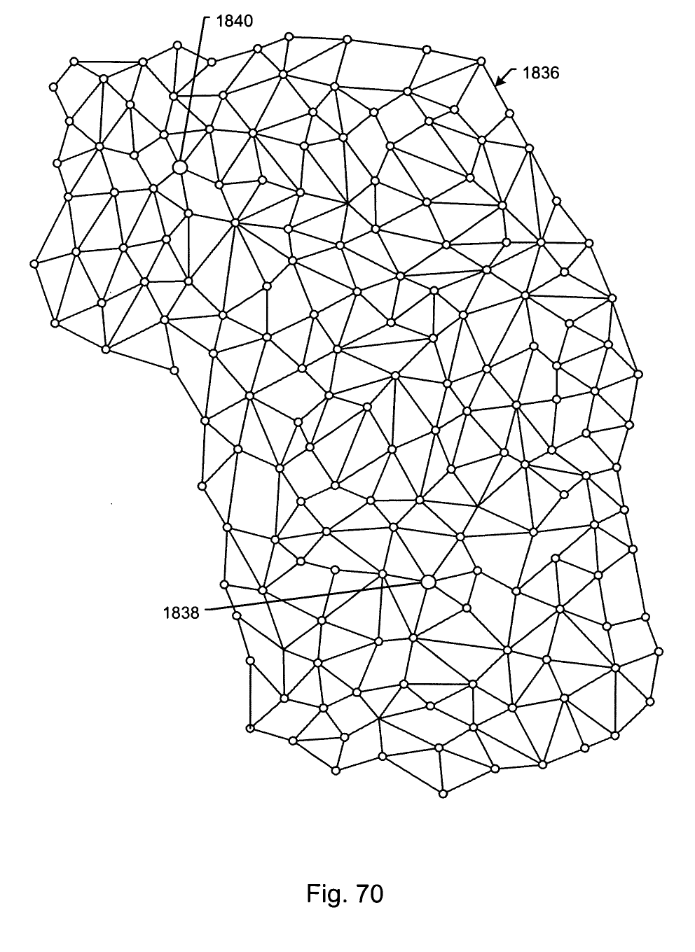

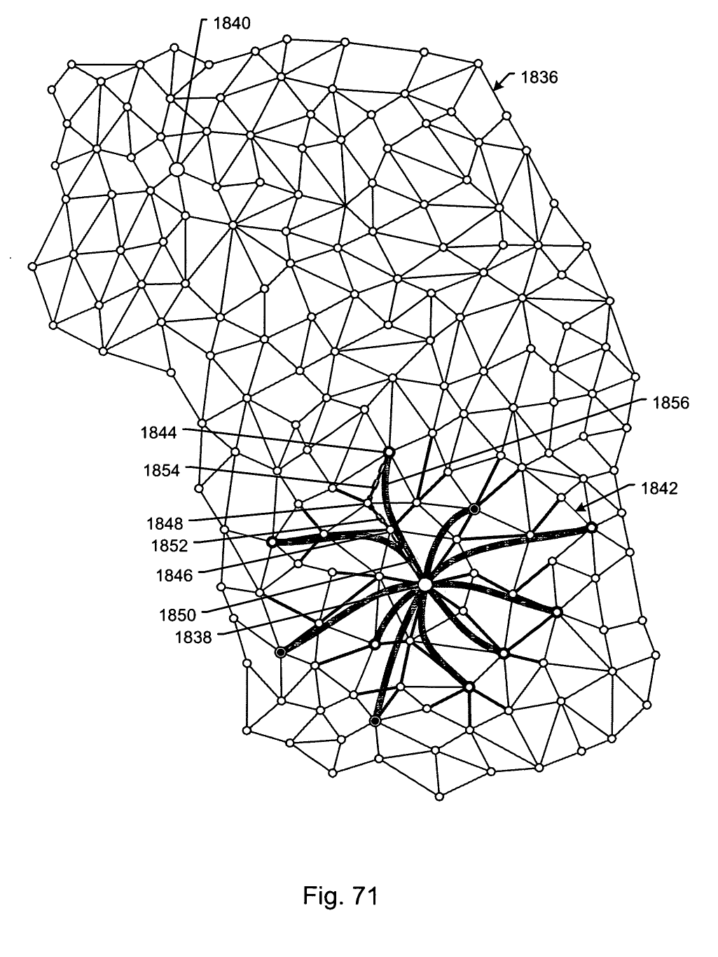

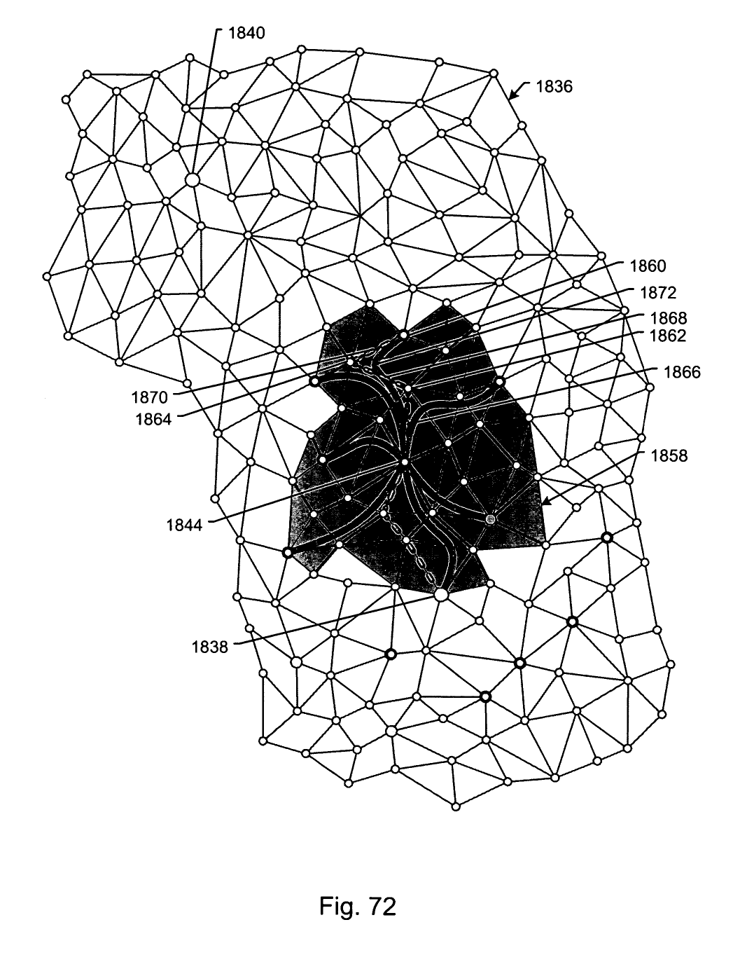

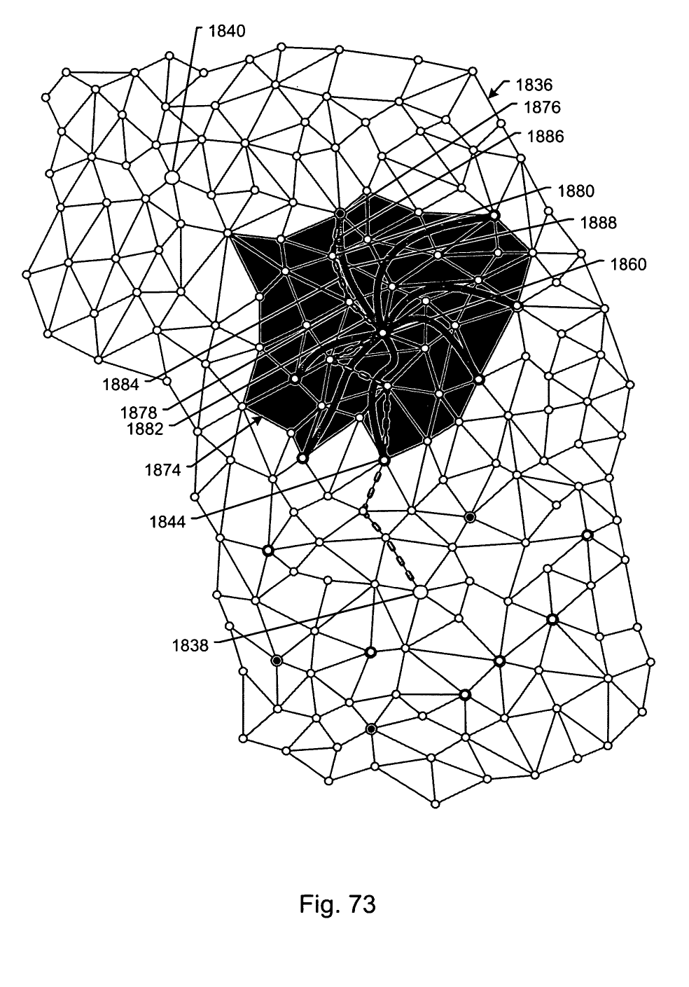

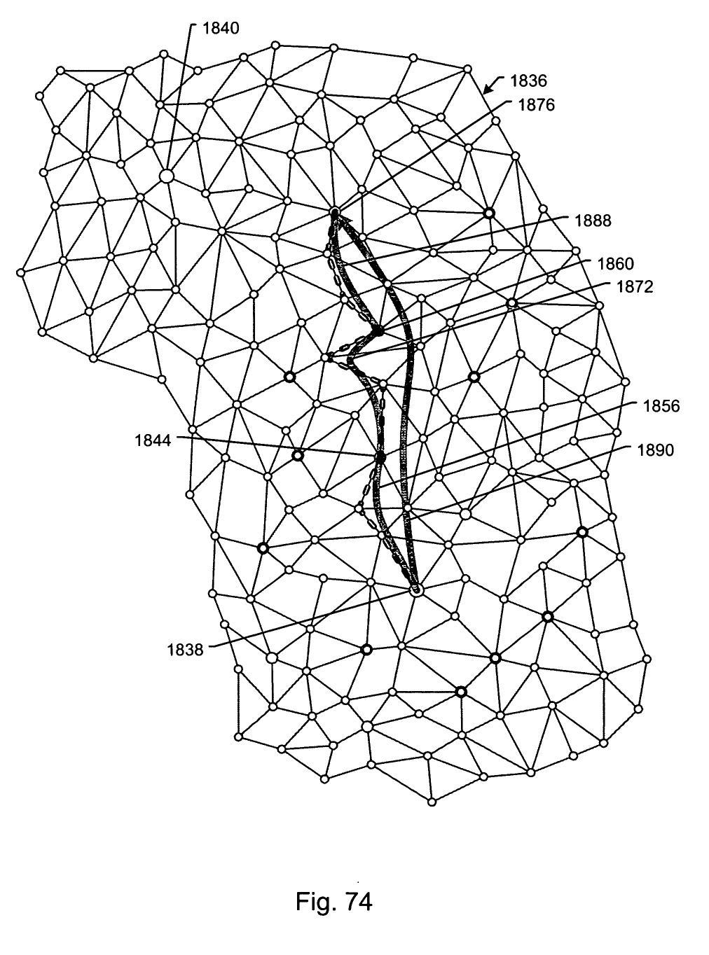

In FIG. 70 is illustrated a SWI network 1836 of interconnected Stigmergic Capable Nodes (SCN). Virtual Ants participate with the SWI network in a contributing role, enhancing the performance of the contact discovery process. The SWI network 1836 includes a typical receiver node 1838 and sender node 1840. Virtual Ants will define the Virtual Contact Domain for each node in the SWI network. In FIG. 71 node 1838 would discover its Virtual Domain 1842 using QVA's initially and UVA's periodically for maintenance. For the example, node 1838 would extend its contact domain 1842 utilizing known contacts such as node 1844. During the discovery process LSP 1856 from node 1838 to node 1844 via nodes 1846 and 1848 comprised of links 1850, 1852 and 1854 was defined as the least cost path within the Virtual Domain 1842. Illustrated in FIG. 72 contact node 1844 will have its own Virtual Domain 1858 discovered using the same process. Node 1844 would extend its contact domain 1858 utilizing known contacts such as node 1860. During the discovery process LSP 1872 from node 1844 to node 1860 via nodes 1862 and 1864 comprised of links 1866, 1868 and 1870 was defined as the least cost path within the Virtual Domain 1848. Illustrated in FIG. 73 contact node 1860 will have its own Virtual Domain 1874 discovered using the same process. Node 1860 would extend its contact domain 1874 utilizing known contacts such as node 1876. During the discovery process LSP 1888 from node 1860 to node 1876 via nodes 1878 and 1880 comprised of links 1882, 1884 and 1886 was defined as the least cost path within the Virtual Domain 1874. For the example node 1876 is a rendezvous point exhibiting the attributes for the service requested by the receiver node 1838. A trigger from receiver node 1838 containing an identifier ID and forwarding path from the rendezvous point 1876 and receiver node 1838 would be placed at the rendezvous point 1876. This is illustrated in FIG. 74 with LSP 1856 from node 1838 to node 1844, LSP 1872 from node 1844 to node 1860 and LSP 1888 from node 1860 to receiver node 1876. An H-LSP 1890 would be defined as the forwarding path from node 1876 to node 1838 comprised of links 1856, 1872 and 1888.

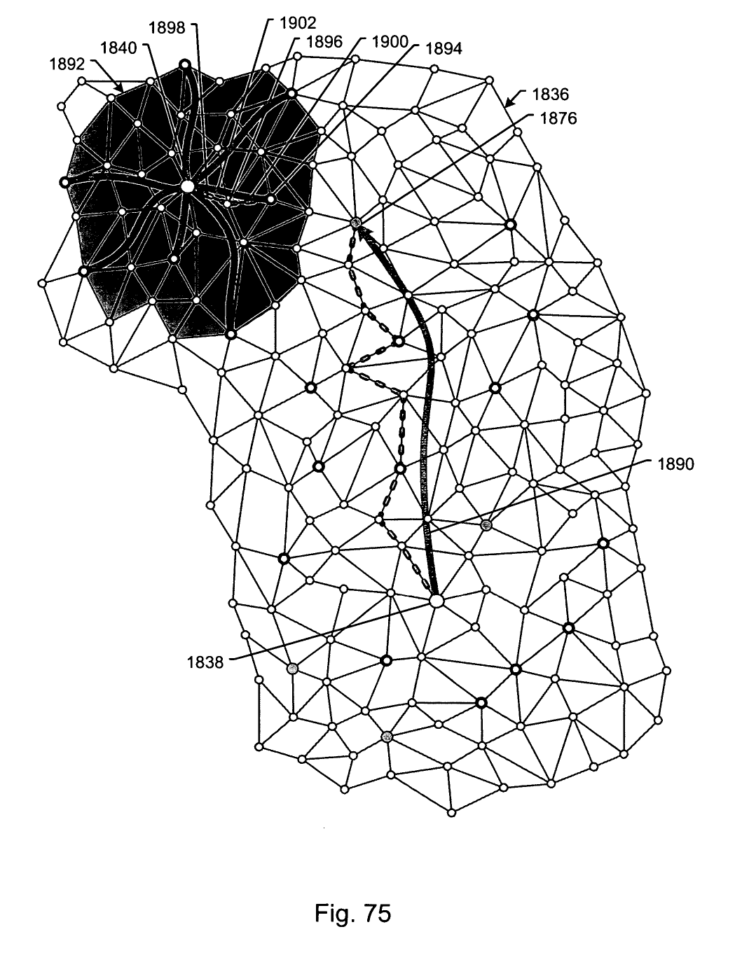

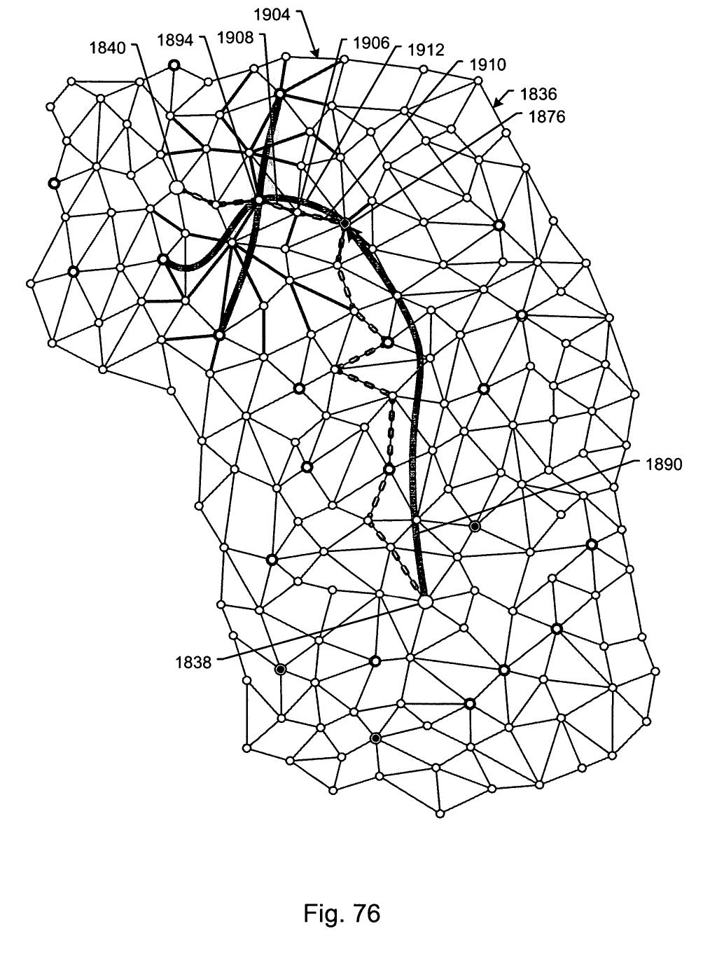

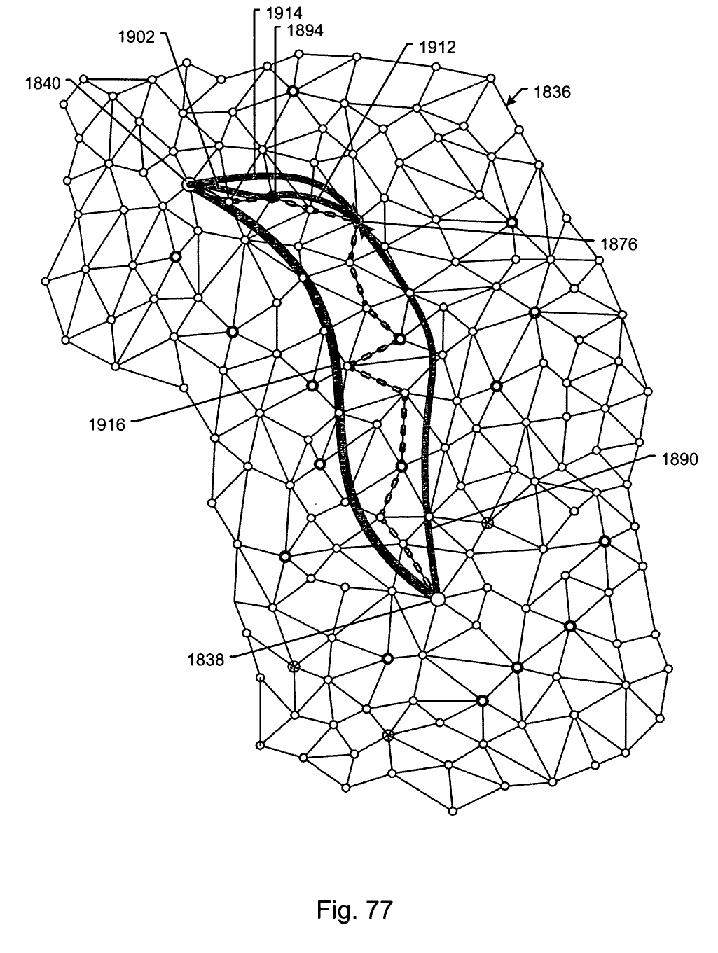

In FIG. 75 the sender node 1840 would discover its Virtual Domain 1892 using QVA's initially and UVA's periodically for maintenance as with the receiver nodes. For the example, node 1840 would extend its contact domain 1892 utilizing known contacts such as node 1894. During the discovery process LSP 1902 from node 1840 to node 1894 via node 1896 comprised of links 1898 and 1900 was defined as the least cost path within the Virtual Domain 1892. Illustrated in FIG. 76 contact node 1894 will have its own Virtual Domain 1904 discovered using the same process. Node 1894 would extend its contact domain 1904 utilizing known contacts such as node 1876. During the discovery process LSP 1912 from node 1894 to node 1876 via node 1906 comprised of links 1908 and 1910 was defined as the least cost path within the Virtual Domain 1904. Node 1876 is the rendezvous point where the trigger was place from receiver node 1838. This is illustrated in FIG. 77 with LSP 1902 from node 1840 to node 1894 and LSP 1912 from node 1894 to receiver node 1876. An H-LSP 1914 would be defined as the forwarding path from node 1876 to node 1840 comprised of links 1902 and 1912. The rendezvous point 1876 would sender H-LSP 1914 and the receiver H-LSP 1890 resulting in the H-LSP 1916 from the sender node 1840 to the receiver node 1838. The sender 1840 could use the forwarding path to send the appropriate service packets to the receiver 1838.

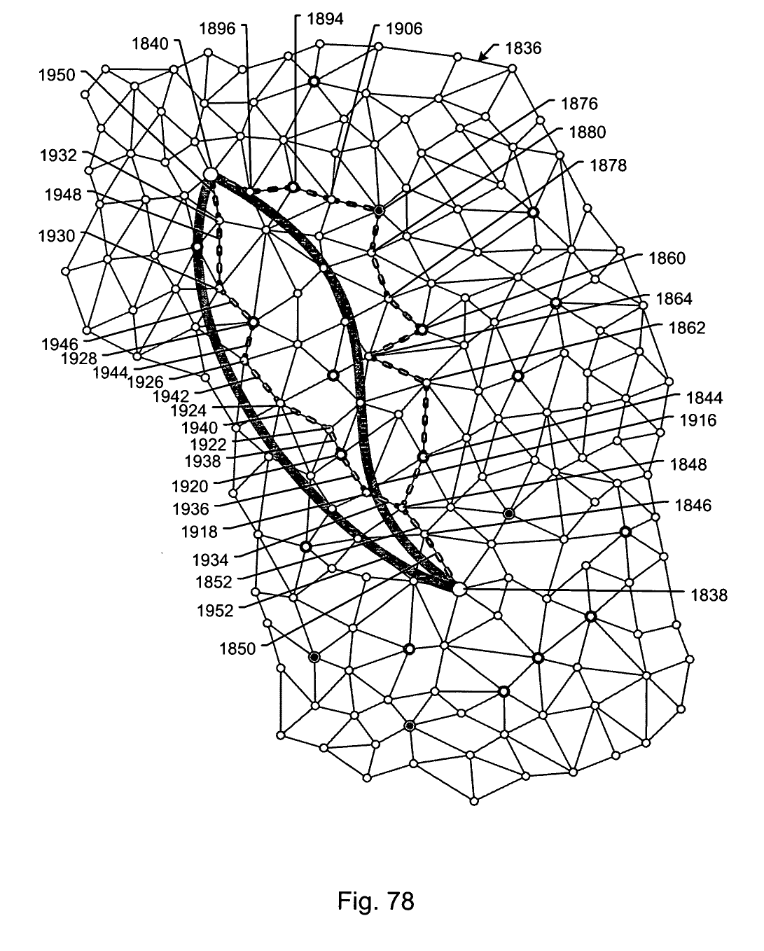

With the completion of the H-LSP 1916 from sender 1840 to receiver 1838, the location of the sender can be made available to the receiver. With the location, the receiver has additional discovery options. In FIG. 78 the previously found H-LSP 1916 is shown from node 1840 to node 1838. The forwarding path follows the sequence of nodes 1840, 1896, 1894, 1906, 1876, 1880, 1878, 1860, 1864, 1862, 1844, 1848, 1846 and 1838 consisting of 13 hops. Recall that all link costs were assumed equal resulting in a simple hop count for determining path cost. The defined path was determined from concatenation of several locally defined least cost paths with limited cost factors, which may or may not result in a globally defined least cost path. With the knowledge of the sender 1840 location, the receiver 1838 can generate Regular Virtual Ants (RVA) to discover a globally defined least cost path by giving the RVA destination 1840 location. The regular ant algorithm will find the least cost path. For the illustrative example the least cost path would be found from the receiver node 1838 to the sender node 1840. The H-LSP 1952 would be determined to be comprised of the links 1950, 1948, 1946, 1944, 1942, 1940, 1938, 1936, 1934, 1852 and 1850 containing the sequence of nodes 1840, 1932, 1930, 1928, 1926, 1924, 1922, 1920, 1918, 1848, 1846 and 1838 consisting of 11 hops. This results in a reduction in the cost from sender node 1840 to receiver node 1838.

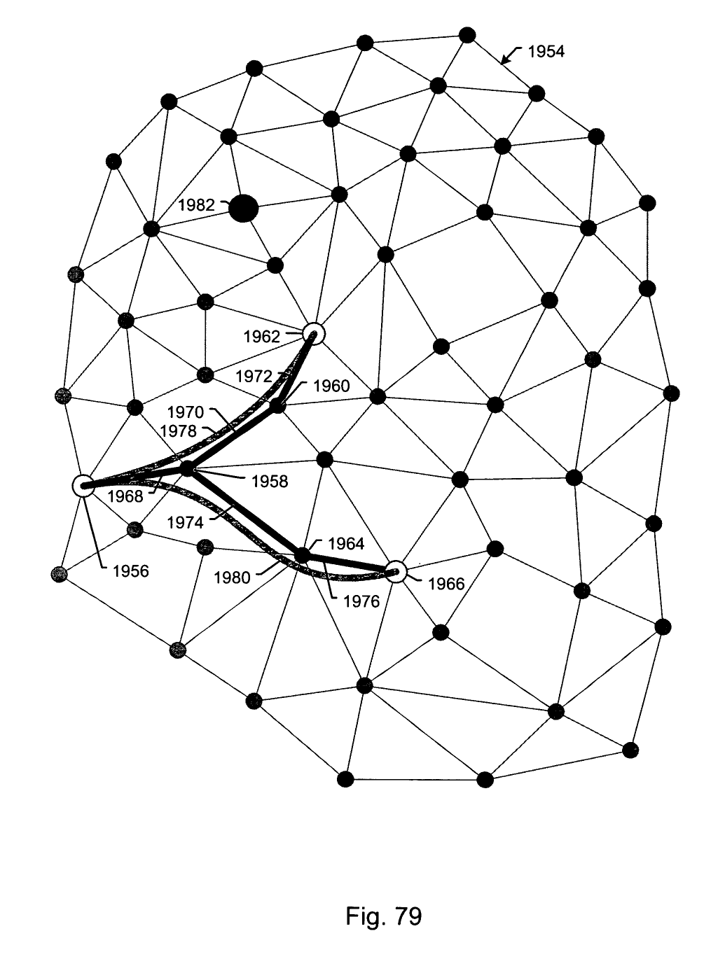

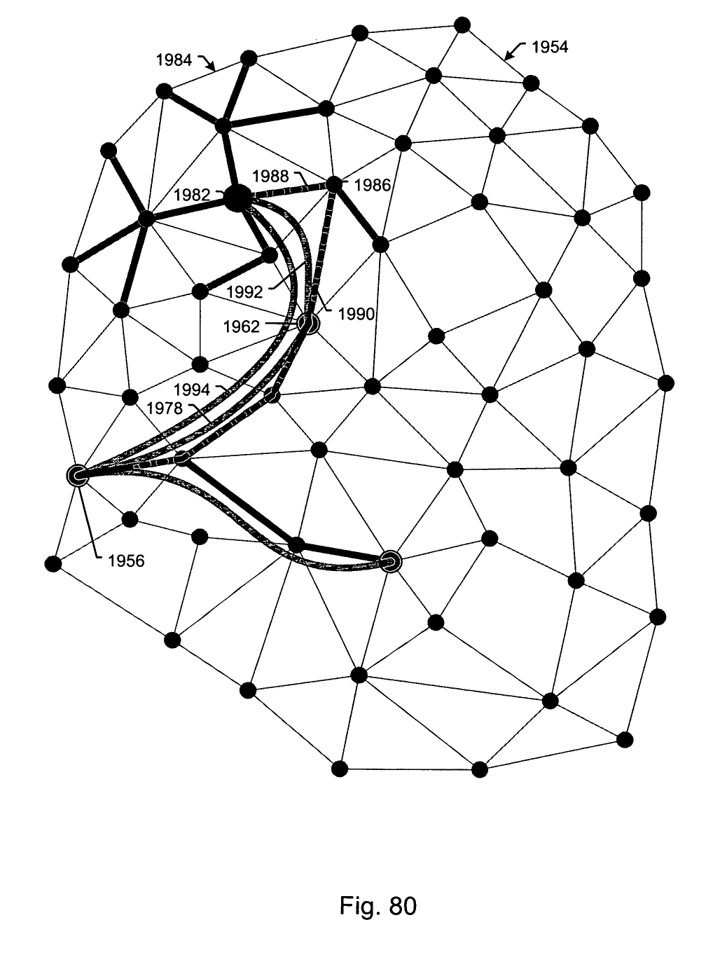

In FIG. 79 is illustrated a SWI network 1954 of interconnected Stigmergic Capable Nodes (SCN). A sender node 1956 is providing a rendezvous based service with mappings to rendezvous points 1962 and 1966. H-LSP 1978 has been defined from node 1956 to node 1962 via nodes 1958 and 1960 comprised of links 1968, 1970 and 1972. H-LSP 1980 has been defined from node 1956 to node 1966 via nodes 1958 and 1964 comprised of links 1968, 1974 and 1976. A mobile node 1982 is introduced in the network. As shown in FIG. 80 the mobile node discovers its Virtual Domain 1984 with a discovered rendezvous point 1962. The LSP 1992 from node 1982 to node 1962 via node 1986 comprised of links 1988 and 1990. Node 1982 would place a trigger at the rendezvous point 1962 requesting a service that the sender node 1956 provides. The H-LSP 1994 would be created from concatenating H-LSP 1978 and LSP 1992 creating a forwarding path for node 1956 to provide service.

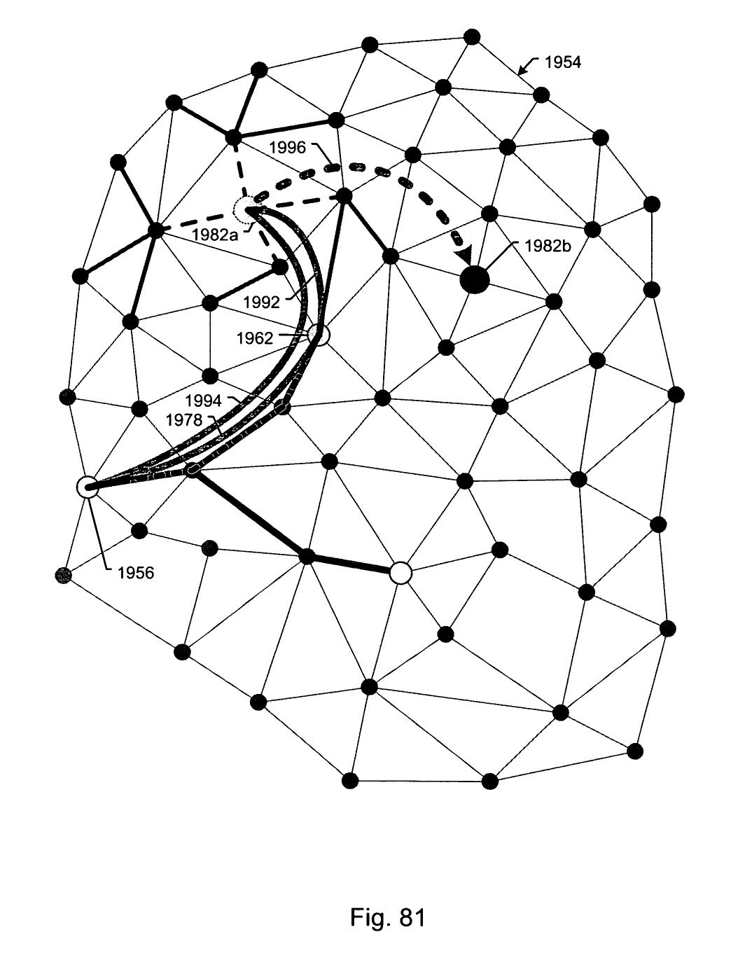

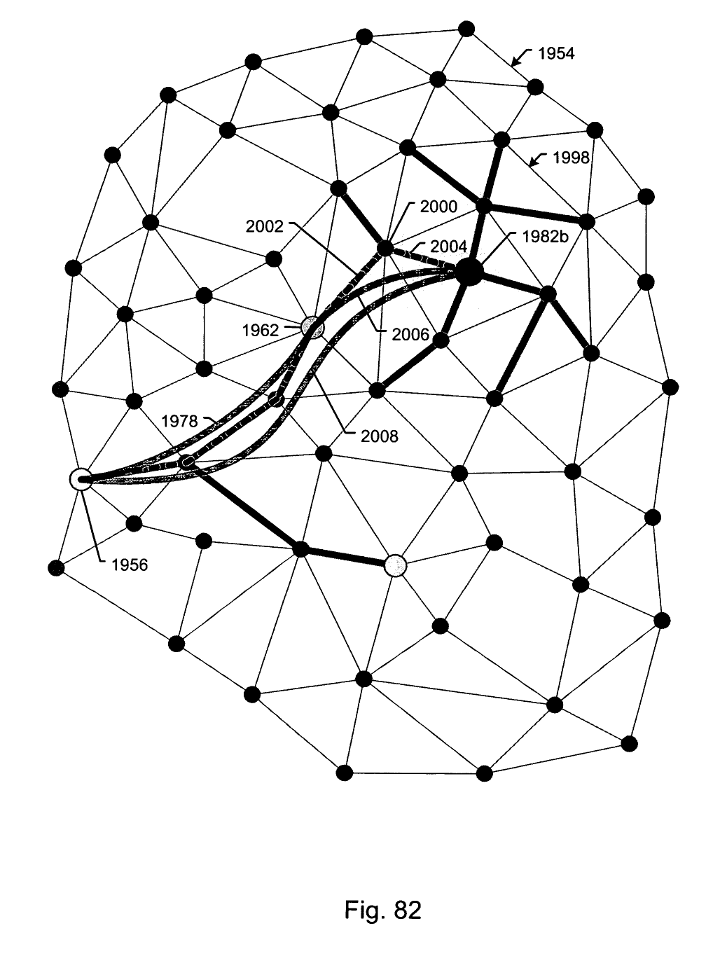

In FIG. 81 the receiver node 1982a changes location along path 1996 to 1982b. This invalidates the LSP 1992 from node 1982a to the rendezvous point 1962 resulting in the H-LSP 1994 from the sender 1956 to the receiver 1982a. Because the node is mobile, UVA's would have a short lifetime and short generation interval in order to update the LSP's in a timely manner to maintain service continuity. Node 1982b would generate UVA's to rapidly refine its Virtual Domain. In FIG. 82 node 1982b has discovered a new Virtual Domain 1998. The new domain includes a new LSP 2006 from node 1982b to node 1962 via node 2000 comprised of links 2004 and 2002. Node 1982b would place a trigger at the rendezvous point 1962 requesting a service that the sender node 1956 provides. The H-LSP 2008 would be created from concatenating H-LSP 1978 and LSP 2006 creating a forwarding path for node 1956 to continue to provide service.

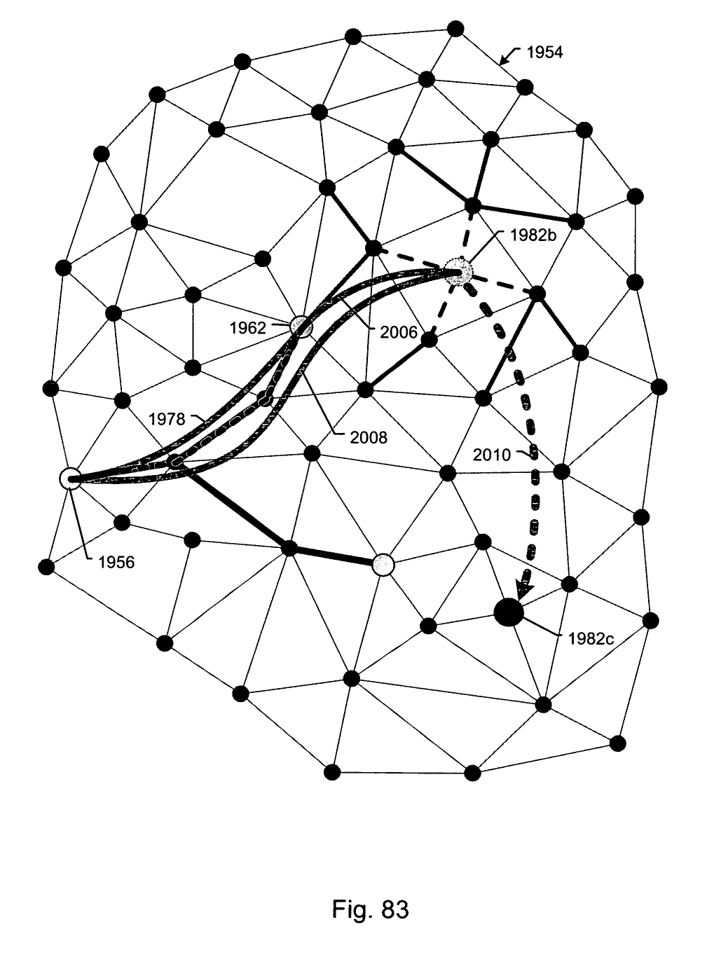

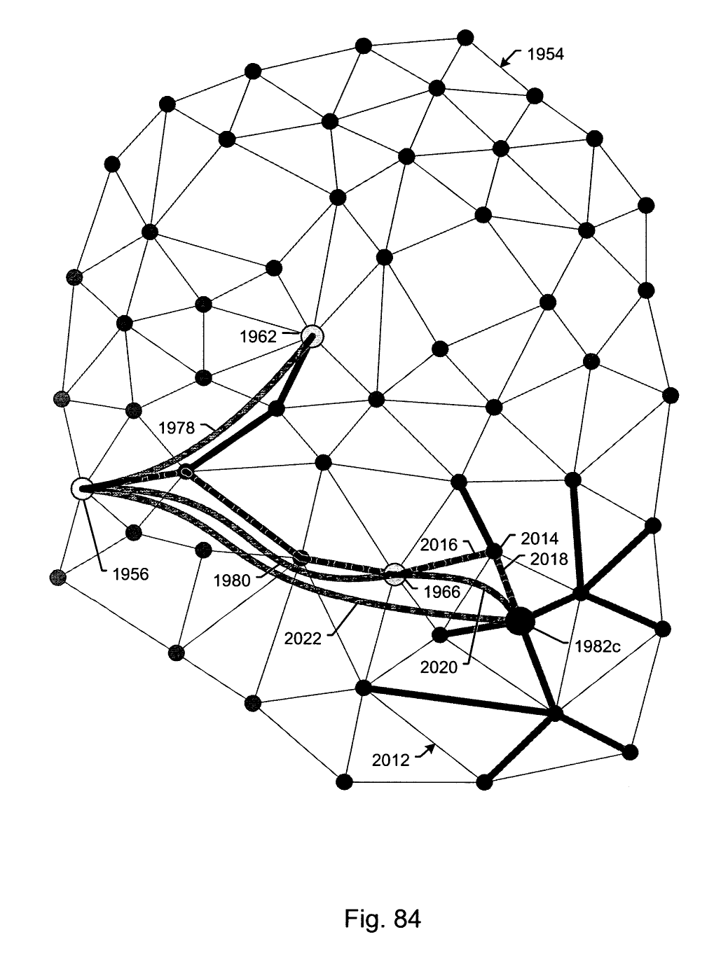

In FIG. 83 the receiver node 1982b changes location along path 2010 to 1982c. This invalidates the LSP 2006 from node 1982b to the rendezvous point 1962 resulting in the H-LSP 2008 from the sender 1956 to the receiver 1982b. Node 1982c would generate UVA's to rapidly refine its Virtual Domain. In FIG. 84 node 1982c has discovered a new Virtual Domain 2012. The new domain includes a new LSP 2020 from node 1982c to node 1966 via node 2014 comprised of links 2018 and 2016. Node 1982c would place a trigger at the rendezvous point 1966 requesting a service that the sender node 1956 provides. The H-LSP 2022 would be created from concatenating H-LSP 1978 and LSP 2020 creating a forwarding path for node 1956 to continue to providing service. This illustrates the capabilities of Virtual Ants in dynamically updating the network parameters for mobile conditions.

This invention has been described utilizing specific examples; a person skilled in the art will understand that there are numerous permutations and variations of the described methods and techniques that are within the scope of the invention.

1. A small world infrastructure (SWI) network, comprising
a) a plurality of communication units (CUs) comprising stigmergic capable nodes (SCNs);
b) a plurality of links interconnecting said plurality of communication units (CUs); and
c) means, at each one of said stigmergic capable nodes, for generating a virtual ant (VA) and for forwarding the virtual ant to at least one other stigmergic capable node to establish, recursively, a hierarchical forwarding path (HFP) between the one and the other stigmergic capable nodes.

2. A small world infrastructure according to claim 1, wherein said means for generating and forwarding can send the virtual ant to a single neighboring stigmergic capable node.

3. A small world infrastructure according to claim 1, wherein said means for generating and forwarding can send the virtual ant to multiple neighboring stigmergic capable nodes.

4. A small world infrastructure according to claim 2, wherein the single neighboring node can receive the virtual ant and terminate the virtual ant.

5. A small world infrastructure according to claim 2, wherein the single neighboring node can receive the virtual ant and forward the received virtual ant to another single neighboring stigmergic capable node.

6. A small world infrastructure according to claim 2, wherein the single neighboring stigmergic capable node can receive the virtual ant and forward the virtual ant to multiple other neighboring stigmergic capable nodes.

7. A small world infrastructure according to claim 1, wherein said stigmergic capable nodes comprise a first node for generating and sending the virtual ant, a second node for receiving and resending the virtual ant, and a third node for receiving the virtual ant from the second node and establishing a hierarchical forwarding path to the first node and through the second node.

8. A small world infrastructure according to claim 7, wherein said stigmergic capable nodes comprise a fourth neighboring node, and said third node is capable of optimizing the hierarchical forwarding path to the first node through the fourth node and bypassing the third node.

9. A small world infrastructure according to claim 7, wherein the third node is capable of modifying the content of the received virtual ant.

10. A small world infrastructure according to claim 7, wherein the third node is capable of deleting the hierarchical forwarding path to the first node.

11. A small world infrastructure according to claim 7, wherein the third node is capable of deleting the hierarchical forwarding path to the first node if the virtual ant is not received by the third node for a period of time.

12. A small world infrastructure according to claim 1, wherein a stigmergic capable node may undertake a given action as determined by the content of the virtual ant.

13. A small world infrastructure according to claim 1, wherein a stigmergic capable node may undertake an action based on the internal state and policy of the node.
